(19) United States
(12) Patent Application Publication
(10) Pub. No.: US 2026/0211979 A1
(43) Pub. Date: Jul. 23, 2026

(54) Classification of 3D Oral Care Representations

(71) Applicant: Solventum Intellectual Properties Company, Maplewood, MN (US)

(72) Inventors: Kelly J. Reff, Lino Lakes, MN (US); Jonathan D. Gandrud, Woodbury, MN (US); Michael B. Starr, Toomevara (IE); Seyed Amir Hossein Hosseini, Saint Paul, MN (US)

(21) Appl. No.: 19/138,966

(22) PCT Filed: Dec. 14, 2023
(86) PCT No.: PCT/IB2023/062701

§ 371 Date: Jun. 13, 2025

Related U.S. Application Data
(60) Provisional application No. 63/432,627, filed on Dec. 14, 2022.
(60) Provisional application No. 63/460,563, filed on Apr. 19, 2023.

(51) Int. Cl. G06F 18/2431; A61C 7/00; G06N 3/0455; G06T 7/00; G06T 17/20

(52) U.S. Cl. CPC G06F 18/2431; A61C 7/002; G06T 7/0014; G06T 17/20; G06N 3/0455; G06T 2207/20081; G06T 2207/20084; G06T 2207/30036; G06T 2210/41

(57) ABSTRACT

Systems and techniques for classifying a 3D representation of oral care data are disclosed. The method involves receiving a first 3D representation comprising one or more mesh elements and providing it as input to a trained autoencoder network. The processing circuitry computes one or more mesh element features for the mesh elements and provides them to the trained autoencoder network. By executing the trained autoencoder network, the first 3D representation of oral care data is encoded into one or more latent space representations. These latent space representations are specifically designed for utilization by a machine learning model for the classification of the first 3D representation of oral care data. These systems and techniques enable accurate and efficient classification of 3D representations, enhancing the analysis and understanding of oral care data for improved diagnosis and treatment planning.

### RELATED DOCUMENTS

The entire disclosure of PCT Application No. PCT/IB2022/057373 is incorporated herein by reference. The entire disclosures of each of PCT Applications with Publication Nos. WO2022123402A1, WO2021245480A1, and WO2020026117A1 are incorporated herein by reference. The entire disclosure of each of the following Provisional U.S. Patent Applications is incorporated herein by reference: 63/432,627; 63/366,492; 63/366,495; 63/352,850; 63/366,490; 63/366,494; 63/370,160; 63/366,507; 63/352,877; 63/366,514; 63/366,498; 63/366,514; and 63/264,914.

### TECHNICAL FIELD

This disclosure relates to configurations and training of machine learning models to improve the accuracy of automatically classifying three-dimensional (3D) oral care representations, such as teeth and orthodontic setups. The techniques may train autoencoders to perform such classifications.

### SUMMARY

The present disclosure describes systems and techniques for training and using one or more machine learning models, such as neural networks, to classify 3D oral care representations. 3D oral care representations may be classified through the use of representation learning. A first machine learning module (e.g., such as a neural network) may be trained to generate one or more second representations of a first 3D oral care representation. The one or more second representations may then be classified by a second machine learning module (e.g., a neural network, a support vector machine, a logistic regression model or another of the ML models disclosed herein) which has been trained for that classification task. The first machine learning module may take as input information of the first 3D representation which may aid in the first machine learning module's ability to correctly encode the first representation, such as mesh element features and oral care metrics (e.g., orthodontic metrics or restoration design metrics). In cases where the first representation is a 3D mesh, the mesh elements may be arranged into lists (e.g., of faces, edges, vertices and/or voxels), which may then be received as inputs to the first machine learning module (e.g., an encoder, an encoder-decoder structure, a multilayer perceptron comprising convolution and/or pooling layers, and the like). An encoder-decoder structure may comprise at least one encoder or at least one decoder. Non-limiting examples of an encoder-decoder structure include a 3D U-Net, a transformer, a pyramid encoder-decoder or an autoencoder, among others. In some implementations, a mesh element feature vector may be computed for one or more of the mesh elements and be provided to the first machine learning module. In some implementations, orthodontic metrics (e.g., which may describe physical relationships between two or more teeth) or restoration design metrics (e.g., which may describe the physical relationships between two or more teeth or may describe the shape and/or structure of a tooth) may be received at the input of the first machine learning module, to improve the ability of the model to encode aspects of the first representation. The second representation may reduce the size or quantity of data required to describe the original data from the first representation (e.g., about shape and/or structure). The second representation of the tooth may be more easily consumed by a machine learning model (such as the second machine learning module) in this reduced-size and compact form. This kind of classification activity may be performed in the course of creating an oral care appliance, such as a clear tray aligner, bracket bonding tray, or dental restoration appliance.

According to the techniques described herein, a machine learning model (such as an encoder structure, autoencoder or U-Net) may be trained to place a classification label on a dental setup. A label may indicate whether the setup is in the maloccluded (pre-treatment) state, an intermediate state (e.g., a stage during treatment), or represents a final setup (e.g., terminal arrangement of treatment at the end of treatment). A neural network for such classification may be used to influence the process of generating the series of intermediate states for orthodontic treatment. This classifier can be used classify an arch of teeth during setups prediction to assess the progress of the prediction generation process and may also be used as a quality validation step after setup prediction is completed.

According to the techniques described herein, a machine learning model (such as an encoder structure, autoencoder, or U-Net) may be trained to place a classification label on a 3D representation of an oral care mesh, such as a tooth. A tooth reconstruction autoencoder may be trained to generate a latent vector A for a tooth mesh. According to these techniques of the disclosure, an ML model may be trained to classify the type of the tooth mesh (e.g., the state of health, or the name associated with that tooth according to one or more of the standard dental notation systems), using that latent vector A as an input vector.

Multiple techniques in digital oral care may benefit from the use of a first module (e.g., an autoencoder neural network) which has been trained to reconstruct a 3D oral care representation (e.g., trained to reconstruct a tooth mesh—comprising crown, root and/or attached articles). A 3D encoder may be trained to encode an oral care mesh into a latent form, and a 3D decoder may be trained to reconstruct that latent form into a facsimile of the received oral care mesh, where techniques disclosed herein may be used to measure the resulting reconstruction error. The first module may create a representation. A second module may use that representation for prediction. There may be one or more instances of the first module, and there may be one or more instances of the second module.

3D oral care representations (e.g., one or more 3D representations of the patient's teeth, one or more tooth transforms, or one or more mesh element labels, among others described herein) may be used to train an encoder-decoder structure, such as an autoencoder. For example, a reconstruction autoencoder may encode a 3D oral care representation (e.g., a tooth mesh, one or more tooth transforms, or one or more mesh element labels, among others described herein) into one or more latent space representations. The one or more latent space representations may be provided to a machine learning model for classification (e.g., a second ML module) of the first 3D oral care representation. In some implementations, the trained reconstruction autoencoder model may contain one or more multi-dimensional encoders which are trained to encode the 3D oral care representation into a latent space representation, and/or one or more multi-dimensional decoders which are trained to reconstruct the latent space representation into a reconstructed representation that is a facsimile of the 3D oral care representation. In some implementations, an encoder-decoder structure may be trained, at least in part, using a loss value which quantifies the difference between a predicted (or generated) output and a ground truth (or reference) output. For example, a reconstruction error calculation module may quantify the difference between the 3D oral care representation and the reconstructed 3D oral care representation. In some implementations, this reconstruction error may be used as a reconstruction loss to train, at least in part, the encoder-decoder structure. In some implementations, the methods may classify one or more orthodontic setups (e.g., malocclusion, intermediate stage, or a final setup), one or more tooth meshes, one or more set of mesh elements labels (e.g., for use in segmentation), one or more transforms (e.g., which may transform teeth, appliance components or fixture model components, etc.), or other 3D oral care representations described herein. For example, when a tooth is classified, the tooth classification may be indicative of at least one of a tooth name or a tooth type. In some instances, the tooth may have attached hardware (e.g., orthodontic bracket, orthodontic attachment, button, or others described herein), and the classification methods of this disclosure may classify the tooth as such (e.g., the classification label may be indicative of hardware attached to the tooth). Stated another way, the classification methods may classify a latent representation of the tooth as either “has foreign object attached”, or “does not have any attached foreign objects”, among other possible classifications. In some implementations, the classification methods may render a classification label that is indicative of the type of hardware attached to a tooth (e.g., orthodontic bracket, orthodontic attachment, button, or others described herein). In some instance, the methods may be deployed in a clinical context. In some instances, the classified 3D oral care representation may be used for generating (or designing) an oral care appliance (e.g., clear tray aligner, a dental restoration appliance, or an indirect bonding tray, among others). Various implementations may train any of the following for use in classifying latent representations of 3D oral care representations: a neural network, a support vector machine (SVM), a regression model, a Logistic regression model, a decision tree, a random forest model, a boosting model, a Gaussian process, a k-nearest neighbors (KNN) model, a Naïve Bayes model, or a gradient boosting algorithm.

### BRIEF DESCRIPTION OF DRAWINGS

FIG. 1 shows a method of augmenting training data for use in training machine learning (ML) models of this disclosure.

FIG. 2 shows a method of training a capsule autoencoder.

FIG. 3 shows a method of training a tooth reconstruction autoencoder.

FIG. 4 shows a method of using a deployed tooth reconstruction autoencoder.

FIG. 5 shows a reconstructed tooth mesh, which has been reconstructed using a reconstruction autoencoder, according to techniques of this disclosure.

FIG. 6 shows a reconstructed tooth mesh, which has been reconstructed using a reconstruction autoencoder, according to techniques of this disclosure.

FIG. 7 shows a visualization of reconstruction error for a tooth.

FIG. 8 shows reconstruction error values for several tooth reconstructions.

FIG. 9 shows method of training a reconstruction autoencoder.

FIG. 10 shows non-limiting example code for a reconstruction autoencoder.

FIG. 11 shows examples of 3D representations which have been reconstructed, according to techniques of this disclosure.

FIG. 12 shows a latent space where loss incorporates reconstruction loss but does not incorporate KL-Divergence loss.

FIG. 13 shows a latent space in which the loss includes both reconstruction loss and KL-divergence loss.

FIG. 14 shows a method of classifying an orthodontic setup, according to techniques of this disclosure.

FIG. 15 shows a method of classifying a tooth, according to techniques of this disclosure.

### DETAILED DESCRIPTION

Described herein are techniques which may make use of an autoencoder which has been trained for oral care mesh reconstruction, which provides the advantage of encoding a potentially complex oral care mesh into a latent form (e.g., such as a latent vector or latent capsule) which may have reduced dimensionality and may be ingested by an instance of the second module (e.g., a predictive model for mesh cleanup, setups prediction, tooth restoration design generation, classification of 3D representations, validation of 3D representations, or setups comparison) for prediction purposes. While the dimensionality of the latent form may be reduced relative to the received oral care mesh, information about the reconstruction characteristics of the received oral care mesh may be retained. This latent representation of the original oral care mesh may be received as input to the predictive model of the second module, providing the advantage of improving accuracy and data precision in comparison to other techniques. The latent representation may, in some implementations, be modified according to the techniques of this disclosure to enable the predictive model of the second module to customize output data. An advantage of computing reconstruction error on a reconstructed oral care mesh is to verify that the reconstructed oral care mesh is a facsimile of the received oral care mesh (e.g., where one or more dimensions or other aspects of the reconstructed oral care mesh are measured to be within a threshold reconstruction error of the received oral care mesh). In some implementations, the first module may also be trained to produce other kinds of representations, such as those generated by neural networks performing convolution and/or pooling operations (e.g., a network with a size 5 convolution kernel which also performs average pooling, or a network such as a U-Net).

Either or both of the first and/or second modules may receive a variety of input data, as described herein, including tooth meshes for one or both arches of the patient. The tooth data may be presented in the form of 3D representations, such as meshes or point clouds. These data may be preprocessed, for example, by arranging the constituent mesh elements into lists and computing an optional mesh element feature vector for each mesh element. Such feature vectors may provide valuable information about the shape and/or structure of an oral care mesh to either or both of the first and/or second modules. For example, the first module, which generates the representations, may receive the vertices of a 3D mesh (or of a 3D point cloud) and compute a mesh element feature vector for each vertex. Such a feature vector may contain the XYZ coordinates of each vertex, in addition to other optional mesh element features described herein. Additional inputs may be received at the ingress point(s) of either or both of the first and/or second modules, such as one or more oral care metrics. Oral care metrics may be used for measuring one or more physical aspects of an oral care mesh (e.g., physical relationships within a tooth or between teeth). In some instances, an oral care metric may be computed for either or both of a malocclusion oral care mesh example and aground oral care mesh example which is then used in the training of either or both of the first and second modules. The metric value may be received as input of either or both of the first and second modules, as a way of training the underlying model of that particular module to encode a distribution of such a metric over the several examples of the training dataset. During training, the network may then receive this metric value as an input, to assist in training the network to link that inputted metric value to the physical aspects of the ground truth oral care mesh which is used in loss calculation. Such a loss calculation may quantify the difference between a prediction and a ground truth example (e.g., between a predicted oral care mesh and a ground truth oral care mesh). By providing the network data describing a metric value, the techniques of this disclosure may, through the course of loss calculation and subsequent backpropagation, train the network to encode a distribution of a given metric. In deployment, one or more oral care arguments (e.g., procedure parameters or restoration design parameters) may be defined to specify one or more aspects of an intended oral care mesh, which is to be generated using either or both of the first and/or second modules which has been trained for that purpose. In some implementations, an oral care parameter may be defined which corresponds to an oral care metric, which may be received as input to either or both of a deployed first module and/or a deployed second module, and be taken as an instruction to that module to generate an oral care mesh with the specified customization. This interplay between oral care metrics and oral care parameters may also apply to the training and deployment of other predictive models in oral care as well.

The predictive models of the present disclosure may, in some implementations, produce more accurate results by the incorporation of one or more of the following inputs: archform information V, interproximal reduction (IPR) information U, tooth dimension information P, tooth gap information Q, latent capsule representations of oral care meshes T, latent vector representations of oral care meshes A, procedure parameters K (which may describe a clinician's intended treatment of the patient), doctor preferences L (which may describe the typical procedure parameters chosen by a doctor), flags regarding tooth status M (such as for fixed or pinned teeth), tooth position information N, tooth orientation information O, tooth name/dental notation R, oral care metrics S (comprising at least one of oral care metrics and restoration design metrics).

Systems of this disclosure may, in some instances, be deployed at a clinical context (such as a dental or orthodontic office) for use by clinicians (e.g., doctors, dentists, orthodontists, nurses, hygienists, oral care technicians). Such systems which are deployed at a clinical context may enable clinicians to process oral care data (such as dental scans) in the clinic environment, or in some instances, in a “chairside” context (where the patient is present in the clinical environment). A non-limiting list of examples of techniques may include: segmentation, mesh cleanup, coordinate system prediction, CTA trimline generation, restoration design generation, appliance component generation or placement or assembly, generation of other oral care meshes, the validation of oral care meshes, setups prediction, removal of hardware from tooth meshes, hardware placement on teeth, imputation of missing values, clustering on oral care data, oral care mesh classification, setups comparison, metrics calculation, or metrics visualization. The execution of these techniques may, in some instances, enable patient data to be processed, analyzed and used in appliance generation by the clinician before the patient leaves the clinical environment (which may facilitate treatment planning because feedback may be received from the patient during the treatment planning process).

Systems of this disclosure may automate operations in digital orthodontics (e.g., setups prediction, hardware placement, setups comparison), in digital dentistry (e.g., restoration design generation) or in combinations thereof. Some techniques may apply to either or both of digital orthodontics and digital dentistry. A non-limiting list of examples is as follows: segmentation, mesh cleanup, coordinate system prediction, oral care mesh validation, imputation of oral care parameters, oral care mesh generation or modification (e.g., using autoencoders, transformers continuous normalizing flows, or denoising diffusion probabilistic model), metrics visualization, appliance component placement or appliance component generation or the like. In some instances, systems of this disclosure may enable a clinician or technician to process oral care data (such as scanned dental arches). In addition to segmentation, mesh cleanup, coordinate system prediction or validation operations, the systems of this disclosure may enable orthodontic treatment planning, which may involve setups prediction as at least one operation. Systems of this disclosure may also enable restoration design generation, where one or more restored tooth designs are generated and processed in the course of creating oral care appliances. Systems of this disclosure may enable either or both of orthodontic or dental treatment planning, or may enable automation steps in the generation of either or both of orthodontic or dental appliances. Some appliances may enable both of dental and orthodontic treatment, while other appliances may enable one or the other.

In some instances, the setups classification techniques described herein may classify a setup as belonging to an intermediate stage configuration or arrangement. In some instances, the progression along the process of staging may be identified, yielding information about how near or far the stage is relative to the final setup. For example, in some examples, there may be 5 classes of intermediate stage: ⅕ of the way towards final setup, ⅖ of the way towards final setup, and so on. With this granularity of classification, the setups classification techniques of this disclosure may enable the evaluation of the progress or quality of a setups prediction model (e.g., a model that is trained to predict a series of intermediate stages).

Techniques of this disclosure may require a training dataset of hundreds or thousands of cohort patient cases, to ensure that the neural network is able to encode the distribution of patient cases which are likely to be encountered in clinical treatment. A cohort patient case may include a set of tooth crown meshes, a set of tooth root meshes, or a data file containing attributes of the case (e.g., a JSON file). A typical example of a cohort patient case may contain up to 32 crown meshes (e.g., which may each contain tens of thousands of vertices or tens of thousands of faces), up to 32 root meshes (e.g., which may each contain tens of thousands of vertices or tens of thousands of faces), multiple gingiva mesh (e.g., which may each contain tens of thousands of vertices or tens of thousands of faces) or one or more JSON files which may each contain tens of thousands of values (e.g., objects, arrays, strings, real values, Boolean values or Null values).

Aspects of the present disclosure can provide a technical solution to the technical problem of classifying, using a machine learning model which has been trained on representations which have been generated using an autoencoder, 3D oral care representations for use in oral care appliance generation. In particular, by practicing techniques disclosed herein computing systems specifically adapted to perform classification of 3D oral care representations for oral care appliance generation are improved. For example, aspects of the present disclosure improve the performance of a computing system having a 3D representation of the patient's dentition by reducing the consumption of computing resources. In particular, aspects of the present disclose reduce computing resource consumption by decimating 3D representations of the patient's dentition (e.g., reducing the counts of mesh elements used to describe aspects of the patient's dentition) so that computing resources are not unnecessarily wasted by processing excess quantities of mesh elements. Additionally, decimating the meshes does not reduce the overall predictive accuracy of the computing system (and indeed may actually improve predictions because the input provided to the ML model after decimation is a more accurate (or better) representation of the patient's dentition). For example, noise or other artifacts which are unimportant (and which may reduce the accuracy of the predictive models) are removed. That is, aspects of the present disclosure provide for more efficient allocation of computing resources and in a way that improves the accuracy of the underlying system.

Furthermore, aspects of the present disclosure may need to be executed in a time-constrained manner, such as when an oral care appliance must be generated for a patient immediately after intraoral scanning (e.g., while the patient waits in the clinician's office). As such, aspects of the present disclosure are necessarily rooted in the underlying computer technology of classifying 3D representations based upon latent encodings and cannot be performed by a human, even with the aid of pen and paper. For instance, implementations of the present disclosure must be capable of: 1) storing thousands or millions of mesh elements of the patient's dentition in a manner that can be processed by a computer processor; 2) performing calculation on thousands or millions of mesh elements, e.g., to quantify aspects of the shape and or/structure of an individual tooth in the 3D representation of the patient's dentition; 3) encoding the thousands or millions of mesh elements into a latent representation of hundreds of real values; 4) classifying that latent representation using a trained ML model; 5) using the classification method to classify the teeth of the patient and then automatically generating orthodontic setups using a trained ML model, based at least in part, upon the classified teeth; and 6) generating an orthodontic appliance based at least in part upon the generated setups, and do so during the course of a short office visit.

This disclosure pertains to digital oral care, which encompasses the fields of digital dentistry and digital orthodontics. This disclosure generally describes methods of processing three-dimensional (3D) representations of oral care data. It should be understood, without loss of generality, that there are various types of 3D representations. One type of 3D representation is a 3D geometry. A 3D representation may include, be, or be part of one or more of a 3D polygon mesh, a 3D point cloud (e.g., such as derived from a 3D mesh), a 3D voxelized representation (e.g., a collection of voxels—for sparse processing), or 3D representations which are described by mathematical equations. Although the term “mesh” is used frequently throughout this disclosure, the term should be understood, in some implementations, to be interchangeable with other types of 3D representations. A 3D representation may describe elements of the 3D geometry and/or 3D structure of an object.

Dental arches S1, S2, S3 and S4 all contain the exact same tooth meshes, but those tooth meshes are transformed differently, according to the following description. A first arch S1 includes a set of tooth meshes arranged (e.g., using transforms) in their positions in the mouth, where the teeth are in the mal positions and orientations. A second arch S2 includes the same set of tooth meshes from S1 arranged (e.g., using transforms) in their positions in the mouth, where the teeth are in the ground truth setup positions and orientations. A third arch S3 includes the same meshes as S1 and S2, which are arranged (e.g., using transforms) in their positions in the mouth, where the teeth are in the predicted final setup poses (e.g., as predicted by one or more of the techniques of this disclosure). S4 is a counterpart to S3, where the teeth are in the poses corresponding to one of the several intermediate stages of orthodontic treatment with clear tray aligners.

It should be understood, without the loss of generality, that the techniques of this disclosure which apply to final setups are also applicable to intermediate staging in orthodontic treatment, particularly geometric deep learning (GDL) Setups, reinforcement learning (RL) Setups, variational autoencoder (VAE) Setups, Capsule Setups, multilayer perceptron (MLP) Setups, Diffusion Setups, pose transfer (PT) Setups, Similarity Setups, force directed graphs (FDG) Setups, Transformer Setups, Setups Comparison, or Setups Classification. The Metrics Visualization aspects of this disclosure may also be configured to visualize data from both final setups and intermediate stages. MLP Setups, VAE Setups and Capsule Setups each fall within the scope of Autoencoder Setups. Some implementations of MLP Setups may fall within the Scope of Transformer Setups. Representation Setups refers to any of MLP Setups, VAE Setups, Capsule Setups and any other setups prediction machine learning model which uses an autoencoder to create the representation for at least one tooth.

Each of the setups prediction techniques of this disclosure is applicable to the fabrication of clear tray aligners and/or indirect bonding trays. The setups predictions techniques may also be applicable to other products that involve final teeth poses, also. A pose may comprise a position (or location) and a rotation (or orientation).

A 3D mesh is a data structure which may describe the geometry or shape of an object related to oral care, including but not limited to a tooth, a hardware element, or a patient's gum tissue. A 3D mesh may include one or more mesh elements such as one or more of vertices, edges, faces and combinations thereof. In some implementations, mesh element may include voxels, such as in the context of sparse mesh processing operations. Various spatial and structural features may be computed for these mesh elements and be provided to the predictive models of this disclosure, with the predictive models of this disclosure providing the technical advantage of improving data precision in the form of the models of this disclosure outputting more accurate predictions.

A patient's dentition may include one or more 3D representations of the patient's teeth (e.g., and/or associated transforms), gums and/or other oral anatomy. An orthodontic metric (OM) may, in some implementations, quantify the relative positions and/or orientations of at least one 3D representation of a tooth relative to at least one other 3D representation of a tooth. A restoration design metric (RDM) may, in some implementations, quantify at least one aspect of the structure and/or shape of a 3D representation of a tooth. An orthodontic landmark (OL) may, in some implementations, locate one or more points or other structural regions of interest on a 3D representation of a tooth. An OL may, in some implementations, be used in the generation of an orthodontic or dental appliance, such as a clear tray aligner or a dental restoration appliance. A mesh element may, in some implementations, comprise at least one constituent element of a 3D representation of oral care data. For example, in the case of a tooth that is represented by a 3D mesh, mesh elements may include at least: vertices, edges, faces and voxels. A mesh element feature may, in some implementations, quantify some aspect of a 3D representation in proximity to or in relation with one or more mesh elements, as described elsewhere in this disclosure. Orthodontic procedure parameters (OPP) may, in some implementations, specify at least one value which defines at least one aspect of planned orthodontic treatment for the patient (e.g., specifying desired target attributes of a final setup in final setups prediction). Orthodontic Doctor preferences (ODP) may, in some implementations, specify at least one typical value for an OPP, which may, in some instances, be derived from past cases which have been treated by one or more oral care practitioners. Restoration Design Parameters (RDP) may, in some implementations, specify at least one value which defines at least one aspect of planned dental restoration treatment for the patient (e.g., specifying desired target attributes of a tooth which is to undergo treatment with a dental restoration appliance). Doctor Restoration Design Preferences (DRDP) may, in some implementations, specify at least one typical value for an RDP, which may, in some instances, be derived from past cases which have been treated by one or more oral care practitioners. 3D oral care representations may include, but are not limited to: 1) a set of mesh element labels which may be applied to the 3D mesh elements of teeth/gums/hardware/appliance meshes (or point clouds) in the course of mesh segmentation or mesh cleanup; 2) 3D representation(s) for one or more teeth/gums/hardware/appliances for which shapes have been modified (e.g., trimmed, distorted, or filled-in) in the course of mesh segmentation or mesh cleanup; 3) one or more coordinate systems (e.g., describing one, two, three or more coordinate axes) for a single tooth or a group of teeth (such as a full arch—as with the LDE coordinate system); 4) 3D representation(s) for one or more teeth for which shapes have been modified or otherwise made suitable for use in dental restoration; 5) 3D representation(s) for one or more dental restoration appliance components; 6) one or more transforms to be applied to one or more of: dental restoration appliance library component placement relative to one or more teeth, a tooth to be placed for an orthodontic setup (either final setup or intermediate stage), a hardware element to be placed relative to one or more teeth or the like; 7) an orthodontic setup; 8) a 3D representation of a hardware element (such as facial bracket, lingual bracket, orthodontic attachment, button, hook, bite ramp, etc.) to be placed relative to one or more teeth, etc.; 8) a 3D representation of a bonding pad for a hardware element (which may be generated for a specific tooth by outlining a perimeter on the tooth, specifying a thickness to form a shell, and then subtracting-out the tooth via a Boolean operation); 9) 3D representation of a clear tray aligner (CTA); 10) the location or shape of a CTA trimline (e.g., described as either a mesh or polyline); 11) archform that describes the contours or layout of an arch of teeth (e.g., described as a 3D polyline or as a 3D mesh or surface), which may follow the incisal edges one or more teeth, which may follow the facial surfaces of one or more teeth, which may in some implementations correspond to the maloccluded arch and in other implementations correspond to the final setup arch (the effects of malocclusion on the shape of the archform may be diminished by smoothing or averaging of the shape of the archform), which may be described by one or more control points and/or a spline; 12) 3D representation of a fixture models (e.g., depictions of teeth and gums for use in thermoforming clear tray aligners, or depictions of teeth/gums/hardware for use in thermoforming indirect bonding trays); 13) one or more latent space vectors (or latent capsules) produced by the 3D encoder stage of a 3D autoencoder which has been trained on the reconstruction of oral care meshes (e.g., a variational autoencoder which has been trained for tooth reconstruction); 14) one or more oral care metrics values (e.g., such as orthodontic metrics or restoration design generation metrics) for one or more teeth; 15) one or more landmarks (e.g., 3D points) which describe the shapes and/or geometrical attributes of one or more teeth, other dentition structures or hardware structures (e.g., to be used in orthodontic setups creation or restoration appliance component generation or placement); 16) 3D representation created by scanning (e.g., optically scanning, CT scanning or MRI scanning) a 3D printed part corresponding to one or more teeth/gums/hardware/appliances (e.g., a scanned fixture model); 17) 3D printed aligners (including optionally local thickness, reinforcing rib geometry, flap positioning, or the like) 18) 3D representation of the patient's dentition that was captured chairside by a clinician or medical practitioner (e.g., in a context where the 3D representation is validated chairside, before the patient leaves the clinic, so that errors can be detected and re-scans performed as necessary); 19) dental restoration tooth design (e.g., for veneers, crowns, bridges or dental restoration appliances); 20) 3D representations of one or more teeth for use in digital oral care treatment; 21) other 3D printed parts pertaining to oral care procedures or other fields; 22) IPR cut surfaces; 23) one or more orthodontic setups transforms associated with one or more IPR cut surfaces; 24) a (digital) pontic tooth design which may fill at least a portion of the space between teeth to allow room in an orthodontic setup for an erupting tooth to later emerge from the gums; or 25) a component of a fixture model (e.g., comprising fixture model components such as interproximal webbing, block-out, bite locks, bite ramps, interproximal reinforcement, gingival ridges, torque points, power ridges, pontic tooth or dimples, among others).

The techniques of this disclosure may be advantageously combined. For example, the Setups Comparison tool may be used to compare the output of the GDL Setups model against ground truth data, compare the output of the RL Setups model against ground truth data, compare the output of the VAE Setups model against ground truth data and compare the output of the MLP Setups model against ground truth data. With each of these setups prediction models compared against ground truth data, it may be possible to determine which model gives the best performance on a certain dataset or within a given problem domain. Furthermore, the Metrics Visualization tool can enable a global view of the final setups and intermediate stages produced by one or more of the setups prediction models, with the advantage of enabling the selection of the best setups prediction model. The Metrics Visualization tool, furthermore, enables the computation of metrics which have a global scope over a set of intermediate stages. These global metrics may, in some implementations, be consumed as inputs to the neural networks for predicting setups (e.g., GDL Setups, RL Setups, VAE Setups, Capsule Setups, MLP Setups, Diffusion Setups, PT Setups, Similarity Setups, among others). The global metrics may also be provided to FDG Setups. The local metrics from this disclosure (i.e., a local metric is a metric which may be computed for one stage or setup of treatment, rather than over several stages or setups) may, in some implementations, be consumed by the neural networks herein for predicting setups, with the advantage of improving predictive results. The metrics described in this disclosure may, in some implementations, be visualized using the Metric Visualization tool.

The VAE and MAE models for mesh element labelling and mesh in-filling can be advantageously combined with the setups prediction neural networks, for the purpose of mesh cleanup ahead of or during the prediction process. In some implementations, the VAE for mesh element labelling may be used to flag mesh elements for further processing, such as metrics calculation, removal or modification. In some instances, such flagged mesh elements may be provided as inputs to a setups prediction neural network, to inform that neural network about important mesh features, attributes or geometries, with the advantage of improving the performance of the resulting setups prediction model. In some implementations, mesh in-filling may cause the geometry of a tooth to become more nearly complete, enabling the better functioning of a setups prediction model (i.e., improved correctness of prediction on account of better-formed geometry). In some instances, a neural network to classify a setup (i.e., the Setups Classifier) may aid in the functioning of a setups prediction neural network, because the setups classifier tells that setups prediction neural network when the predicted setup is acceptable for use and can be provided to a method for aligner tray generation. A Setups Classifier (e.g., GDL Setups, RL Setups, VAE Setups, Capsule Setups, MLP Setups, Diffusion Setups, PT Setups, Similarity Setups and FDG Setups, among others) may aid in the generation of final setups and also in the generation of intermediate stages. Furthermore, a Setups Classifier neural network may be combined with the Metrics Visualization tool. In other implementations, a Setups Classification neural network may be combined with the Setups Comparison tool (e.g., the Setup Comparison tool may output an indication of how a setup produced in part by the Setups Classifier compares to a setup produced by another setups prediction method). In some implementations, the VAE for mesh element labelling may identify one or more mesh elements for use in a metrics calculation. The resulting metrics outputs may be visualized by the Metrics Visualization tool.

In some examples, the Setups Classifier neural network may aid in the setups prediction technique described in U.S. Patent Application No. US20210259808A1 (which is incorporated herein by reference in its entirety) or the setups prediction technique described in PCT Application with Publication No. WO2021245480A1 (which is incorporated herein by reference in its entirety) or in PCT Application No. PCT/IB2022/057373 (which is incorporated herein by reference in its entirety). The Setups Classifier would help one or more of those techniques to know when the predicted final setup is most nearly correct. In some instances, the Setups Classifier neural network may output an indication of how far away from final setup a given setup is (i.e., a progress indicator).

In some implementations, the latent space embedding vector(s) from the reconstruction VAE can be concatenated with the inputs to the setups prediction neural network described in WO2021245480A1. The latent space vectors can also be incorporated as inputs to the other setups prediction models: GDL Setups, RL Setups, VAE Setups, Capsule Setups, MLP Setups and Diffusion Setups, among others. The advantage is to impart the reconstruction characteristics (e.g., latent vector dimensions of a tooth mesh) to that neural network, hence improving the generated setups prediction.

In some examples, the various setups prediction neural networks of this disclosure may work together to produce the setups required for orthodontic treatment. For example, the GDL Setups model may produce a final setup, and the RL Setups model may use that final setup as input to produce a series of intermediate stages setups. Alternatively, the VAE Setups model (or the MLP Setups model) may create a final setup which may be used by an RL Setups model to produce a series of intermediate stages setups. In some implementations, a setup prediction may be produced by one setups prediction neural network, and then taken as input to another setups prediction neural network for further improvements and adjustments to be made. In some implementations, such improvements may be performed in iterative fashion.

In some implementations, a setups validation model, such as the model disclosed in US Provisional Application No. U.S. 63/366,495, may be involved in this iterative setups prediction loop. First a setup may be generated (e.g., using a model trained for setups prediction, such as GDL Setups, RL Setups, VAE Setups, Capsule Setups, MLP Setups, Diffusion Setups, PT Setups, Similarity Setups and FDG Setups, among others), then the setup undergoes validation. If the setup passes validation, the setup may be outputted for use. If the setup fails validation, the setup may be sent back to one or more of the setups prediction models for corrections, improvements and/or adjustments. In some instances, the setups validation model may output an indication of what is wrong with the setup, enabling the setups generation model to make an improved version upon the next iteration. The process iterates until done.

Generally speaking, in some implementations, two or more of the following techniques of the present disclosure may be combined in the course of orthodontic and/or dental treatment: GDL Setups, Setups Classification, Reinforcement Learning (RL) Setups, Setups Comparison, Autoencoder Setups (VAE Setups or Capsule Setups), VAE Mesh Element Labeling, Masked Autoencoder (MAE) Mesh In-filling, Multi-Layer Perceptron (MLP) Setups, Metrics Visualization, Imputation of Missing Oral Care Parameters Values, Tooth Classification Using Latent Vector, FDG Setups, Pose Transfer Setups, Restoration Design Metrics Calculation, Neural Network Techniques for Dental Restoration And Orthodontics (e.g., 3D Oral Care Representation Generation or Modification Using Transformers), Landmark-based (LB) Setups, Diffusion Setups, Imputation of Tooth Movement Procedures, Capsule Autoencoder Segmentation, Diffusion Segmentation, Similarity Setups, Validation of Oral Care Representations (e.g., using autoencoders), Coordinate System Prediction, Restoration Design Generation, or 3D Oral Care Representation Generation or Modification Using Denoising Diffusion Models.

In some instances, tooth shape-based inputs may be provided to a neural network for setups predictions. In other instances, non-shape-based inputs can be used, such as a tooth name or designation, as it pertains to dental notation. In some implementations, a vector R of flags may be provided to the neural network, where a ‘1’ value indicates that the tooth is present and a ‘0’ value indicates that the tooth is absent from the patient case (though other values are possible). The vector R may comprise a 1-hot vector, where each element in the vector corresponds to a tooth type, name or designation. Identifying information about a tooth (e.g., the tooth's name) can be provided to the predictive neural networks of this disclosure, with the advantage of enabling the neural network to become trained to handle different teeth in tooth-specific ways. For example, the setups prediction model may learn to make setups transformations predictions for a specific tooth designation (e.g., upper right central incisor, or lower left cuspid, etc.). In the case of the mesh cleanup autoencoders (either for labelling mesh element or for in-filling missing mesh data), the autoencoder may be trained to provide specialized treatment to a tooth according to that tooth's designation, in this manner. In the case of a setups classification neural network, a listing of tooth name(s) present in the patient's arch may better enable the neural network to output an accurate determination of setup classification, because tooth designation is a valuable input to training such a neural network. Tooth designation/name may be defined, for example, according to the Universal Numbering System, Palmer System, or the FDI World Dental Federation notation (ISO 3950).

In one example, where all except the (up to four) wisdom teeth are present in the case, a vector R may be defined as an optional input to the setups prediction neural networks of this disclosure, where there is a 0 in the vector element corresponding to each of the wisdom teeth, and a 1 in the elements corresponding to the following teeth: UR7, UR6, UR5, UR4, UR3, UR2, UR1, UL1, UL2, UL3, UL4, UL5, UL6, UL7, LL7, LL6, LL5, LL4, LL3, LL2, LL1, LR1, LR2, LR3, LR4, LR5, LR6, LR7

In some instances, the position of the tooth tip may be provided to a neural network for setups predictions. In other instances, one or more vectors S of the orthodontic metrics described elsewhere in this disclosure may be provided to a neural network for setups predictions. The advantage is an improved capacity for the network to become trained to understand the state of a maloccluded setup and therefore be able to predict a more accurate final setup or intermediate stage.

In some implementations, the neural networks may take as input one or more indications of interproximal reduction (IPR) U, which may indicate the amount of enamel that is to be removed from a tooth during the course orthodontic treatment (either mesially or distally). In some implementations, IPR information (e.g., quantity of IPR that is to be performed on one or more teeth, as measured in millimeters, or one or more binary flags to indicate whether or not IPR is to be performed on each tooth identified by flagging) may be concatenated with a latent vector A which is produced by a VAE or a latent capsule T autoencoder. The vector(s) and/or capsule(s) resulting from such a concatenation may be provided to one or more of the neural networks of the present disclosure, with the technical improvement or added advantage of enabling that predictive neural network to account for IPR. IPR is especially relevant to setups prediction methods, which may determine the positions and poses of teeth at the end of treatment or during one or more stages during treatment. It is important to account for the amount of enamel that is to be removed ahead of predicted tooth movements.

In some implementations, one or more procedure parameters K and/or doctor preferences vectors L may be introduced to a setups prediction model. In some implementations, one or more optional vectors or values of tooth position N (e.g., XYZ coordinates, in either tooth local or global coordinates), tooth orientation O (e.g., pose, such as in transformation matrices or quaternions, Euler angles or other forms described herein), dimensions of teeth P (e.g., length, width, height, circumference, diameter, diagonal measure, volume—any of which dimensions may be normalized in comparison to another tooth or teeth), distance between adjacent teeth Q. These “dimensions of teeth P” may in some instances be used to describe the intended dimensions of a tooth for dental restoration design generation.

In some implementations, tooth dimensions P (e.g., length, width, height, or circumference) may be measured inside a plane, such as the plane that intersects the centroid of the tooth, or the plane that intersects a center point that is located midway between the centroid and either the incisal-most extent or the gingival-most extent of the tooth. The tooth dimension of height may be measured as the distance from gums to incisal edge. The tooth dimension of width may be measured as the distance from the mesial extent to the distal extent of the tooth. In some implementations, the circularity or roundness of the tooth cross-section may be measured and included in the vector P. Circularity or roundness may be defined as the ratio of the radii of inscribed and circumscribed circles.

The distance Q between adjacent teeth can be implemented in different ways (and computed using different distance definitions, such as Euclidean or geodesic). In some implementations, a distance Q1 may be measured as an averaged distance between the mesh elements of two adjacent teeth. In some implementations, a distance Q2 may be measured as the distance between the centers or centroids of two adjacent teeth. In some implementations, a distance Q3 may be measured between the mesh elements of closest approach between two adjacent teeth. In some implementations, a distance Q4 may be measured between the cusp tips of two adjacent teeth. Teeth may, in some implementations, be considered adjacent within an arch. Teeth may, in some implementations, also be considered adjacent between opposing arches. In some implementations, any of Q1, Q2, Q3 and Q4 may be divided by a term for the purpose of normalizing the resulting value of Q. In some implementations, the normalizing term may involve one or more of: the volume of a tooth, the count of mesh elements in a tooth, the surface area of a tooth, the cross-sectional area of a tooth (e.g., as projected into the XY plane), or some other term related to tooth size.

Other information about the patient's dentition or treatment needs (or related parameters) may be concatenated with the other input vectors to one or more of MLP, GAN, generator, encoder structure, decoder structure, transformer, VAE, conditional VAE, regularized VAE, 3D U-Net, capsule autoencoder, diffusion model, and/or any of the neural networks models listed elsewhere in this disclosure.

The vector M may contain flags which apply to one or more teeth. In some implementations, M contains at least one flag for each tooth to indicate whether the tooth is pinned. In some implementations, M contains at least one flag for each tooth to indicate whether the tooth is fixed. In some implementations, M contains at least one flag for each tooth to indicate whether the tooth is pontic. Other and additional flags are possible for teeth, as are combinations of fixed, pinned and pontic flags. A flag that is set to a value that indicates that a tooth should be fixed is a signal to the network that the tooth should not move over the course of treatment. In some implementations, the neural network loss function may be designed to be penalized for any movement in the indicated teeth (and in some particular cases, may be heavily penalized). A flag to indicate that a tooth is pontic informs the network that the tooth gap is to be maintained, although that gap is allowed to move. In some cases, M may contain a flag indicating that a tooth is missing. In some implementations, the presence of one or more fixed teeth in an arch may aid in setups prediction, because the one or more fixed teeth may provide an anchor for the poses of the other teeth in the arch (i.e., may provide a fixed reference for the pose transformations of one or more of the other teeth in the arch). In some implementations, one or more teeth may be intentionally fixed, so as to provide an anchor against which the other teeth may be positioned. In some implementations, a 3D representation (such as a mesh) which corresponds to the gums may be introduced, to provide a reference point against which teeth can be moved.

Without the loss of generality, one or more of the optional input vectors K, L, M, N, O, P, Q, R, S, U and V described elsewhere in this disclosure may also be provided to the input or into an intermediate layer of one or more of the predictive models of this disclosure. In particular, these optional vectors may be provided to the MLP Setups, GDL Setups, RL Setups, VAE Setups, Capsule Setups and/or Diffusion Setups, with the advantage of enabling the respective model to generate setups which better meet the orthodontic treatment needs of the patient. In some implementations, such inputs may be provided, for example, by being concatenated with one or more latent vectors A which are also provided to one or more of the predictive models of this disclosure. In some implementations, such inputs may be provided, for example, by being concatenated with one or more latent capsules T which are also provided to one or more of the predictive models of this disclosure.

In some implementations, one or more of K, L, M, N, O, P, Q, R, S, U and V may be introduced to the neural network (e.g., MLP or Transformer) directly in a hidden layer of the network. In some instances, one or more of K, L, M, N, O, P, Q, R, S, U and V may be introduced directly into the internal processing of an encoder structure.

In some implementations, a setups prediction model (such as GDL Setups, RL Setups, VAE Setups, Capsule Setups, MLP Setups, PT Setups, Similarity Setups and Diffusion Setups) may take as input one or more latent vectors A which correspond to one or more input oral care meshes (e.g., such as tooth meshes). In some implementations, a setups prediction model (such as GDL Setups, RL Setups, VAE Setups, Capsule Setups, MLP Setups and Diffusion Setups) may take as input one or more latent capsules T which correspond to one or more input oral care meshes (e.g., such as tooth meshes). In some implementations, a setups prediction method may take as input both of A and T.

Examples of oral care metrics include Orthodontic Metrics (OM) and Restoration Design Metrics (RDM). RDM may describe the shape and/or form of one or more 3D representations of teeth for use in dental restoration. One use case example is in the creation of one or more dental restoration appliances. Another use case example is in the creation of one or more veneers (such as a zirconia veneer). Some RDM may quantify the shape and/or other characteristics of a tooth. Other RDM may quantify relationships (e.g., spatial relationships) between two or more teeth. RDM differ from restoration design parameters (RDP) in that restoration design metrics define a current state of a patient's dentition, whereas restoration design parameters serve as specifications to a machine learning or other optimization model to generate desired tooth shapes and/or forms. RDM describe the shapes of the teeth currently (e.g., in a starting or mal condition). Restoration design parameters specify how an oral care provider (such as a dentist or dental technician) intends for the teeth to look after the completion of restoration treatment. Either or both of RDM and RDP may be provided a neural network or other machine learning or optimization algorithm for the purpose of dental restoration. In some implementations, RDM may be computed on the pre-restoration dentition of the patient (i.e., the primary implementation). In other implementations, RDM may be computed on the post-restoration dentition of the patient. A restoration design may comprise one or more teeth and may be referred to as a restoration arch. Restoration design generation may involve the generation of an improved geometry and/or structure of one or more teeth in a restoration arch.

Aspects of RDM calculation are described below. In some implementations, RDM may be measured, for example, through locating landmarks in the teeth (or gums, hardware and/or other elements of the patient's dentition), and the measurements of distances between those landmarks, or otherwise made in relation to those landmarks. In some implementations, one or more neural networks or other machine learning models may be trained to identify or extract one or more RDM from one or more 3D representations of teeth (or gums, hardware and/or other elements of the patient's dentition). Techniques of this disclosure may use RDM in various ways. For instance, in some implementations, one or more neural networks or other machine learning models may be trained to classify or label one or more setups, arches, dentitions or other sets of teeth based at least in part on RDM. As such, in these examples, RDMs form a part of the training data used for training these models.

Aspects of a tooth mesh reconstruction autoencoder (e.g., a variational autoencoder optionally utilizing normalizing flows) may be used in accordance with techniques of this disclosure are described below. Continuous normalizing flows (CNF) may comprise a series of invertible mappings which may transform a probability distribution. In some implementations, CNF may be implemented by a succession of blocks in the decoder of an autoencoder. Such blocks may constrict a complex probability distribution, thereby enabling the autoencoder's decoder to learn to map a simple distribution to a more complicated distribution and back, which leads to a data precision-related technical improvement that enables the distribution of tooth shapes after reconstruction (in deployment) to be more representative of the distribution of tooth shapes in the training dataset. The invertibility of a CNF provides for a technical advantage of improved mathematical efficiencies during training, thereby providing resource usage-related technical improvements. An autoencoder for restoration design generation is disclosed in US Provisional Application No. U.S. 63/366,514. This autoencoder (e.g., a variational autoencoder or VAE) takes as input a tooth mesh (or other 3D representation) that reflects a mal state (i.e., the pre-restoration tooth shape). The encoder component of the autoencoder encodes that tooth mesh to a latent form (e.g., a latent vector). Modifications may be applied to this latent vector (e.g., based on a mapping of the latent space through prior experiments), for the purpose of altering the geometry and/or structure of the eventual reconstructed mesh. Additional vectors may, in some implementations, be included with the latent vector (e.g., through concatenation), and the resulting concatenation of vectors may be reconstructed by way of the decoder component of the autoencoder into a reconstructed tooth mesh which is a facsimile of the input tooth mesh.

RDM and RDP may also be used as neural network inputs in the execution phase, in accordance with aspects of this disclosure. In some implementations, one or more RDM may be concatenated with the input to the encoder, for the purpose of telling the encoder specific information about the input 3D tooth representation. In some implementations, one or more RDM may be concatenated with the latent vector, before reconstruction, for the purpose of providing the decoder component with specific information about the input 3D tooth representation. Furthermore, in some implementations, one or more restoration design parameters (RDP) may be concatenated with the input to the encoder component, for the purpose of providing the encoder specific information about the input 3D tooth representation. Likewise, in some implementations, one or more restoration design parameters (RDP) may be concatenated with the latent vector, before reconstruction, for the purpose of providing the decoder specific information about the input 3D tooth representation.

In this way, either or both of RDM and RDP may be introduced to the functioning of an autoencoder (e.g., a tooth reconstruction autoencoder), and serve to influence the geometry and/or structure of the reconstructed restoration design (i.e., influence the shape of the tooth on the output of the autoencoder). In some implementations, the variational autoencoder of US Provisional Application No. U.S. 63/366,514 may be replaced by a capsule autoencoder (e.g., instead of encoding the tooth mesh into a latent vector, the tooth mesh is encoded into one or more latent capsules).

In some implementations, clustering or other unsupervised techniques may be performed on RDM to cluster one or more setups, arches, dentitions or other sets of teeth based on the restoration characteristics of the teeth. Such clusters may be useful in treatment planning, as the clusters provide insight into categories of patients with different treatment needs. This information may be instructive to clinicians as they learn about possible treatment options. In some instances, best practices may be identified (such as default RDP values) for patient cases that fall into one or another cluster (e.g., as determined by a similarity measure, as in k-NN). After a new case is classified into a particular cluster, information about the relevant best practices may be provided to the clinician who is responsible for processing the case. Such default values may, in some instances, undergo further tuning or modifications.

Case Assignment: Such clusters may be used to gain further insight into the kinds of patient cases which exist in a dataset. Analysis of such clusters may reveal that patient treatment cases with certain RDM values (or ranges of values) may take less time to treat (or alternatively more time to treat). Cases which take more time to treat (or are otherwise more difficult) may be assigned to experienced or senior technicians for processing. Cases which take less time to treat may be assigned to newer or less-experienced techniques for processing. Such an assignment may be further aided by finding correlations between RDM values for certain cases and the known processing durations associated with those cases.

The following RDM may be measured and used in the creation of either or both of dental restoration appliances and veneers {veneers are a type of dental restoration appliance}, with the objective of making the resulting teeth natural looking. Symmetry is generally a preferred facet. There may be differences between patients based on demographic differences. The generation of dental restoration appliances may benefit from some or all of the following RDM. Shade and translucency may pertain, in particular, to the creation of veneers, though some implementations of dental restoration appliances may also consider this information.

Examples of inter-tooth RDM are enumerated below.
1) Bilateral Symmetry and/or Ratios: A measure of the symmetry between one or more teeth and one or more other teeth on opposite sides of the dental. For example, for a pair of corresponding teeth, a measure of the width of each tooth. In one instance, the one tooth is of normal width, and the other tooth is too narrow. In another instance, both teeth are of normal width. The following is a list of attributes that can be measured for a tooth, and compared to the corresponding measurement for one or more corresponding teeth: a) width—mesial to distal distance; b) length—gingival to incisal distance; c) diagonal—distance across the tooth, e.g., from the mesial gingival corner to the distal incisal corner (this measure is one of many that can be used to quantify the shape of teeth beyond length and width). Ratios between a and b may be computed, such as a/b or b/a. Such ratios can be indicative of whether spatial symmetry exists (e.g., by measuring the ratio a/b on the left side and measuring the ratio a/b on the right side, then compare the left and right ratios). In some implementations, where spatial symmetry is “off”, the length, width and/or ratios may not match. Such a ratio may, in some implementations, be computed relative to a standard. A number of esthetic standards are available in the dental literature. Examples include Golden Proportion and Recurring Esthetic Dental Proportion. In some implementations, spatial symmetry may be measured on a pair of teeth, where one tooth is on the right side of the arch, and the other tooth is on the left side of the arch.
2) Proportions of Adjacent Teeth: Measure the width proportions of adjacent teeth as measured as a projection along an arch onto a plane (e.g., a plane that is situated in front of the patient's face). The ideal proportions for use in the final restoration design can be, for example, the so-called golden proportions. The golden proportions relate adjacent teeth, such as central incisors and lateral incisors. This metric pertains to the measuring of these proportions as the proportions exist in the pre-restoration mal dentition. The ideal golden proportions are 1.6, 1, 0.6, for the central incisor, lateral incisor and cuspid, on a particular side (either left or right) for a particular arch (e.g., the upper arch). If one or more of these proportion values is off (e.g., in the case of “peg laterals”), the patient may wish for dental restoration treatment to correct the proportions.
3) Arch Discrepancies: A measure of any size discrepancies between the upper arch and lower arch, for example, pertaining to the widths of the teeth, for the purpose of dental restoration. For example, techniques of this disclosure may make adjacent tooth width proportion measurements in the upper arch and in the lower arch. In some implementations, Bolton analysis measurements may be made by measuring upper widths, lower widths, and proportions between those quantities. Arch discrepancies may be described in absolute measurements (e.g., in mm or other suitable units) or in terms of proportions or ratios, in various implementations.
4) Midline: A measure of the midline of the maxillary incisors, relative to the midline of the mandibular incisors. Techniques of this disclosure may measure the midline of the maxillary incisors, relative to the midline of the nose (if data about nose location is available).
5) Proximal Contacts: A measure of the size (area, volume, circumference, etc.) of the proximal contact between adjacent teeth. In the ideal circumstance, the teeth touch along the mesial/distal surfaces and the gums fill in gingivally to where the teeth touch. Black triangles may form if the gum tissue fails to fill the space below the proximal contact. In some instances, the size of the proximal contact may get progressively shorter for teeth located farther towards the posterior of the arch. In an ideal scenario, the proximal contact would be long enough so that there is an appropriately sized incisal embrasure and the gum tissue fills in the area below or gingival to the contact.
6) Embrasure: In some implementations, techniques of this disclosure may measure the size (area, volume, circumference, etc.) of an embrasure, the gap between teeth at either of the gingival or incisal edge. In some implementations, techniques of this disclosure may measure the symmetry between embrasures on opposite sides of the arch. An embrasure is based at least in part on the length of the length of the contact between teeth, and/or at least in part on the shape of the tooth. In some instances, the size of the embrasure may get progressively longer for teeth located farther towards the posterior of the arch.

Examples of Intra-tooth RDM are enumerated below, continuing with the numbering of other RDM listed above.
7) Length and/or Width: A measure of the length of a tooth relative to the width of that tooth. This metric may reveal, for example, that a patient has long central incisors. Width and length are defined as: a) width—mesial to distal distance; b) length—gingival to incisal distance; c) other dimensions of tooth body—the portions of tooth between the gingival region and the incisal edge. In some implementations, either or both of a length and a width may be measured for a tooth and compared to the length and/or width of one or more teeth.
8) Tooth Morphology: A measure of the primary anatomy of the tooth shape, such as line angles, buccal contours, and/or incisal angles and/or embrasures. The frequency and/or dimensions may be measured. In some implementations, the observed primary tooth shape aspects may be matched to one or more known styles. Techniques of this disclosure may measure secondary anatomy of the tooth shape, such as mamelon grooves. For instance, the frequency and/or dimensions may be measured. In some implementations, the observed secondary tooth shape aspects may be matched to one or more known styles. In some examples, techniques of this disclosure may measure tertiary anatomy of the tooth shape, such as perikymata or striations. For instance, the frequency and/or dimensions may be measured. In some implementations, the observed tertiary tooth shape aspects may be matched to one or more known styles.
9) Shade and/or Translucency: A measure of tooth shade and/or translucency. Tooth shade is often described by the Vita Classical or 3D Master shade guide. Tooth translucency is described by transmittance or a contrast ratio. Tooth shade and translucency may be evaluated (or measured) based on one or more of the following kinds of data pertaining to teeth: the incisal edge, incisal third, body and gingival third. The enamel layer translucency is general higher than the dentin or cementum layer. Shade and translucency may, in some implementations, be measured on a per-voxel (local) basis. Shade and translucency may, in some implementations, be measured on a per-area basis, such as an incisal area, tooth body area, etc. Tooth body may pertain to the portions of the tooth between the gingival region and the incisal edge.
10) Height of Contour: A measure of the contour of a tooth. When viewed from the proximal view, all teeth have a specific contour or shape, moving from the gingival aspect to the incisal. This is referred to as the facial contour of the tooth. In each tooth, there is a height of contour, where that shape is the most pronounced. This height of contour changes from the teeth in the anterior of the arch to the teeth in the posterior of the arch. In some implementations, this measurement may take the form of fitting against a template of known dimensions and/or known proportions. In some implementations, this measurement may quantify a degree of curvature along the facial tooth surface. In some implementations, measure the location along the contour of the tooth where the height of the curvature is most pronounced. This location may be measured as a distance away from the gingival margin or a distance away from the incisal edge, or a percentage along the length of the tooth.

PCT Application with Publication No. WO2020026117A1 is incorporated herein by reference in its entirety. WO2020026117A1 lists some examples of Orthodontic Metrics (OM). Further examples are disclosed herein. The orthodontic metrics may be used to quantify the physical arrangement of an arch of teeth for the purpose of orthodontic treatment (as opposed to restoration design metrics—which pertain to dentistry and describe the shape and/or form of one or more pre-restoration teeth, for the purpose of supporting dental restoration). These orthodontic metrics can measure how badly maloccluded the arch is, or conversely the metrics can measure how correctly arranged the teeth are. In some implementations, the GDL Setups model (or RL Setups, VAE Setups, Capsule Setups, MLP Setups, Diffusion Setups, PT Setups, Similarity Setups and FDG Setups) may incorporate one or more of these orthodontic metrics, or other similar or related orthodontic metrics. In some implementations, such orthodontic metrics may be incorporated into the feature vector for a mesh element, where these per-element feature vectors are fed into the setups prediction network as inputs. In some implementations, such orthodontic metrics may be directly consumed by a generator, an MLP, a transformer, or other neural network as direct inputs (such as presented in one or more input vectors of real numbers S, such as described elsewhere in this disclosure. The use of such orthodontic metrics in the training of the generator may improve the performance (i.e., correctness) of the resulting generator, resulting in predicted transforms which place teeth more nearly in the correct final setups poses than would otherwise be possible. Such orthodontic metrics may be consumed by an encoder structure or by a U-Net structure (in the case of GDL Setups). Such orthodontic metrics may be consumed by an autoencoder, variational autoencoder, masked autoencoder or regularized autoencoder (in the case of the VAE Setups, VAE Mesh Element Labelling, MAE Mesh In-Filling). Such orthodontic metrics may be consumed by a neural network which generates action predictions as a part of a reinforcement learning RL Setups model. Such orthodontic metrics may be consumed by a classifier which applies a label to a setup arch (e.g., labels such as mal, staging or final setup). This description is non-limiting, as the orthodontic metrics may also be incorporated in other ways into the various techniques of this disclosure.

The various loss calculations of the present disclosure may, in some examples, incorporate one or more orthodontic metrics, with the advantage of improving the correctness of the resulting neural network. An orthodontic metric may be used to directly compare a predicted example to the corresponding ground truth example (such as is done with the metrics in the Setups Comparison description). In other examples, one or more orthodontic metrics may be taken from this section and incorporated into a loss computation. Such an orthodontic metric may be computed on the predicted example, and then the orthodontic metric would also be computed on the ground truth example. These two orthodontic metrics results would then be consumed by the loss computation, with the advantage of improving the performance of the resulting neural network. In some implementations, one or more orthodontic metrics pertaining to the alignment of two or more adjacent teeth may be computed and incorporated into a loss function, for example, to train, at least in part, a setups prediction neural network. In some implementations, such an orthodontic metric may facilitate the network in aligning the mesial surface of a tooth with the distal surface of an adjacent tooth. Backpropagation is an example algorithm by which a neural network may be trained using one or more loss values.

In some implementations, one or more orthodontic metrics may be used to evaluate the predicted output of a neural network, such as a setups prediction. Such a metric(s) may enable the training algorithm to determine how close the predicted output is to an acceptable output, for example, in a quantified sense. In some implementations, this use of an orthodontic metric may enable a loss value to be computed which does not depend entirely on a comparison to a ground truth. In some implementations, such a use of an orthodontic metric may enable loss calculation and network training to proceed without the need for a comparison against a ground truth example. The advantage of such an approach is that loss may be computed based on a general principle or specification for the predicted output (such as a setup) rather than tying loss calculation to a specific ground truth example (which may have been defined by a particular doctor, clinician, or technician, whose treatment philosophy may differ from that of other technicians or doctors). In some implementations, such an orthodontic metric may be defined based on a FID (Frechet Inception Distance) score.

The following is a description of some of the orthodontic metrics which are used to quantify the state of a set of teeth in an arch for the purpose of orthodontic treatment. These orthodontic metrics indicate the degree of malocclusion that the teeth are in at a given stage of clear tray aligner treatment.

An orthodontic metric that can be computed using tensors may be especially advantageous when training one of the neural networks of the present disclosure, because tensor operations may promote efficient computations. The more efficient (and faster) the computation, the faster the rate at which training can proceed.

In some examples, an error pattern may be identified in one or more predicted outputs of an ML model (e.g., a transformation matrix for a predicted tooth setup, a labelling of mesh elements for mesh cleanup, an addition of mesh elements to a mesh for the purpose of mesh in-filling, a classification label for a setup, a classification label for a tooth mesh, etc.). One or more orthodontic metrics may be selected to become an input to the next round of ML model training, to address any pattern of errors or deficiencies which may be identified in the one or more predicted outputs.

Some OM may be defined relative to an archfrom coordinate frame, the LDE coordinate system. In some implementations, a point may be described using an LDE coordinate frame relative to an archform, where L, D and E correspond to: 1) Length along the curve of the archform, 2) Distance away from the archform, and 3) distance in the direction perpendicular to the L and D axes (which may be termed Eminence), respectively.

Various of the OM and other techniques of the present disclosure may compute collisions between 3D representations (e.g., of oral care objects, such as teeth). Such collisions may be computed as at least one of: 1) penetration distance between 3D tooth representations, 2) count of overlapping mesh elements between 3D tooth representations, and 3) volume of overlap between 3D tooth representations. In some implementations, an OM may be defined to quantify the collision of two or more 3D representations of oral care structures, such as teeth. Some optimization algorithms, such as setups prediction techniques, may seek to minimize collisions between oral care structures (such as teeth).

Six (6) metrics for the comparison of two or more arches are listed below. Other suitable comparison orthodontic metrics are found elsewhere in this disclosure, such as in the section for the Setups Comparison technique.
1. Rotation geodesic distance (rotation between predicted example and ground truth setup example)
2. Translation distance (gap between predicted example and ground truth setup example)
3. Normalized translation distance
4. 3D alignment error that measures the distance between predicted mesh elements and ground truth mesh elements, in units of mm.
5. Normalized 3D alignment
6. Percent overlap (% overlap) by volume (alternatively % overlap by mesh elements) of predicted example and corresponding ground truth example

Within-arch orthodontic metrics are as follows.
Alignment—A 3D tooth orientation vector may be calculated using the tooth's mesial-distal axis. A 3D vector, which may be tangent vector to the archform at the position of the tooth may also be calculated. The XY components (i.e., which may be 2D vectors) may then be used to compare the orientation of the archform at the tooth's location to the tooth's orientation in XY space. Cosine similarity may be used to calculate the 2D orientation difference (angle) between the archform tangent and the tooth's mesial-distal axis.

Arch Symmetry—For each left-right pair of teeth (e.g., lower left lateral incisor and/or lower right lateral incisor) the absolute difference may be calculated between each tooth's X-coordinate and the global coordinate reference frame's X-axis. This delta may indicate the arch asymmetry for a given tooth pair. The result of such a calculation may be the mean X-axis delta of one or more tooth-pairs from the arch. This calculation may, in some implementations, be performed relative to the Y-axis with y-coordinates (and/or relative to the Z axis with Z-coordinates).

Archform D-axis Differences—May compute the D dimension difference (i.e., the positional difference in the facial-lingual direction) between two arch states, for one or more teeth. May, in some implementations, return a dictionary of the D-direction tooth movement for each tooth, with tooth UNS number as the key. May use the LDE coordinate system relative to an archform.

Archform (Lower) Length Ratio—May compute the ratio between the current lower arch length and the arch length as it was in the original maloccluded lower arch.

Archform (Upper) Length Ratio—May compute the ratio between the current upper arch length and the arch length as it was in the original maloccluded upper arch.

Archform Parallelism (Full arch)—For at least one local tooth coordinate system origin in the upper arch, the one or more nearest origins (e.g., tooth local coordinate system origins) in the lower arch. In some implementations, the two nearest origins may be used. May compute the straight line distance from the upper arch point to the line formed between the origins of the two teeth in the opposing (lower) arch. May return the standard deviation of the set of “point-to-line” distances mentioned above, where the set may be composed of the point-to-line distances for each tooth in the arch.

Archform Parallelism (Individual tooth)—This metric may share some computational elements with the archform_parallelism_global orthodontic metric, except that this metric may input the mean distance from a tooth origin to the line formed by the neighboring teeth in opposing arches (e.g., a tooth in the upper arch and the corresponding tooth in the lower arch). The mean distance may be computed for one or more such pairs of teeth. In some implementations, this may be computed for all pairs of teeth. Then the mean distance may be subtracted from the distance that is computed for each tooth pair. This OM may yield the deviation of a tooth from a “typical” tooth parallelism in the arch.

Buccolingual Inclination—For at least one molar or premolar, find the corresponding tooth on the opposite side of the same arch (i.e., for a tooth on the left side of the arch, find the same type of tooth on the right side and vice versa). This OM may compute an n-element list for each tooth (e.g. n may equal 2). This list may contain at least the tooth IDs of the teeth in each pair of teeth (e.g., LeftLowerFirstMolar and RightLowerFirstMolar in a list=[left_tooth_idx_1, right_tooth_idx_2]). Such an n-element vector may be computed for each molar and each premolar in the upper and lower arches. The buccal cusps maybe identified on the molars and premolars on each of the left and right sides of the arch. Draw a line between the buccal cusps of the left tooth and the buccal cusps on the right tooth. Make a plane using this line and the z-axis of the arch. The lingual cusps may be projected onto the plane (i.e., at this point the angle of inclination may be determined). By performing an additional projection, the approximate vertical distance between the lingual cusps and the buccal cusps may be computed. This distance may be used as the buccolingual inclination OM.

Canine Overbite—The upper and lower canines may be identified. The first premolar for the given side of the mouth may be identified. On a given side of the arch, a distance may be computed between the upper canine and the lower canine, and also between the upper pre-molar and the lower pre-molar. The average (or median, or mode or some other statistic) may be computed for the measured distances. The z-component of this result indicates the degree of overbite. Overbite may be computed between any tooth in one arch and the corresponding tooth in the other arch.

Canine Overjet Contact—May calculate the collisions (e.g., collision distances) between pairs of canines on opposing arches.

Canine Overjet Contact KDE—May take an orthodontic metric score for the current patient case as input, and may convert that score into to a log-likelihood using a previously trained kernel density estimation (KDE) model or distribution. This operation may yield information about where in the distribution of “typical” values this patient case lies.

Canine Overjet—This OM may share some computational steps with the canine overbite OM. In some implementations, average distances may be computed. In some implementations, the distance calculation may compute the Euclidean distance of the XY components of a tooth in the upper arch and a tooth in the lower arch, to yield overjet (i.e., as opposed to computing the difference in Z-components, as may be performed for canine overbite). Overjet may be computed between any tooth in one arch and the corresponding tooth in the other arch.

Canine Class Relationship (also applies to first, second and third molars)—This OM may, in some implementations comprise two functions (e.g., written in Python).
get canine_landmarkso: Get landmarks for each tooth which may be used to compute the class relationship, and then, in some implementations, map those landmarks onto the global coordinate space so that measurements may be made between teeth.
class_relationship_score_by_side( ): May compute the average position of at least one landmark on at least one tooth in the lower arch, and may compute the same for the upper arch. Then may compute the vector from the upper arch landmark position to the lower arch landmark position, and finally projects this vector onto the lower arch to yield a quantification (e.g., as a scalar) of the amount of delta in “arch1-axis” position there is. This OM may compute how far forward or behind the tooth is positioned on the 1-axis relative to the tooth or teeth of interest in the opposing arch.

Crossbite—Fossa in at least one upper molar may be located by finding the halfway point between distal and mesial marginal ridge saddles of the tooth. A lower molar cusp may lie between the marginal ridges of the corresponding upper molar. This OM may compute a vector from the upper molar fossa midpoint to the lower molar cusp. This vector may be projected onto the d-axis of the archform, yielding a lateral measure of distance from the cusp to the fossa. This distance may define the crossbite magnitude.

Edge Alignment—This OM may identify the leftmost and rightmost edges of a tooth, and may identify the same for that tooth's neighbor.
The OM may then draw a vector from the leftmost edge of the tooth to the leftmost edge of the tooth's neighbor.
The OM may then draw a vector from the rightmost edge of the tooth to the rightmost edge of the tooth's neighbor.
The OM may then calculates the linear fit error between the two vectors.
Such a calculation may involve making two vectors:

$$Vec\_tooth = right\_tooths \_leftside to left\_tooths \_leftside$$

$$Vec\_neighbor = right\_tooths \_rightside to left\_tooths \_leftside$$

And then may involve computing the dot-product of these two vectors and subtracting the result from 1. (i.e., EdgeAlignment score=1−abs(dot(Vec_tooth, Vec_neighbor))).
A score of 0 may indicate perfect alignment. A score of 1 may mean perpendicular alignment.

Incisor Interarch Contact KDE—May identify the deviation of the IncisorInterarchContact from the mean of a modeled distribution of such statistics across a dataset of one or more other patient cases.

Leveling—May compute a measure of leveling between a tooth and its neighbor. This OM may calculate the difference in height between two or more neighboring teeth. For molars, this OM may use the midpoint between the mesial and distal saddle ridges as the height of the molar. For non-molar teeth, this OM may use the length of the crown from gums to tip. In some implementations, the tip may be the origin of the local coordinate space of the tooth. Other implementations may place the origin in other locations. A simple subtraction between the heights of neighboring teeth may yield the leveling delta between the teeth (e.g., by comparing Z components).

Midline—May compute the position of the midline for the upper incisors and/or the lower incisors, and then may compute the distance between them.

Molar Interarch Contact KDE—May compute a molar interarch contact score (i.e., a collision depth or other type of collision), and then may identify where that score lies in a pre-defined KDE (distribution) built from representative cases.

Occlusal Contacts—For a particular tooth from the arch, this OM may identify one or more landmarks (e.g., mesial cusp, or central cusp, etc.). Get the tooth transform for that tooth. For each cusp on the current tooth, the cusp may be scored according to how well the cusp contacts the neighboring (corresponding) tooth in the opposite arch. A vector may be found from the cusp of the tooth in question to the vertical intersection point in the corresponding tooth of the opposing arch. The distance and/or direction (i.e., up or down) to the opposing arch may be computed. A list may be returned that contains the resulting signed distances, one for each cusp on the tooth in question.

Overbite—The upper and lower central incisors may be compared along the z-axis. The difference along the z-axis may be used as the overbite score.

Overjet—The upper and lower central incisors may be compared along the y-axis. The difference along the y-axis may be used as the overjet score.

Molar Interarch Contact—May calculate the contact score between molars, and may use collision measurement(s) (such as collision depth).

Root Movement d—The tooth transforms for an initial state and a next state may be received. The archform axes at a point L along the archform may be computed. This OM may return a distance moved along the d-axis. This may be accomplished by projecting the root pivot point onto the d-axis.

Root Movement 1—The tooth transforms for an initial state and a next state may be received. The archform axes at a point L along the archform may be computed. This OM may return a distance moved along the 1-axis. This may be accomplished by projecting the root pivot point onto the 1-axis.

Spacing—May compute the spacing between each tooth and its neighbor. The transforms and meshes for the arch may be received. The left and right edges of each tooth mesh may be computed. One or more points of interest may be transformed from local coordinates into the global arch coordinate frame. The spacing may be computed in a plane (e.g., the XY plane) between each tooth and its neighbor to the “left”.

May return an array of one or more Euclidean distances (e.g., such as in the XY plane) which may represent the spacing between each tooth and its neighbor to the left.

Torque—May compute torque (i.e., rotation around and axis, such as the x-axis). For one or more teeth, one or more rotations may be converted from Euler angles into one or more rotation matrices. A component (such as a x-component) of the rotations may be extracted and converted back into Euler angles. This x-component may be interpreted as the torque for a tooth. A list maybe returned which contains the torque for one or more teeth, and may be indexed by the UNS number of the tooth.

The neural networks of this disclosure may exploit one or more benefits of the operation of parameter tuning, whereby the inputs and parameters of a neural network are optimized to produce more data-precide results. One parameter which may be tuned is neural network learning rate (e.g., which may have values such as 0.1, 0.01, 0.001, etc.). Data augmentation schemes may also be tuned or optimized, such as schemes where “shiver” is added to the tooth meshes before being input to the neural network (i.e., small random rotations, translations and/or scaling may be applied to vary the dataset and make the neural network robust to variations in data).

A subset of the neural network model parameters available for tuning are as follows:
Learning rate (LR) decay rate (e.g., how much the LR decays during a training run)
Learning rate (LR). The floating-point value (e.g., 0.001) that is used by the optimizer.
LR schedule (e.g., cosine annealing, step, exponential)
Voxel size (for cases with sparse mesh processing operations)
Dropout % (e.g., dropout which may be performed in a linear encoder]
LR decay step size (e.g., decay every 10 or 20 or 30 epochs)
Model scaling, which may increase or decrease the count of layers and/or the count of parameters per layer.

Parameter tuning may be advantageously applied to the training of a neural network for the prediction of final setups or intermediate staging to provide data precision-oriented technical improvements. Parameter tuning may also be advantageously applied to the training of a neural network for mesh element labeling or a neural network for mesh in-filling. In some examples, parameter tuning may be advantageously applied to the training of a neural network for tooth reconstruction. In terms of classifier models of this disclosure, parameter tuning may be advantageously applied to a neural network for the classification of one or more setups (i.e., classification of one or more arrangements of teeth). The advantage of parameter tuning is to improve the data precision of the output of a predictive model or a classification model. Parameter tuning may, in some instances, provide the advantage of obtaining the last remaining few percentage points of validation accuracy out of a predictive or classification model.

Various loss calculation techniques are generally applicable to the techniques of this disclosure (e.g., GDL Setups, RL Setups, VAE Setups, Capsule Setups, MLP Setups, Diffusion Setups, PT Setups, Similarity Setups, Setups Classification, Tooth Classification, VAE Mesh Element Labelling, MAE Mesh In-Filling and the imputation of procedure parameters).

These losses include L1 loss, L2 loss, mean squared error (MSE) loss, cross entropy loss, among others. Losses may be computed and used in the training of neural networks, such as multi-layer perceptron's (MLP), U-Net structures, generators and discriminators (e.g., for GANs), autoencoders, variational autoencoders, regularized autoencoders, masked autoencoders, transformer structures, or the like. Some implementations may use either triplet loss or contrastive loss, for example, in the learning of sequences.

Losses may also be used to train encoder structures and decoder structures. A KL-Divergence loss may be used, at least in part, to train one or more of the neural networks of the present disclosure, such as a mesh reconstruction autoencoder or the generator of GDL Setups, which the advantage of imparting Gaussian behavior to the optimization space. This Gaussian behavior may enable a reconstruction autoencoder to produce a better reconstruction (e.g., when a latent vector representation is modified and that modified latent vector is reconstructed using a decoder, the resulting reconstruction is more likely to be a valid instance of the inputted representation). There are other techniques for computing losses which may be described elsewhere in this disclosure. Such losses may be based on quantifying the difference between two or more 3D representations.

MSE loss calculation may involve the calculation of an average squared distance between two sets, vectors or datasets. MSE may be generally minimized. MSE may be applicable to a regression problem, where the prediction generated by the neural network or other machine learning model may be a real number. In some implementations, a neural network may be equipped with one or more linear activation units on the output to generate an MSE prediction. Mean absolute error (MAE) loss and mean absolute percentage error (MAPE) loss can also be used in accordance with the techniques of this disclosure.

Cross entropy may, in some implementations, be used to quantify the difference between two or more distributions. Cross entropy loss may, in some implementations, be used to train the neural networks of the present disclosure. Cross entropy loss may, in some implementations, involve comparing a predicted probability to a ground truth probability. Other names of cross entropy loss include “logarithmic loss,” “logistic loss,” and “log loss”. A small cross entropy loss may indicate a better (e.g., more accurate) model. Cross entropy loss may be logarithmic. Cross entropy loss may, in some implementations, be applied to binary classification problems. In some implementations, a neural network may be equipped with a sigmoid activation unit at the output to generate a probability prediction. In the case of multi-class classifications, cross entropy may also be used. In such a case, a neural network trained to make multi-class predictions may, in some implementations, be equipped with one or more softmax activation functions at the output (e.g., where there is one output node for class that is to be predicted). Other loss calculation techniques which may be applied in the training of the neural networks of this disclosure include one or more of: Huber loss, Hinge loss, Categorical hinge loss, cosine similarity, Poisson loss, Logcosh loss, or mean squared logarithmic error loss (MSLE). Other loss calculation methods are described herein and may be applied to the training of any of the neural networks described in the present disclosure.

One or more of the neural networks of the present disclosure may, in some implementations, be trained, at least in part by a loss which is based on at least one of: a Point-wise Mesh Euclidean Distance (PMD) and an Earth Mover's Distance (EMD). Some implementations may incorporate a Hausdorff Distance (HD) calculation into the loss calculation. Computing the Hausdorff distance between two or more 3D representations (such as 3D meshes) may provide one or more technical improvements, in that the HD not only accounts for the distances between two meshes, but also accounts for the way that those meshes are oriented, and the relationship between the mesh shapes in those orientations (or positions or poses). Hausdorff distance may improve the comparison of two or more tooth meshes, such as two or more instances of a tooth mesh which are in different poses (e.g., such as the comparison of predicted setup to ground truth setup which may be performed in the course of computing a loss value for training a setups prediction neural network).

Reconstruction loss may compare a predicted output to a ground truth (or reference) output. Systems of this disclosure may compute reconstruction loss as a combination of L1 loss and MSE loss, as shown in the following line of pseudocode: reconstruction_loss=0.5*L1(all_points_target,all_points_predicted)+0.5*MSE(all_points_target,all_points_predicted). In the above example, all_points_target is a 3D representation (e.g., a 3D mesh or point cloud) corresponding to ground truth data (e.g., a ground truth tooth restoration design, or a ground truth example of some other 3D oral care representation). In the above example, all points_predicted is a 3D representation (e.g., a 3D mesh or point cloud) corresponding to generated or predicted data (e.g., a generated tooth restoration design, or a generated example of some other kind of 3D oral care representation). Other implementations of reconstruction loss may additionally (or alternatively) involve L2 loss, mean absolute error (MAE) loss or Huber loss terms.

Reconstruction error may compare reconstructed output data (e.g., as generated by a reconstruction autoencoder, such as a tooth design which has been generated for use in generating a dental restoration appliance) to the original input data (e.g., the data which were provided to the input of the reconstruction autoencoder, such as a pre-restoration tooth). Systems of this disclosure may compute reconstruction error as a combination of L1 loss and MSE loss, as shown in the following line of pseudocode: reconstruction_error=0.5*L1(all_points_input, all points reconstructed)+0.5*MSE(all_points_input, all_points_reconstructed). In the above example, all_points_input is a 3D representation (e.g., a 3D mesh or point cloud) corresponding to input data (e.g., the pre-restoration tooth design which was provided to a reconstruction autoencoder, or another 3D oral care representation which is provided to the input of an ML model). In the above example, all_points_reconstructed is a 3D representation (e.g., 3D mesh or point cloud) corresponding to reconstructed (or generated) data (e.g., a reconstructed tooth restoration design, or another example of a generated 3D oral care representation).

In other words, reconstruction loss is concerned with computing a difference between a predicted output and a reference output, whereas reconstruction error is concerned with computing a difference between a reconstructed output and an original input from which the reconstructed data are derived.

The techniques of this disclosure may include operations such as 3D convolution, 3D pooling, 3D unconvolution and 3D unpooling. 3D convolution may aid segmentation processing, for example in down sampling a 3D mesh. 3D un-convolution undoes 3D convolution, for example, in a U-Net. 3D pooling may aid the segmentation processing, for example in summarized neural network feature maps. 3D un-pooling undoes 3D pooling, for example in a U-Net. These operations may be implemented by way of one or more layers in the predictive or generative neural networks described herein. These operations may be applied directly on mesh elements, such as mesh edges or mesh faces. These operations provide for technical improvements over other approaches because the operations are invariant to mesh rotation, scale, and translation changes. In general, these operations depend on edge (or face) connectivity, therefore these operations remain invariant to mesh changes in 3D space as long as edge (or face) connectivity is preserved. That is, the operations may be applied to an oral care mesh and produce the same output regardless of the orientation, position or scale of that oral care mesh, which may lead to data precision improvement. MeshCNN is a general-purpose deep neural network library for 3D triangular meshes, which can be used for tasks such as 3D shape classification or mesh element labelling (e.g., for segmentation or mesh cleanup). MeshCNN implements these operations on mesh edges. Other toolkits and implementations may operate on edges or faces.

In some implementations of the techniques of this disclosure, neural networks may be trained to operate on 2D representations (such as images). In some implementations of the techniques of this disclosure, neural networks may be trained to operate on 3D representations (such as meshes or point clouds). An intraoral scanner may capture 2D images of the patient's dentition from various views. An intraoral scanner may also (or alternatively) capture 3D mesh or 3D point cloud data which describes the patient's dentition. According to various techniques, autoencoders (or other neural networks described herein) may be trained to operate on either or both of 2D representations and 3D representations.

A 2D autoencoder (comprising a 2D encoder and a 2D decoder) may be trained on 2D image data to encode an input 2D image into a latent form (such as a latent vector or a latent capsule) using the 2D encoder, and then reconstruct a facsimile of the input 2D image using the 2D decoder. In the case of a handheld mobile app which has been developed for such analysis (e.g., for the analysis of dental anatomy), 2D images may be readily captured using one or more of the onboard cameras. In other examples, 2D images may be captured using an intraoral scanner which is configured for such a function. Among the operations which may be used in the implementation a 2D autoencoder (or other 2D neural network) for 2D image analysis are 2D convolution, 2D pooling and 2D reconstruction error calculation.

2D image convolution may involve the “sliding” of a kernel across a 2D image and the calculation of elementwise multiplications and the summing of those elementwise multiplications into an output pixel. The output pixel that results from each new position of the kernel is saved into an output 2D feature matrix. In some implementations, neighboring elements (e.g., pixels) may be in well-defined locations (e.g., above, below, left and right) in a rectilinear grid.

A 2D pooling layer may be used to down sample a feature map and summarize the presence of certain features in that feature map.

2D reconstruction error may be computed between the pixels of the input and reconstructed images. The mapping between pixels may be well understood (e.g., the upper pixel [23,134] of the input image is directly compared to pixel [23,134] of the reconstructed image, assuming both images have the same dimensions).

Among the advantages provided by the 2D autoencoder-based techniques of this disclosure is the ease of capturing 2D image data with a handheld device. In some instances, where outside data sources provide the data for analysis, there may be instances where only 2D image data are available. When only 2D image data are available, then analysis using a 2D autoencoder is warranted.

Modern mobile devices (such as commercially available smartphones) may also have the capability of generating 3D data (e.g., using multiple cameras and stereophotogrammetry, or one camera which is moved around the subject to capture multiple images from different views, or both), which in some implementations, may be arranged into 3D representations such as 3D meshes, 3D point clouds and/or 3D voxelized representations. The analysis of a 3D representation of the subject may in some instances provide technical improvements over 2D analysis of the same subject. For example, a 3D representation may describe the geometry and/or structure of the subject with less ambiguity than a 2D representation (which may contain shadows and other artifacts which complicate the depiction of depth from the subject and texture of the subject). In some implementations, 3D processing may enable technical improvements because of the inverse optics problem which may, in some instances, affect 2D representations. The inverse optics problem refers to the phenomenon where, in some instances, the size of a subject, the orientation of the subject and the distance between the subject and the imaging device may be conflated in a 2D image of that subject. Any given projection of the subject on the imaging sensor could map to an infinite count of {size, orientation, distance}pairings. 3D representations enable the technical improvement in that 3D representations remove the ambiguities introduced by the inverse optics problem.

A device that is configured with the dedicated purpose of 3D scanning, such as a 3D intraoral scanner (or a CT scanner or MI scanner), may generate 3D representations of the subject (e.g., the patient's dentition) which have significantly higher fidelity and precision than is possible with a handheld device. When such high-fidelity 3D data are available (e.g., in the application of oral care mesh classification or other 3D techniques described herein), the use of a 3D autoencoder is offers technical improvements (such as increased data precision), to extract the best possible signal out of those 3D data (i.e., to get the signal out of the 3D crown meshes used in tooth classification or setups classification).

A 3D autoencoder (comprising a 3D encoder and a 3D decoder) may be trained on 3D data representations to encode an input 3D representation into a latent form (such as a latent vector or a latent capsule) using the 3D encoder, and then reconstruct a facsimile of the input 3D representation using the 3D decoder. Among the operations which may be used to implement a 3D autoencoder for the analysis of a 3D representation (e.g., 3D mesh or 3D point cloud) are 3D convolution, 3D pooling and 3D reconstruction error calculation.

For each mesh element, a 3D convolution may be performed to aggregate local features from nearby mesh elements. Processing may be performed above and beyond the techniques for 2D convolution, to account for the differing count and locations of neighboring mesh elements (relative to a particular mesh element). A particular 3D mesh element may have a variable count of neighbors and those neighbors may not be found in expected locations (as opposed to a pixel in 2D convolution which may have a fixed count of neighboring pixels which may be found in known or expected locations). In some instances, the order of neighboring mesh elements may be relevant to 3D convolution. 3D pooling:

A 3D pooling operation may enable the combining of features from a 3D mesh (or other 3D representation) at multiple scales. 3D pooling may iteratively reduce a 3D mesh into mesh elements which are most highly relevant to a given application (e.g., for which a neural network has been trained). Similarly to 3D convolution, 3D pooling may benefit from special processing beyond that entailed in 2D convolution, to account for the differing count and locations of neighboring mesh elements (relative to a particular mesh element). In some instances, the order of neighboring mesh elements may be less relevant to 3D pooling than to 3D convolution.

3D reconstruction error may be computed using one or more of the techniques described herein, such as computing Euclidean distances between corresponding mesh elements, between the two meshes. Other techniques are possible in accordance with aspects of this disclosure. 3D reconstruction error may generally be computed on 3D mesh elements, rather than the 2D pixels of 2D reconstruction error. 3D reconstruction error may enable technical improvements over 2D reconstruction error, because a 3D representation may, in some instances, have less ambiguity than a 2D representation (i.e., have less ambiguity in form, shape and/or structure). Additional processing may, in some implementations, be entailed for 3D reconstruction which is above and beyond that of 2D reconstruction, because of the complexity of mapping between the input and reconstructed mesh elements (i.e., the input and reconstructed meshes may have different mesh element counts, and there may be a less clear mapping between mesh elements than there is for the mapping between pixels in 2D reconstruction). The technical improvements of 3D reconstruction error calculation include data precision improvement.

A 3D representation may be produced using a 3D scanner, such as an intraoral scanner, a computerized tomography (CT) scanner, ultrasound scanner, a magnetic resonance imaging (NMI) machine or a mobile device which is enabled to perform stereophotogrammetry. A 3D representation may describe the shape and/or structure of a subject. A 3D representation may include one or more 3D mesh, 3D point cloud, and/or a 3D voxelized representation, among others. A 3D mesh includes edges, vertices, or faces. Though interrelated in some instances, these three types of data are distinct. The vertices are the points in 3D space that define the boundaries of the mesh. These points would alternatively be described as a point cloud but for the additional information about how the points are connected to each other, as described by the edges. An edge is described by two points and can also be referred to as a line segment. A face is described by a number of edges and vertices. For instance, in the case of a triangle mesh, a face comprises three vertices, where the vertices are interconnected to form three contiguous edges. Some meshes may contain degenerate elements, such as non-manifold mesh elements, which may be removed, to the benefit of later processing. Other mesh pre-processing operations are possible in accordance with aspects of this disclosure. 3D meshes are commonly formed using triangles, but may in other implementations be formed using quadrilaterals, pentagons, or some other n-sided polygon. In some implementations, a 3D mesh may be converted to one or more voxelized geometries (i.e., comprising voxels), such as in the case that sparse processing is performed. The techniques of this disclosure which operate on 3D meshes may receive as input one or more tooth meshes (e.g., arranged in one or more dental arches). Each of these meshes may undergo pre-processing before being input to the predictive architecture (e.g., including at least one of an encoder, decoder, pyramid encoder-decoder and U-Net). This pre-processing may include the conversion of the mesh into lists of mesh elements, such as vertices, edges, faces or in the case of sparse processing—voxels. For the chosen mesh element type or types, (e.g., vertices), feature vectors may be generated. In some examples, one feature vector is generated per vertex of the mesh. Each feature vector may contain a combination of spatial and/or structural features, as specified in the following table:

TABLE 1

| Element | Spatial Features | Structural Features |
|---|---|---|
| Edges | XYZ position of an edge | Edge curvature (depends on a |
| | midpoint, XYZ positions | connectivity neighborhood, |
| | of the edge vertices, or | average curvature of two |
| | the normal vector at an | vertices), dihedral angles, edge |
| | edge midpoint (average | length, density measure such as |
| | of the normal vectors of | a count of incident edges (i.e., a |
| | two vertices). | count of the other neighboring |
| | | edges which share the vertices |
| | | of that edge). |
| Faces | XYZ position of a face | Face curvature (average |
| | centroid, surface normal | curvature of the vertices of the |
| | vector. | face), face area, density measure |
| | | such as count of adjacent faces |
| | | (i.e., which share at least one |
| | | edge with the face). |
| Points | XYZ position | Density measure such as the |
| | | count of neighboring points |
| | | within a radius of the point |
| Vertices | XYZ position, normal | Vertex curvature, density |
| | vector (weighted average | measure such as the count of |
| | of the normal vectors of | vertices within a radius of the |
| | the connecting faces for | vertex, density measure such as |
| | the vertex). | the count of incident edges. |
| Voxels | XYZ centroid. | Volume, [height × depth × width] |
| | | dimensions, density measure |
| | | such as a count of contained |
| | | vertices, density measure such as |
| | | count of intersected faces, |
| | | density measure such as count of |
| | | intersected edges. |

Table 1 discloses non-limiting examples of mesh element features. In some implementations, color (or other visual cues/identifiers) may be considered as a mesh element feature in addition to the spatial or structural mesh element features described in Table 1. As used herein (e.g., in Table 1), a point differs from a vertex in that a point is part of a 3D point cloud, whereas a vertex is part of a 3D mesh and may have incident faces or edges. A dihedral angle (which may be expressed in either radians or degrees) may be computed as the angle (e.g., a signed angle) between two connected faces (e.g., two faces which are connected along an edge). A sign on a dihedral angle may reveal information about the convexity or concavity of a mesh surface. For example, a positively signed angle may, in some implementations, indicate a convex surface. Furthermore, a negatively signed angle may, in some implementations, indicate a concave surface. To calculate the principal curvature of a mesh vertex, directional curvatures may first be calculated to each adjacent vertex around the vertex. These directional curvatures may be sorted in circular order (e.g., 0, 49, 127, 210, 305 degrees) in proximity to the vertex normal vector and may comprise a subsampled version of the complete curvature tensor. Circular order means: sorted in by angle around an axis. The sorted directional curvatures may contribute to a linear system of equations amenable to a closed form solution which may estimate the two principal curvatures and directions, which may characterize the complete curvature tensor. Consistent with Table 1, a voxel may also have features which are computed as the aggregates of the other mesh elements (e.g., vertices, edges and faces) which either intersect the voxel or, in some implementations, are predominantly or fully contained within the voxel. Rotating the mesh may not change structural features but may change spatial features. And, as described elsewhere in this disclosure, the term “mesh” should be considered in a non-limiting sense to be inclusive of 3D mesh, 3D point cloud and 3D voxelized representation. In some implementations, apart from mesh element features, there are alternative methods of describing the geometry of a mesh, such as 3D keypoints and 3D descriptors. Examples of such 3D keypoints and 3D descriptors are found in “TONIONI A, et al. in ‘Learning to detect good 3D keypoints.’, Int J Comput. Vis. 2018 Vol 0.126, pages 1-20.”. 3D keypoints and 3D descriptors may, in some implementations, describe extrema (either minima or maxima) of the surface of a 3D representation. In some implementations, one or more mesh element features may be computed, at least in part, via deep feature synthesis (DFS), e.g. as described in: J. M. Kanter and K. Veeramachaneni, “Deep feature synthesis: Towards automating data science endeavors,” 2015 IEEE International Conference on Data Science and Advanced Analytics (DSAA), 2015, pp. 1-10, doi: 10.1109/DSAA.2015.7344858.

Representation generation neural networks based on autoencoders, U-Nets, transformers, other types of encoder-decoder structures, convolution and/or pooling layers, or other models may benefit from the use of oral care arguments (e.g., oral care metrics or oral care parameters). For example, oral care metrics (e.g., orthodontic metrics or restoration design metrics) may convey aspects of the shape and/or structure of the patient's dentition (e.g., the shape and/or structure of an individual tooth, or the special relationships between two or more teeth) to the neural network models of this disclosure. Each oral care metric describes distinct information about the patient's dentition that may not be redundantly present in other input data that are provided to the neural network. For example, an “Overbite” metric may quantify the overlap between the upper and lower central incisors along the vertical Z-axis, information which may not otherwise, in some implementations, be readily ascertainable by a traditional neural network. Stated another way, the oral care metrics provide refined information about the patient's dentition that a traditional neural network (e.g., a representation generation neural network) may not be adequately trained or configured to extract. However, a neural network which is specifically trained to generate oral care metrics may overcome such a shortcoming, because, for example loss may be computed in such a way as to facilitate accurate oral care metrics prediction. Mesh oral care metrics may provide a processed version of the structure and/or shape of the patient's dentition, data which may not otherwise be available to the neural network. This processed information is often more accessible, or more amenable for encoding by the neural network. A system implementing the techniques disclosed herein has been utilized to run a number of experiments on 3D representations of teeth. For example, oral care metrics have been provided to a representation generation neural network which is based on a U-Net model. Based on experiments, it was found that systems using oral care metrics (e.g., “Overbite”, “Overjet” and “Canine Class Relationship” metrics) were at least 2.5% more accurate than systems that did not. Furthermore, training converges more quickly when the oral care metrics are used. Stated another way, the machine learning models trained using oral care metrics tended to be more accurate more quickly (at earlier epochs) than systems which did not. For an existing system observed to have a historical accuracy rate of 91%, an improvement in accuracy of 2.5% reduces the actual error rate by almost 30%.

Predictive models which may operate on feature vectors of the aforementioned features include but are not limited to: GDL Setups, RL Setups, VAE Setups, Capsule Setups, MLP Setups, Diffusion Setups, PT Setups, Similarity Setups, Tooth Classification, Setups Classification, Setups Comparison, VAE Mesh Element Labeling, MAE Mesh In-filling, Mesh Reconstruction Autoencoder, Validation Using Autoencoders, Mesh Segmentation, Coordinate System Prediction, Mesh Cleanup, Restoration Design Generation, Appliance Component Generation and/or Placement, and Archform Prediction. Such feature vectors may be presented to the input of a predictive model. In some implementations, such feature vectors may be presented to one or more internal layers of a neural network which is part of one or more of those predictive models.

The neural networks of this disclosure may benefit for the operation of parameter tuning, whereby the inputs and parameters of a neural network are optimized to produce results which are optimal. One parameter which may be tuned is neural network learning rate (e.g., which may have values such as 0.1, 0.01, 0.001, etc.). Data augmentation schemes may also be tuned or optimized, such as schemes where “shiver” is added to the tooth meshes before being input to the neural network (i.e., small random rotations, translations and/or scaling may be applied to vary the dataset and make the neural network robust to variations in data).

A subset of the neural network model parameters available for tuning are as follows:
learning rate (LR) decay rate (how much the LR decays during a training run)
Learning rate. The floating-point value (e.g., 0.001) that is used by the optimizer.
Learning rate schedule (e.g., cosine annealing, step, exponential)
voxel size (for cases with sparse mesh processing operations)
dropout % (e.g., dropout which may be performed in a linear encoder)
learning rate decay step size (e.g., decay every 10 or 20 or 30 epochs)
model scaling. Increase or decrease the count of layers and/or the count of parameters per layer.

Parameter tuning may be advantageously applied to the training of a neural network for the prediction of final setups or intermediate stage (aka intermediate setups or simply ‘staging’). Parameter tuning may also be advantageously applied to the training of a neural network for mesh element labeling or a neural network for mesh in-filling. Parameter tuning may also be advantageously applied to the training of a neural network for tooth reconstruction. Parameter tuning may also be advantageously applied to a neural network for the classification of one or more setups (i.e., classification of one or more arrangements of teeth). The advantage of parameter tuning is to improve the output of a predictive model. Parameter tuning may, in some instances, have the advantage of “squeezing” the last remaining few percentage points of validation accuracy out of a predictive or classification model.

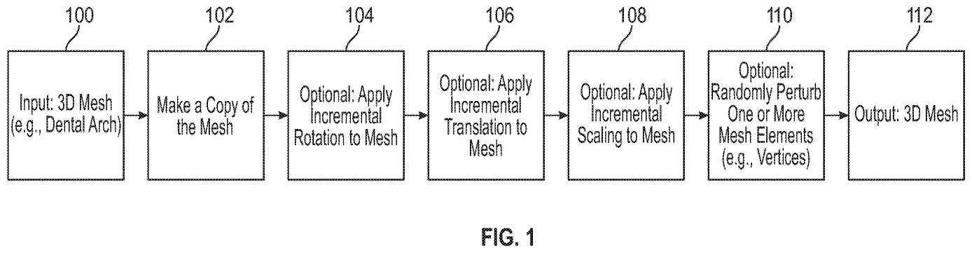

Various neural network models of this disclosure may draw benefits from data augmentation. Examples include models of this which are trained on 3D meshes, such as GDL Setups, RL Setups, VAE Setups, Capsule Setups, MLP Setups, Diffusion Setups, PT Setups, Similarity Setups, FDG Setups, Setups Classification, Setups Comparison, VAE Mesh Element Labeling, MAE Mesh In-filling, Mesh Reconstruction VAE, and Validation Using Autoencoders. Data augmentation, such as by way of the method shown in FIG. 1, may increase the size of the training dataset of dental arches. Data augmentation can provide additional training examples by adding random rotations, translations, and/or rescaling to copies of existing dental arches. In some implementations of the techniques of this disclosure, data augmentation may be carried out by perturbing or jittering the vertices of the mesh, in a manner similar to that described in (“Equidistant and Uniform Data Augmentation for 3D Objects”, IEEE Access, Digital Object Identifier 10.1109/ACCESS.2021.3138162). The position of a vertex may be perturbed through the addition of Gaussian noise, for example with zero mean, and 0.1 standard deviation. Other mean and standard deviation values are possible in accordance with the techniques of this disclosure.

FIG. 1 shows a data augmentation method that systems of this disclosure may apply to 3D oral care representations. A non-limiting example of a 3D oral care representation is a tooth mesh or a set of tooth meshes. Tooth data 100 (e.g., 3D meshes) are received at the input. The systems of this disclosure may generate copies of the tooth data 100 (102). In the example of FIG. 1, the systems of this disclosure may apply one or more stochastic rotations to the tooth data 100 (104). In the example of FIG. 1, the systems of this disclosure may apply stochastic translations to the tooth data 100 (106). The systems of this disclosure may apply stochastic scaling operations to the tooth data 100 (108). The systems of this disclosure may apply stochastic perturbations to one or more mesh elements of the tooth data 100 (110). The systems of this disclosure may output augmented tooth data 112 that are formed by way of the method of FIG. 1.

Because generator networks of this disclosure can be implemented as one or more neural networks, the generator may contain an activation function. When executed, an activation function outputs a determination of whether or not a neuron in a neural network will fire (e.g., send output to the next layer). Some activation functions may include: binary step functions, or linear activation functions. Other activation functions impart non-linear behavior to the network, including: sigmoid/logistic activation functions, Tanh (hyperbolic tangent) functions, rectified linear units (ReLU), leaky ReLU functions, parametric ReLU functions, exponential linear units (ELU), softmax function, swish function, Gaussian error linear unit (GELU), or scaled exponential linear unit (SELU). A linear activation function may be well suited to some regression applications (among other applications), in an output layer. A sigmoid/logistic activation function may be well suited to some binary classification applications (among other applications), in an output layer. A softmax activation function may be well suited to some multiclass classification applications (among other applications), in an output layer. A sigmoid activation function may be well suited to some multilabel classification applications (among other applications), in an output layer. A ReLU activation function may be well suited in some convolutional neural network (CNN) applications (among other applications), in a hidden layer. A Tanh and/or sigmoid activation function may be well suited in some recurrent neural network (RNN) applications (among other applications), for example, in a hidden layer. There are multiple optimization algorithms which can be used in the training of the neural networks of this disclosure (such as in updating the neural network weights), including gradient descent (which determines a training gradient using first-order derivatives and is commonly used in the training of neural networks), Newton's method (which may make use of second derivatives in loss calculation to find better training directions than gradient descent, but may require calculations involving Hessian matrices), and conjugate gradient methods (which may yield faster convergence than gradient descent, but do not require the Hessian matrix calculations which may be required by Newton's method). In some implementations, additional methods may be employed to update weights, in addition to or in place of the techniques described above. These additional methods include the Levenberg-Marquardt method and/or simulated annealing. The backpropagation algorithm is used to transfer the results of loss calculation back into the network so that network weights can be adjusted, and learning can progress.

Neural networks contribute to the functioning of many of the applications of the present disclosure, including but not limited to: GDL Setups, RL Setups, VAE Setups, Capsule Setups, MLP Setups, Diffusion Setups, PT Setups, Similarity Setups, Tooth Classification, Setups Classification, Setups Comparison, VAE Mesh Element Labeling, MAE Mesh In-filling, Mesh Reconstruction Autoencoder, Validation Using Autoencoders, imputation of oral care parameters, 3D mesh segmentation (3D representation segmentation), Coordinate System Prediction, Mesh Cleanup, Restoration Design Generation, Appliance Component Generation and/or Placement, or Archform Prediction. The neural networks of the present disclosure may embody part or all of a variety of different neural network models. Examples include the U-Net architecture, multi-later perceptron (MLP), transformer, pyramid architecture, recurrent neural network (RNN), autoencoder, variational autoencoder, regularized autoencoder, conditional autoencoder, capsule network, capsule autoencoder, stacked capsule autoencoder, denoising autoencoder, sparse autoencoder, conditional autoencoder, long/short term memory (LSTM), gated recurrent unit (GRU), deep belief network (DBN), deep convolutional network (DCN), deep convolutional inverse graphics network (DCIGN), liquid state machine (LSM), extreme learning machine (ELM), echo state network (ESN), deep residual network (DRN), Kohonen network (KN), neural Turing machine (NTM), or generative adversarial network (GAN). In some implementations, an encoder structure or a decoder structure may be used. Each of these models provides one or more of its own particular advantages. For example, a particular neural networks architecture may be especially well suited to a particular ML technique. For example, autoencoders are particularly suited to the classification of 3D oral care representations, due to the ability to encode the 3D oral care representation into a form which is more easily classifiable.

In some implementations, the neural networks of this disclosure can be adapted to operate on 3D point cloud data (alternatively on 3D meshes or 3D voxelized representation). Numerous neural network implementations may be applied to the processing of 3D representations and may be applied to training predictive and/or generative models for oral care applications, including: PointNet, PointNet++, SO-Net, spherical convolutions, Monte Carlo convolutions and dynamic graph networks, PointCNN, ResNet, MeshNet, DGCNN, VoxNet, 3D-ShapeNets, Kd-Net, Point GCN, Grid-GCN, KCNet, PD-Flow, PU-Flow, MeshCNN and DSG-Net. Oral care applications include, but are not limited to: setups prediction (e.g., using VAE, RL, MLP, GDL, Capsule, Diffusion, etc. which have been trained for setups prediction), 3D representation segmentation, 3D representation coordinate system prediction, element labeling for 3D representation clean-up (VAE for Mesh Element labeling), in-filling of missing elements in 3D representation (MAE for Mesh In-Filling), dental restoration design generation, setups classification, appliance component generation and/or placement, archform prediction, imputation of oral care parameters, setups validation, or other validation applications and tooth 3D representation classification.

Some implementations of the techniques of this disclosure incorporate the use of an autoencoder. Autoencoders that can be used in accordance with aspects of this disclosure include but are not limited to: AtlasNet, FoldingNet and 3D-PointCapsNet. Some autoencoders may be implemented based on PointNet.

Representation learning may be applied to setups prediction techniques of this disclosure by training a neural network to learn a representation of the teeth, and then using another neural network to generate transforms for the teeth. Some implementations may use a VAE or a Capsule Autoencoder to generate a representation of the reconstruction characteristics of the one or more meshes related to the oral care domain (including, in some instances, information about the structures of the tooth meshes). Then that representation (either a latent vector or a latent capsule) may be used as input to a module which generates the one or more transforms for the one or more teeth. These transforms may in some implementations place the teeth into final setups poses. These transforms may in some implementations place the teeth into intermediate staging poses. In some implementations, a transform may be described by a 9×1 transformation vector (e.g., that specifies a translation vector and a quaternion). In other implementations, a transform may be described by a transformation matrix (e.g., a 4×4 affine transformation matrix).

In some implementations, systems of this disclosure may implement a principal components analysis (PCA) on an oral care mesh, and use the resulting principal components as at least a portion of the representation of the oral care mesh in subsequent machine learning and/or other predictive or generative processing.

An autoencoder may be trained to generate a latent form of a 3D oral care representation. An autoencoder may contain a 3D encoder (which encodes a 3D oral care representation into a latent form), and/or a 3D decoder (which reconstructs that latent from into a facsimile of the inputted 3D oral care representation). Although this disclosure refers to 3D encoders and 3D decoders, the term 3D should be interpreted in a non-limiting fashion to encompass multi-dimensional modes of operation. For example, systems of this disclosure may train multi-dimensional encoders and/or multi-dimensional decoders.

Systems of this disclosure may implement end-to-end training. Some of the end-to-end training-based techniques of this disclosure may involve two or more neural networks, where the two or more neural networks are trained together (i.e., the weights are updated concurrently during the processing of each batch of input oral care data). End-to-end training may, in some implementations, be applied to setups prediction by concurrently training a neural network which learns a representation of the teeth, along with a neural network which generates the tooth transforms.

According to some of the transfer learning-based implementations of this disclosure, a neural network (e.g., a U-Net) may be trained on a first task (e.g., such as coordinate system prediction). The neural network trained on the first task may be executed to provide one or more of the starting neural network weights for the training of another neural network that is trained to perform a second task (e.g., setups prediction). The first network may learn the low-level neural network features of oral care meshes and be shown to work well at the first task. The second network may exhibit faster training and/or improved performance by using the first network as a starting point in training. Certain layers may be trained to encode neural network features for the oral care meshes that were in the training dataset. These layers may thereafter be fixed (or be subjected to minor changes over the course of training) and be combined with other neural network components, such as additional layers, which are trained for one or more oral care tasks (such as setups prediction). In this manner, a portion of a neural network for one or more of the techniques of the present disclosure (e.g., setups prediction) may receive initial training on another task, which may yield important learning in the trained network layers. This encoded learning may then be built upon with further task-specific training of another network.

In accordance with this disclosure, transfer learning may be used for setups prediction, as well as for other oral care applications, such as mesh classification (e.g., tooth or setups classification), mesh element labeling, mesh element in-filling, procedure parameter imputation, mesh segmentation, coordinate system prediction, restoration design generation, mesh validation (for any of the applications disclosed herein). In some implementations, a neural network trained to output predictions based on oral care meshes may first be partially trained on one of the following publicly available datasets, before being further trained on oral care data: Google PartNet dataset, ShapeNet dataset, ShapeNetCore dataset, Princeton Shape Benchmark dataset, ModelNet dataset, ObjectNet3D dataset, Thingi10K dataset (which is especially relevant to 3D printed parts validation), ABC: A Big CAD Model Dataset For Geometric Deep Learning, ScanObjectNN, VOCASET, 3D-FUTURE, MCB: Mechanical Components Benchmark, PoseNet dataset, PointCNN dataset, MeshNet dataset, MeshCNN dataset, PointNet++ dataset, PointNet dataset, or PointCNN dataset.

In some implementations, a neural network which was previously trained on a first dataset (either oral care data or other data) may subsequently receive further training on oral care data and be applied to oral care applications (such as setups prediction). Transfer learning maybe employed to further train any of the following networks: GCN (Graph Convolutional Networks), PointNet, ResNet or any of the other neural networks from the published literature which are listed above.

In some implementations, a first neural network may be trained to predict coordinate systems for teeth (such as by using the techniques described in WO2022123402A1 or US Provisional Application No. U.S. 63/366,492). A second neural network may be trained for setups prediction, according to any of the setups prediction techniques of the present disclosure (or a combination of any two or more of the techniques described herein). Transfer learning may transfer at least a portion of the knowledge or capability of the first neural network to the second neural network. As such, transfer learning may provide the second neural network an accelerated training phase to reach convergence. In some implementations, the training of the second network may, after being augmented with the transferred learning, then be completed using one or more of the techniques of this disclosure.

Systems of this disclosure may train ML models with representation learning. The advantages of representation learning include that the generative network (e.g., neural network that predicts a transform for use in setups prediction) can be configured to receive input with a known size and/or standard format, as opposed to receiving input with a variable size or structure. Representation learning may produce improved performance over other techniques, because noise in the input data may be reduced (e.g., because the representation generation model extracts hierarchical neural network features and/or reconstruction characteristics of an inputted representation (e.g., a mesh or point cloud) through loss calculations or network architectures chosen for that purpose).

Reconstruction characteristics may comprise values in of a latent representation (e.g., a latent vector) that describe aspects of the shape and/or structure of the 3D representation that was provided to the representation generation module that generated the latent representation. The weights of the encoder module of a reconstruction autoencoder, for example, may be trained to encode a 3D representation (e.g., a 3D mesh, or others described herein) into a latent vector representation (e.g., a latent vector). Stated another way, the capability to encode a large set (e.g., hundreds, thousands or millions) of mesh elements into a latent vector (e.g., of hundreds or a thousand real values—e.g., 512, 1024, etc.) may be learned by the weights of the encoder. Each dimension of that latent vector may contain a real number which describes some aspect of the shape and/or structure of the original 3D representation. The weights of the decoder module of the reconstruction autoencoder may be trained to reconstruct the latent vector into a close facsimile of the original 3D representation. Stated another way, the capability to interpret the dimensions of the latent vector, and to decode the values within those dimensions, may be learned by the decoder. In summary, the encoder and decoder neural network modules are trained to perform the mapping of a 3D representation into a latent vector, which may then be mapped back (or otherwise reconstructed) into a 3D representation that is substantially similar to an original 3D representation for which the latent vector was generated.

Returning to loss calculation, examples of loss calculation may include KL-divergence loss, reconstruction loss or other losses disclosed herein. Representation learning may reduce the size of the dataset required for training a model, because the representation model learns the representation, enabling the generative network to focus on learning the generative task. The result may be improved model generalization because meaningful neural network features of the input data (e.g., local and/or global features) are made available to the generative network. Stated another way, a first network may learn the representation, and a second network may make the predictive decision. By training two networks to perform their own separate tasks, each of the networks may generate more accurate results for their respective tasks than with a single network which is trained to both learn a representation and make a decision. In some instances, transfer learning may first train a representation generation model. That representation generation model (in whole or in part) may then be used to pre-train a subsequent model, such as a generative model (e.g., that generates transform predictions). A representation generation model may benefit from taking mesh element features as input, to improve the capability of a second ML module to encode the structure and/or shape of the inputted 3D oral care representations in the training dataset.

One or more of the neural networks models of this disclosure may have attention gates integrated within. Attention gate integration provides the enhancement of enabling the associated neural network architecture to focus resources on one or more input values. In some implementations, an attention gate may be integrated with a U-Net architecture, with the advantage of enabling the U-Net to focus on certain inputs, such as input flags which correspond to teeth which are meant to be fixed (e.g., prevented from moving) during orthodontic treatment (or which require other special handling). An attention gate may also be integrated with an encoder or with an autoencoder (such as VAE or capsule autoencoder) to improve predictive accuracy, in accordance with aspects of this disclosure. For example, attention gates can be used to configure a machine learning model to give higher weight to aspects of the data which are more likely to be relevant to correctly generated outputs. As such because a machine learning model configured with these attention gates (or mechanisms) utilizes aspects of the data that are more likely to be relevant to correctly generated outputs, the ultimate predictive accuracy of those machine learning models is improved.

The quality and makeup of the training dataset for a neural network can impact the performance of the neural network in its execution phase. Dataset filtering and outlier removal can be advantageously applied to the training of the neural networks for the various techniques of the present disclosure (e.g., for the prediction of final setups or intermediate staging, for mesh element labeling or a neural network for mesh in-filling, for tooth reconstruction, for 3D mesh classification, etc.), because dataset filtering and outlier removal may remove noise from the dataset. And while the mechanism for realizing an improvement is different than using attention gates, that ultimate outcome is that this approach allows for the machine learning model to focus on relevant aspects of the dataset, and may lead to improvements in accuracy similar to improvements in accuracy realized vis-à-vis attention gates.

In the case of a neural network configured to predict a final setup, a patient case may contain at least one of a set of segmented tooth meshes for that patient, a mal transform for each tooth, and/or a ground truth setup transform for each tooth. In the case of a neural network to predict a set of intermediate stage setups, a patient case may contain at least one of a set of segmented tooth meshes for that patient, a mal transform for each tooth, and/or a set of ground truth intermediate stage transforms for each tooth. In some implementations, a training dataset may exclude patient cases which contact passive stages (i.e., stages where the teeth of an arch do not move). In some implementations, the dataset may exclude cases where passive stages exist at the end of treatment. In some implementations, a dataset may exclude cases where overcrowding is present at the end of treatment (i.e., where the oral care provider, such as an orthodontist or dentist) has chosen a final setup where the tooth meshes overlap to some degree. In some implementations, the dataset may exclude cases of a certain level (or levels) of difficulty (e.g., easy, medium and hard).

In some implementations, the dataset may include cases with zero pinned teeth (or may include cases where at least one tooth is pinned). A pinned tooth may be designated by a technician as they design the treatment to stop the various tools from moving that particular tooth. In some implementations, a dataset may exclude cases without any fixed teeth (conversely, where at least one tooth is fixed). A fixed tooth may be defined as a tooth that shall not move in the course of treatment. In some implementations, a dataset may exclude cases without any pontic teeth (conversely, cases in which at least one tooth is pontic). A pontic tooth may be described as a “ghost” tooth that is represented in the digital model of the arch but is either not actually present in the patient's dentition or where there may be a small or partial tooth that may benefit from future work (such as the addition of composite material through a dental restoration appliance). The advantage of including a pontic tooth in a patient case is to leave space in the arch as a part of a plan for the movements of other teeth, in the course of orthodontic treatment. In some instances, a pontic tooth may save space in the patient's dentition for future dental or orthodontic work, such as the installation of an implant or crown, or the application of a dental restoration appliance, such as to add composite material to an existing tooth that is too small or has an undesired shape.

In some implementations, the dataset may exclude cases where the patient does not meet an age requirement (e.g., younger than 12). In some implementations, the dataset may exclude cases with interproximal reduction (IPR) beyond a certain threshold amount (e.g., more than 1.0 mm). The dataset to train a neural network to predict setups for clear tray aligners (CTA) may exclude patient cases which are not related to CTA treatment. The dataset to train a neural network to predict setups for an indirect bonding tray product may exclude cases which are not related to indirect bonding tray treatment. In some implementations, the dataset may exclude cases where only certain teeth are treated. In such implementations, a dataset may comprise of only cases where at least one of the following are treated: anterior teeth, posterior teeth, bicuspids, molars, incisors, and/or cuspids.

Some autoencoder-based implementations of this disclosure use capsule autoencoders to automate processing steps in the creation of oral care appliances (e.g., for orthodontic treatment or dental restoration). The advantage of using capsule autoencoders which have been trained on oral care data is to leverage latent space techniques which reduce the dimensionality of oral care mesh data and thereby refine those data, making the signal in the data stronger and more readily usable by downstream processing modules, whether those downstream modules may be other autoencoder(s), decoder(s), other neural networks, or other types of ML models (such as the supervised and unsupervised models described elsewhere in this disclosure). Capsule autoencoders were originally applied in the 2D domain to perform object recognition in 2D images, where capsules were trained to create a model of the object that was to be recognized. Such an approach enabled an object to be recognized in the 2D image, even if the object was imaged from a new view that was not present in the training dataset. Later research extended capsule autoencoders to the domain of 3D point clouds, such as in “3D Point Capsule Networks” in the proceedings of CVPR 2019, which is incorporated herein by reference in its entirety.

The present disclosure extends the outcomes of this research to apply capsule autoencoders to the domain of digital oral care, dealing with 3D point clouds, 3D meshes and 3D voxelized representation. The term “mesh” in the following should be considered to be interchangeable with 3D point cloud and 3D voxelized representations, in particular implementations. A 3D autoencoder may encode one or more 3D geometries (point clouds or meshes) into latent capsules which encode the reconstruction characteristics of the input 3D representation. These latent capsules exist in two or more dimensions and describe features of the input mesh (or point cloud) and the likelihoods of those features. A set of latent capsules stands in contrast to the latent vector which may be produced by a variational autoencoder (VaE), which may be encoded as a 1D vector. Among the contributions of the present technique is to advantageously apply capsule autoencoders to the digital oral care space, with the data precision-oriented technical advantage of improving predictive results.

Particular examples of applications include segmentation of 3D oral care geometries, setups prediction (both final setups and intermediate stages), mesh cleanup of 3D oral care geometries (e.g., both for the labeling of mesh elements and the filling-in of missing mesh elements), tooth classification (e.g., according to standard dental notation schemes), setups classification (e.g., as mal, staging and final setup) and automated dental restoration design generation.

The one or more latent capsules describing an input 3D representation (e.g., oral care geometries such as point clouds and/or meshes representing unsegmented dental arches, segmented teeth—such as arranged in a maloccluded setup, teeth with hardware attached, teeth without hardware attached, etc.) can be provided to a capsule decoder, to reconstruct a facsimile of the input 3D representation. This facsimile can be compared to the input 3D representation through the calculation of a reconstruction error, thereby demonstrating the information-rich nature of the latent capsule (i.e., that the latent capsule describes sufficient reconstruction characteristics of the input mesh, such that the mesh can be reconstructed from that latent capsule). A low reconstruction error (e.g., below a predetermined loss threshold) indicates that the reconstruction was a success. Some of the applications disclosed herein use this information-rich latent capsule for further processing (e.g., such as setups prediction, mesh segmentation, coordinate system prediction, mesh element labelling for mesh cleanup, in-filling of missing mesh elements or of holes in meshes, classification of setups, classification of oral care meshes, validation of setups and other validation appliances too). Some of the applications disclosed herein make one or more changes to the latent capsule, such as to effectuate changes in the reconstructed mesh, which may then outputted for further use (e.g., to create a dental restoration appliance).

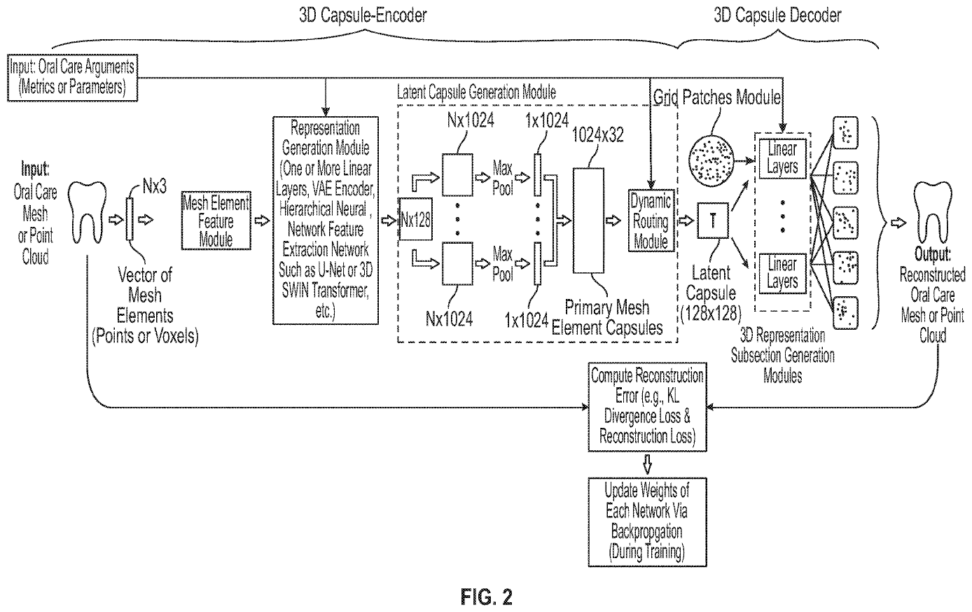

FIG. 2 shows a capsule autoencoder pipeline for mesh reconstruction, which are primarily applied to oral care meshes in the non-limiting examples described herein, but which may also be applied to other healthcare meshes, or to personal safety meshes, such as meshes pertaining to the design, shape, function, and/or use of personal protective equipment, such as disposable respirators. That is, FIG. 2 illustrates an example of a training method for a capsule autoencoder for reconstructing oral care meshes (or point clouds). The deployment method omits the two modules on the bottom. The training method encompasses the whole diagram. The latent capsule T may be a reduced dimensionality form of the inputted oral care mesh and may be used as an input to other processing.

Some existing techniques rely on inputting 3D point cloud data into a capsule autoencoder. Techniques of the present disclosure expand the input geometries to include 3D mesh data and 3D voxelized representations. In some instances, an input point cloud or mesh (such as containing oral care data) may be rearranged into one or more vectors of mesh elements. Such a vector may be N×3 (in the case representing the XYZ coordinates of points or vertices). Such a vector may be N×3 (in the case of representing mesh faces, each of which may be defined by 3 indices, each of which indexes into a list of vertices/points). Such a vector may be N×2 (in the case of representing mesh edges, each of which may be defined by 2 indices, each of which can be indexed into a list of vertices/points). Such a vector may be N×3 (in the case of representing voxels, each of which has an XYZ location, such as a centroid, where the Length×Width×Height of each voxel is known).

In some examples in accordance with aspects of this disclosure, a neural network, such as an MLP, may be used to extract features from the N×3 mesh element input list, yielding an N×128 list of feature vectors, one feature vector per mesh element. In some instances, a vector of one or more computed mesh element features (as defined elsewhere in this disclosure) may be computed for one or more of the N inputted mesh elements. In some implementations, these mesh element features may be used in place of the MLP-generated features. In some implementations, each mesh element may be given a feature which is a hybrid of MLP-generated features and the computed mesh element features, in which case the layer dimension may be augmented to be N×(128+aug_len), where aug_len is the length of the augmentation vector, consisting of the computed mesh element features. For ease of discussion, and without the loss of generality, this layer will simply be referred to as N×128 hereafter.

The length ‘aug_len’ may vary from implementation to implementation, depending on which mesh elements are analyzed and which mesh element features are chosen for use. In some instances, information from more than one type of mesh element may be introduced with the N×128 vector (e.g., point/vertex information may be combined with face information, point/vertex information may be combined with edge information, or point/vertex information may be combined with voxel information). The analysis of different kinds of oral care meshes may call for one mesh element type or another, or for a particular set of mesh features, according to various applications.

The N×128 layer may be passed to a set of subsequent convolutions layers, each of which has been trained to have its own parameter values. The purpose of each of these independent convolution layers may encode the individual mesh element capsules. The output of each of the convolution layers may be maxpooled to a size of 1024 elements. The count of these convolution layers may be a power of two (e.g., 8, 16, 32, 64). In some implementations, there may be 32 such convolution layers, each of which outputs a 1024 element vector from the maxpooling operation. These 32 maxpooling output vectors may be concatenated, forming a layer that may be 1024×32, called the Primary Mesh Element Capsules (PMEC). A dynamic routing module encodes these PMECs into one or more latent capsules, each of which may have square dimensions (e.g., 16×16, 32×32, 64×64, or 128×128). Non-square dimensions are also possible.

In some implementations, a dynamic routing module may enable the output of a latent capsule to be routed to a suitable neural network layer in a subsequent processing module of the capsule autoencoder. The dynamic routing module uses unsupervised techniques (e.g., clustering and/or other unsupervised techniques) to arrange the output of the set of max-pooled feature maps into one or more stacked latent capsules. These latent capsules summarize feature information from the input 3D representation (e.g., one or more tooth meshes or point clouds) and also the likelihood information associated with each capsule. These stacked capsules contain sufficient information about the input 3D representation to reconstruct that 3D representation via the Capsule-Decoder module.

A grid of mesh elements (i.e., such as points/vertices, edges, face or voxels) may be generated by Grid Patches module. Points will be used for the mesh element, in this example. In some implementations, this grid may comprise of randomly arranged points. In other implementations, this grid may reflect a regular and/or rectilinear arrangement of points. The points in each of these grid patches are the “raw material” from which the reconstructed 3D representation may be formed.

The latent capsule (e.g., with dimension 128×128) may be replicated P times, and each of those P latent capsules may be appended with each of the grid patch of randomly generated mesh elements (e.g., points/vertices) in turn, before being input to one or more MLPs. In some examples, such an MLP may comprise of fully connected layers with the following dimensions: {64-64-32-16-3}. The goal of such an operation is to tailor the mesh elements to a specific local area of the 3D representation which may be to be reconstructed. The decoder iterates, generating additional random grid patches and outputting more random portions of the reconstructed 3D representation (i.e., as point cloud patches). These point cloud patches are accumulated until a reconstruction loss drops below a target threshold. The reconstruction loss may be computed using one or more of reconstruction loss (as defined herein) and KL-Divergence loss.

An autoencoder, such as a variational autoencoder (VAE), may be trained to encode 3D mesh data in a latent space vector A, which may exist in an information-rich low-dimensional latent space. This latent space vector A may be particularly suitable for later processing by digital oral care applications (e.g., such as mesh cleanup, mesh segmentation, mesh validation, mesh classification, setups classification, setups prediction and restoration design generation, among others), because A enables high-dimensionality tooth mesh data to be efficiently manipulated. Such a VAE may be trained to reconstruct the latent space vector A back into a facsimile of the input mesh (or transform or other data structure describing a 3D oral care representation). In some implementations, the latent space vector A may be strategically modified, so as to result in changes to the reconstructed mesh (or other data structure). In some instances, the reconstructed mesh may be a tooth mesh with an altered and/or improved shape, such as would be suitable for use in the design of a dental restoration appliance, such as a 3M FILTEK Matrix or a veneer. The term mesh should be considered in a non-limiting sense to be inclusive of 3D mesh, 3D point cloud and 3D voxelized representation.

The tooth reconstruction VAE may advantageously make use of loss functions, nonlinearities (aka neural network activation functions) and/or solvers which are not mentioned by existing techniques. Examples of loss functions may include: mean absolute error (MAE), mean squared error (MSE), L1-loss, L2-loss, KL-divergence, entropy, and reconstruction loss. Such loss functions enable each generated prediction to be compared against the corresponding ground truth value in a quantified manner, leading to one or more loss values which can be used to train, at least in part, one or more of the neural networks. Examples of solvers may include: dopri5, bdf, rk4, midpoint, adams, explicit_adams, and fixed_adams. The solvers may enable the neural networks to solve systems of equations and corresponding unknown variables. Examples of nonlinearities may include: tanh, relu, softplus, elu, swish, square, and identity. The activation functions may be used to introduce nonlinear behavior to the neural networks in a manner that enables the neural networks to better represent the training data. Losses may be computed through the process of training the neural networks via backpropagation. Neural network layers such as the following may be used: ignore, concat, concat v2, squash, concatsquash, scale and concatscale.

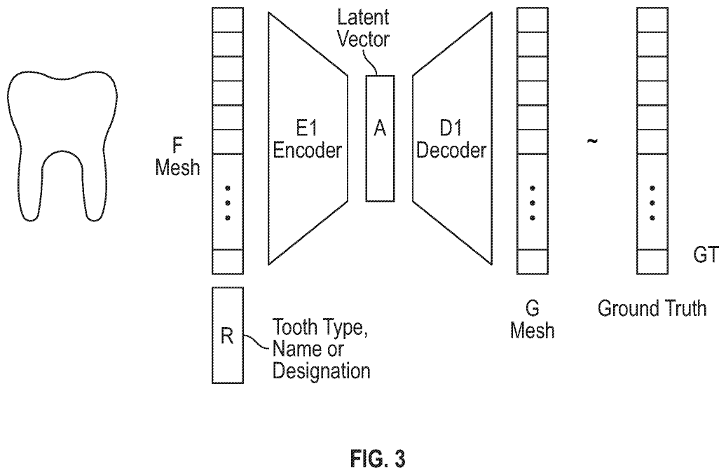

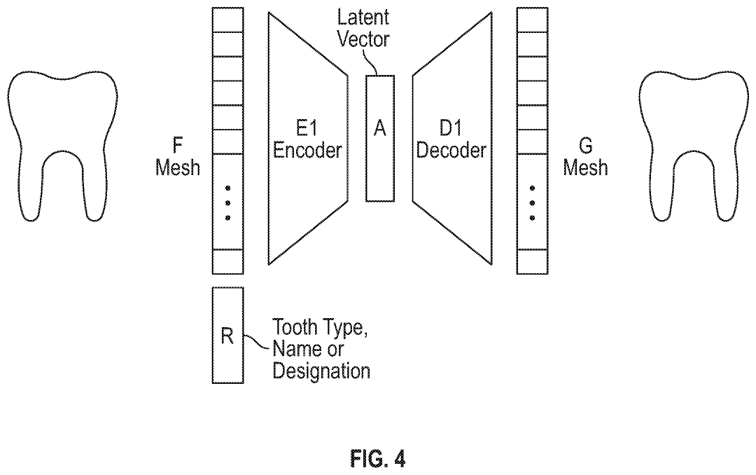

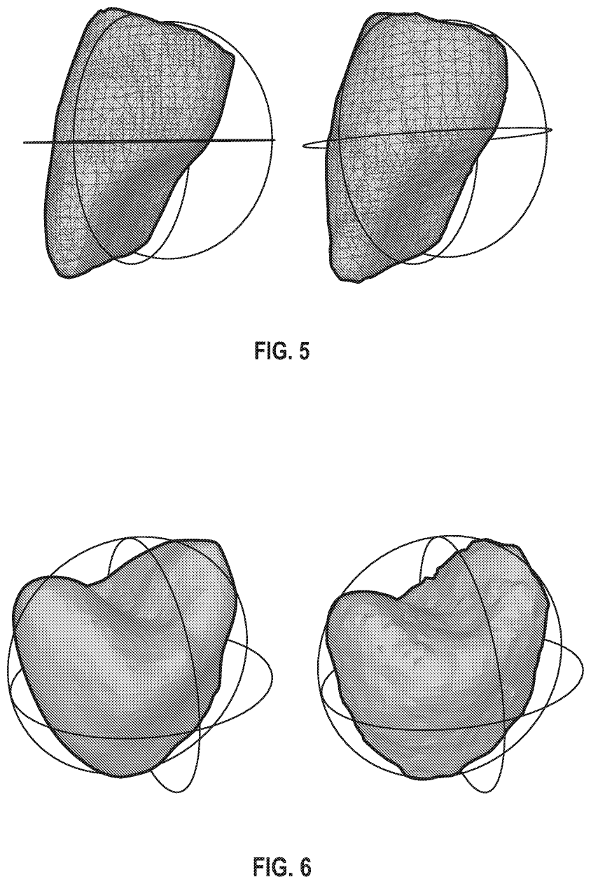

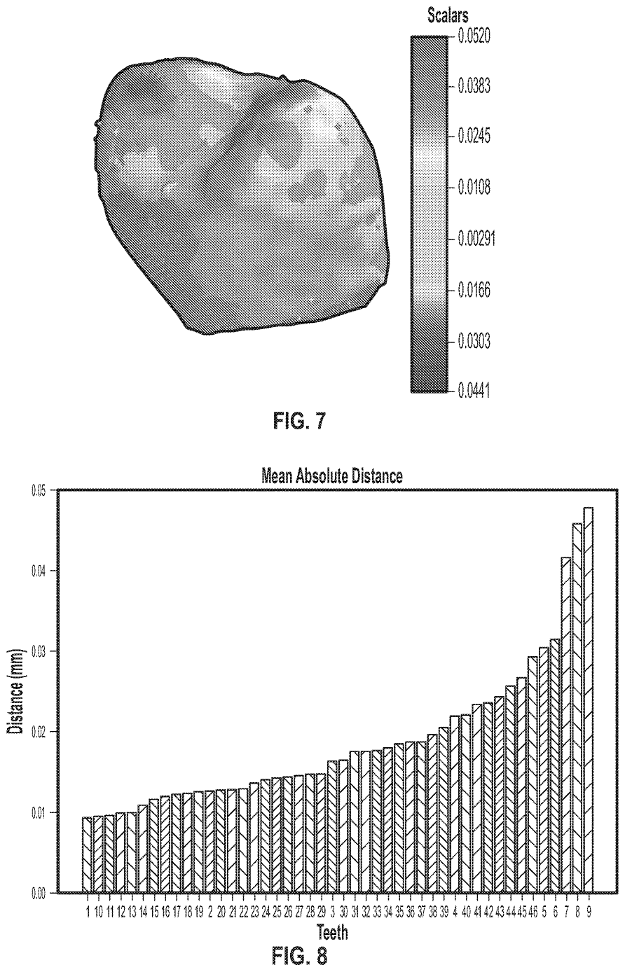

In some implementations, the tooth reconstruction VAE model may be trained on patient cases of teeth in mal occlusion, or alternatively in local coordinates. FIG. 3 shows a method of training such a VAE. FIG. 4 shows the trained mesh reconstruction VAE in deployment. FIGS. 5 and 6 show reconstructed tooth meshes. FIG. 7 shows a depiction of the reconstruction error from the reconstructed tooth shown in FIG. 6, called a reconstruction error plot.

According to the mesh reconstruction VAE training shown in FIG. 3, a 3D oral care representation F may be provided to the encoder E1 (along with optional tooth type information R), which may generate latent vector A. Latent vector A may be reconstructed into reconstructed 3D oral care representation G. Loss may be computed between the reconstructed 3D oral care representation G and ground truth 3D oral care representation GT (e.g., using the VAE loss calculation methods or other loss calculation methods described herein). Backpropagation may be used to train E1 and D1 with such loss.

In the case of FIG. 4, the mesh reconstruction VAE is shown reconstructing a tooth mesh in deployment. R is an optional input, particularly in the case of tooth mesh classification, when such information R is not yet available (due to the tooth mesh classification neural network being trained to generate tooth type information R as an output, according to particular implementations). R may, in some implementations, be used to improve other techniques such as mesh element labeling techniques, mesh reconstruction techniques, and/or oral care mesh classification techniques (e.g., such as tooth classification or setups classification), among others.

FIG. 5 shows an example of an input tooth mesh on the left and the corresponding outputted reconstructed tooth mesh on the right.

FIG. 6 shows another example of an input tooth mesh on the left and the corresponding outputted reconstructed tooth mesh on the right.

FIG. 7 depicts the reconstruction error in the results described above with respect to FIGS. 5 and 6, in a form referred to as a “reconstruction error plot” with units in millimeters (mm). Notice that the reconstruction error is less than 50 microns at the cusp tips, and much less than 50 microns over most of the tooth surface. Compared to a typical tooth with a size of 1.0 cm, an error rate of 50 microns (or less) means that the tooth surface was reconstructed with an error rate of less than 0.5%.

FIG. 8 is a bar chart in which each bar represents an individual tooth and represents the mean absolute distance of all vertices involved in the reconstruction of that tooth in a data that was used to evaluate the performance of a mesh reconstruction model.

The tooth mesh reconstruction autoencoder, of which a variational autoencoder (VAE) is an example, may be trained to encode a tooth as a reduced-dimensionality form, called a latent space vector. The reconstruction VAE may be trained on example tooth meshes. The tooth mesh may be received by the VAE, deconstructed into a latent space vector using a 3D encoder and then reconstructed into a facsimile of the input mesh using a 3D decoder. Existing techniques for setups prediction lack such a deconstruction/reconstruction method. One advantage of this method is that the encoder E1 may become trained to encode a tooth mesh (or mesh of a dental appliance, gums, or other body part or anatomy) into a reduced-dimension form that can be used in the training and deployment of any of suite of powerful setups prediction methods (e.g., GDL Setups, RL Setups, VAE Setups, Capsule Setups, MLP Setups and Diffusion Setups, among others). This reduced-dimensionality form of the tooth may enable the setups prediction neural network to more efficiently encode the reconstruction characteristics of the tooth, and better learn to place the tooth into a pose suitable for either final setups or intermediate stages, thereby providing technical improvements in terms of both data precision and resource footprint.

Furthermore, the reduced dimensionality representations of the teeth (or other 3D oral care representations) may be provided to the second ML module, which may classify the teeth (or other 3D oral care representations). Using a low dimensionality representation can provide a number of advantages. For example, training machine learning models on data samples (e.g., from the training dataset) which have variable sizes (e.g., one sample has a different size from the other) can be highly error-prone, with the resulting machine learning models generating less accurate predictive outputs (e.g., less accurate classifications), for at least the reason that conventional machine learning models are configured with a specific structure that is configured based on an expected format of the input data. And when the input data do not conform to the expected format the machine learning model may unintentionally or inadvertently introduce errors into the prediction. Furthermore, training machine learning models on data samples which are larger than a particular size may result in a less accurate model, because the model is incapable of encoding the distribution of the large data samples (e.g., because the machine learning model was not properly configured to accommodate inputs of that size). Both of these problems are present in a typical dataset of cohort patient case data. The standard size and low-dimensionality nature of the latent vectors described herein solves both of these problems, which results in more accurate machine learning models (e.g., a second ML module which is trained to perform classification).

The reconstructed mesh may be compared to the input mesh, for example using a reconstruction error (as described elsewhere in this disclosure), which quantifies the differences between the meshes. This reconstruction error may be computed using Euclidean distances between corresponding mesh elements between the two meshes. There are other methods of computing this error too which may be derived from material described elsewhere in this disclosure. FIGS. 7 and 8 show example reconstruction errors, in accordance with the techniques described herein.

In some implementations, the mesh or meshes which are provided to the mesh reconstruction VAE my first be converted to vertex lists (or point clouds) before being provided to the encoder E1. This manner of handling the input to E1 may be conducive to either a single mesh input (such as in a tooth mesh classification task) or a set of multiple teeth (such as in the setups classification task). The input meshes do not need to be connected.

Aspects of the model architecture are described below. The encoder E1 may be trained to encode a tooth mesh into a latent space vector A (or “tooth representation vector”). In the course of the restoration design task, encoder E1 may arrange an input tooth mesh into a mesh element vector F, and encode it into a latent space vector A. This latent space vector A may be a reduced dimensionality representation of F that describes the important geometrical attributes of F. Latent space vector A may be provided to the decoder D1 to be restored to full resolution or near full resolution, along with the desired geometrical changes. The restored full resolution mesh or near-full resolution mesh may be described by G, which may then be arranged into the output mesh.

In some implementations, such as in restoration design generation, the tooth name, the tooth designation and/or the type R may be concatenated with the latent vector A, as a means of conditioning the VAE on such information, to improve the ability of the VAE to respond to specific tooth types or designations.

The performance of the mesh reconstruction VAE can be measured using reconstruction error calculations. In some examples, reconstruction error may be computed as element-to-element distances between two meshes, for example using Euclidean distances. Other distance measures are possible in accordance with various implementations of the techniques of this disclosure, such as Cosine distance, Manhattan distance, Minkowski distance, Chebyshev distance, Jaccard distance (e.g. intersection over union of meshes), Haversine distance (e.g., distance across a surface), and Sorensen-Dice distance.

The performance of a mesh reconstruction VAE may, in some implementations, be verified via reconstruction error plots and/or other key performance indicators. The latent space vectors for one or more input tooth meshes may be plotted (e.g., in 2D) using UMAP or t-SNE dimensionality reduction techniques and compared, to select the best available separability between classes of tooth (molar, premolar, incisor, etc.), indicating that the model has an awareness of the strong geometric variation between classes, and a strong similarity within a class. This would be illustrated by clear, non-overlapping clusters in the resulting UMAP/t-SNE plots.

In some instances, the latent vector corresponding to a mesh may be used as a part of a classifier to classify that mesh. For example, classification may be performed to identify a tooth type or to detect errors in the mesh (or an arrangement of meshes), such as in a validation operation). The latent vector and/or computed mesh element features (such as spatial and/or structural mesh features described herein) may be provided to a supervised machine learning model to classify the mesh. A non-exhaustive list of possible supervised ML models is found elsewhere in this disclosure.

In some implementations, a reconstruction VAE may be trained to reconstruct any arbitrary tooth type. In other implementations, a reconstruction VAE may be trained to reconstruct a specific tooth type (e.g., a 1^{st} molar, or a central incisor).

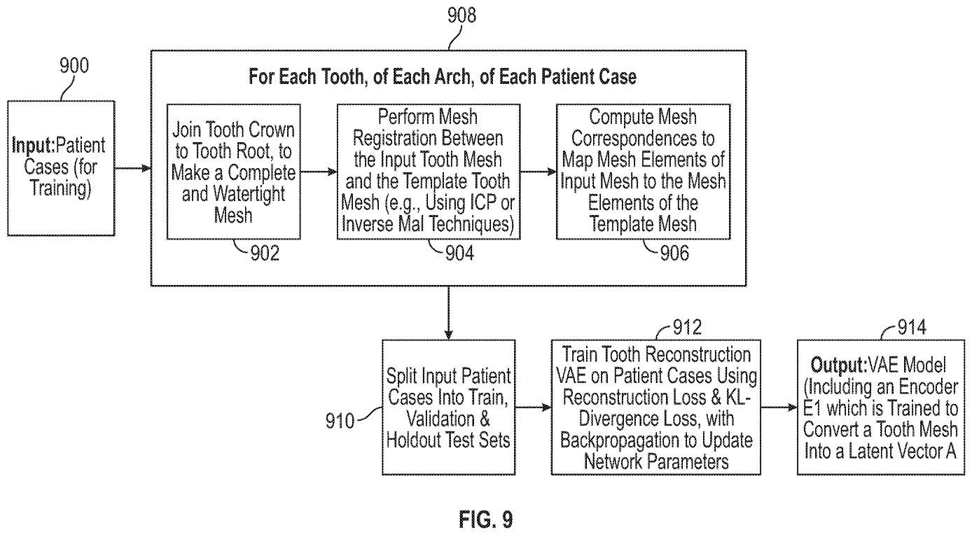

FIG. 9 describes the training of a mesh reconstruction VAE which, in some implementations, may be used to encode a tooth mesh (or other 3D oral care representation) into a latent representation (e.g., a latent vector) A. This VAE may also be trained to encode other kinds of 3D representations (e.g., setups transforms, mesh element labels, or meshes that describe gums, fixture model components, oral care hardware such as brackets and/or attachments, dental restoration appliance components, other portions of anatomy, or the like) into a latent vector A. In some implementations, mesh element features may be computed for one or more mesh elements of the 3D oral care representation, and be provided to the VAE, to improve the accuracy of the generated latent representation(s). The latent representation(s) may be provided to a second ML module. The second ML module (e.g., a Gaussian process, an SVM, a neural network, or another discriminative machine learning model) may be trained to classify the latent representation (and by corollary classify the original 3D oral care representation from which the latent representation was generated). The classification determination may be used as a part of an oral care appliance generation method. For example, one or more segmented teeth may be classified. Those class labels may enable the oral care appliance operations to proceed (e.g., either of orthodontic setups generation or dental restoration design generation may benefit from the identification of the teeth, so that particular teeth can receive special processing).

FIG. 9 shows a method that systems of this disclosure may implement to train an reconstruction autoencoder for reconstructing 3D representation of the patient's dentition. The particular example of FIG. 9 illustrates training of a variational autoencoder (VAE) for reconstructing a tooth mesh 900. In some examples, FIG. 9 may be associated with details on training a tooth crown reconstruction VAE of this disclosure. For each tooth in a patient case 900 (908), the systems of this disclosure may generate a watertight mesh by merging the tooth's crown mesh with the corresponding root mesh such that the vertices on the open edge of the crown mesh match up with the vertices on the open edge of the root mesh (902). The systems of this disclosure may perform a registration step (904) to align a tooth mesh with a template tooth mesh (e.g., using the iterative closest point technique or by applying the inverse mal transform for that tooth), with the technical enhancement of improving the accuracy and data precision of the mesh correspondence computation at 906. The systems of this disclosure may compute correspondences between a tooth mesh and the corresponding template tooth mesh, with the technical improvement of conditioning the tooth mesh to be ready to be provided to the reconstruction autoencoder. The dataset of prepared tooth meshes are split into train, validation and holdout test sets (910), which are then used to train a reconstruction autoencoder (912), described herein as a tooth VAE, tooth reconstruction VAE or more generally as a reconstruction autoencoder. The tooth VAE may comprise a 3D encoder which encodes a tooth mesh into a latent form (e.g., a latent vector A), and a subsequent 3D decoder reconstructs that tooth into a facsimile of the inputted tooth mesh. The tooth VAE of this disclosure may be trained using a combination of reconstruction loss and KL-Divergence loss, and optionally other of the loss functions described herein. The output of this method is a trained tooth reconstruction autoencoder 914.

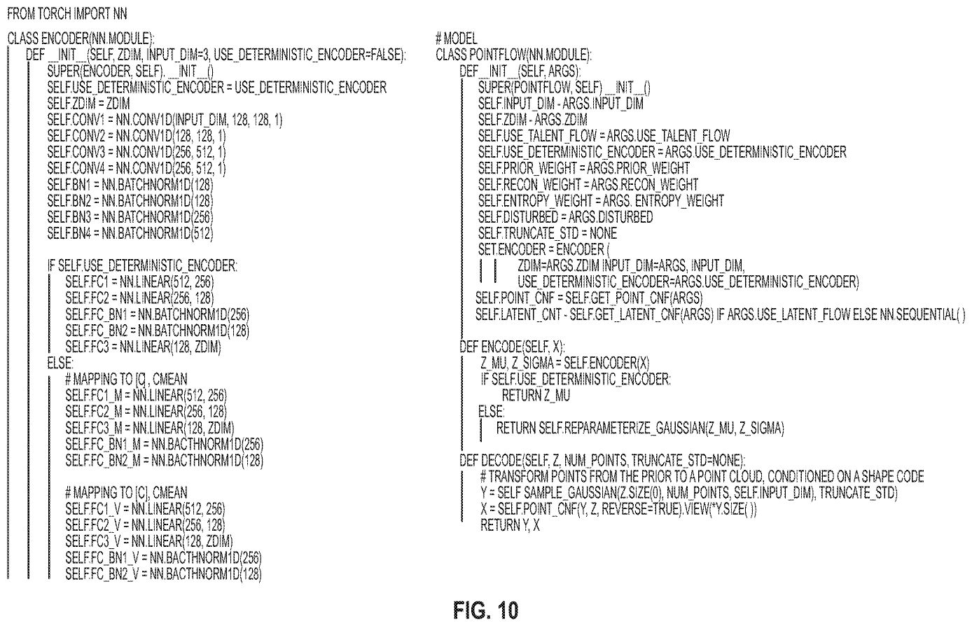

FIG. 10 shows non-limiting code implementing an example 3D encoder and an example 3D decoder for a mesh reconstruction VAE. These implementations may include: convolution operations, batch norm operations, linear neural network layers, Gaussian operations, and continuous normalizing flows (CNF), among others.

One of the steps which may take place in the VAE training data pre-processing is the calculation of mesh correspondences. Correspondences may be computed between the mesh elements of the input mesh and the mesh elements of a reference or template mesh with known structure. The goal of mesh correspondence calculation may be to find matching points between the surfaces of an input mesh and of a template (reference) mesh. Mesh correspondence may generate point to point correspondences between input and template meshes by mapping each vertex from the input mesh to at least one vertex in the template mesh. In one example, a range of entries in the vector may correspond to the mesial lingual cusp tip; another range of elements may correspond to the distal lingual cusp tip; another range of elements may correspond to the mesial surface of that tooth; another range of elements may correspond to the lingual surface of that tooth, and so on. In the case of a tooth mesh reconstruction autoencoder (such as a VAE), in some implementations, the autoencoder may be trained on just a subset of teeth (e.g., only molars or only upper left first molars). In other implementations, the autoencoder may be trained on a larger subset or all of the teeth in the mouth. In some implementations, an input vector may be provided to the autoencoder (e.g., a vector of flags) which may define or otherwise influence the autoencoder as to which type of tooth mesh may have been received by the autoencoder as input. A data precision improvement of this approach is to mesh correspondences in mesh reconstruction to reduce sampling error, improve alignment, and improve mesh generation quality. Further details on the use of mesh correspondences with the autoencoder models of this disclosure is found elsewhere in this disclosure.

In some implementations, an iterative closest point (ICP) algorithm may be run between the input tooth mesh and a template tooth mesh, during the computation of mesh correspondences. The correspondences may be computed to establish vertex-to-vertex relationships (between the input tooth mesh and the reconstructed tooth mesh), for use in computing reconstruction error.

In some implementations, an inverse mal transform may be applied to bring the input tooth mesh into at least approximate alignment with a template tooth mesh, during the computation of mesh correspondences. In some implementations, both ICP and an inverse mal transform may be applied. Training data:

According to particular implementations, training data may be generalized to one or more arches of teeth (e.g., among other 3D oral care representations) or may be more specific to particular teeth within an arch (e.g., among other 3D oral care representations). In situations in which more specific training data is leveraged, the specific training data can be presented as a tooth template. For instance, a tooth template may be specific to one or more tooth types (e.g., lower right central incisor). In some implementations, a tooth template may be generated which is an average of many examples of a certain type of tooth (such as an average of lower first molars). In some implementations, a tooth template may be generated which is an average of many examples of more than one tooth type (such as an average of first and second bicuspids from both upper and lower arches).

In some implementations, the pre-processing procedure may involve one or more of the following steps: generation of watertight meshes (e.g. making sure that the boundary of the root mesh seals cleanly against the boundary of the crown mesh), registration to align the tooth mesh with a template mesh (e.g., using either ICP or the inverse mal transform), and the computation of mesh correspondences (i.e., to generate mesh element-to-mesh element correspondences between the input tooth mesh and a template tooth mesh).

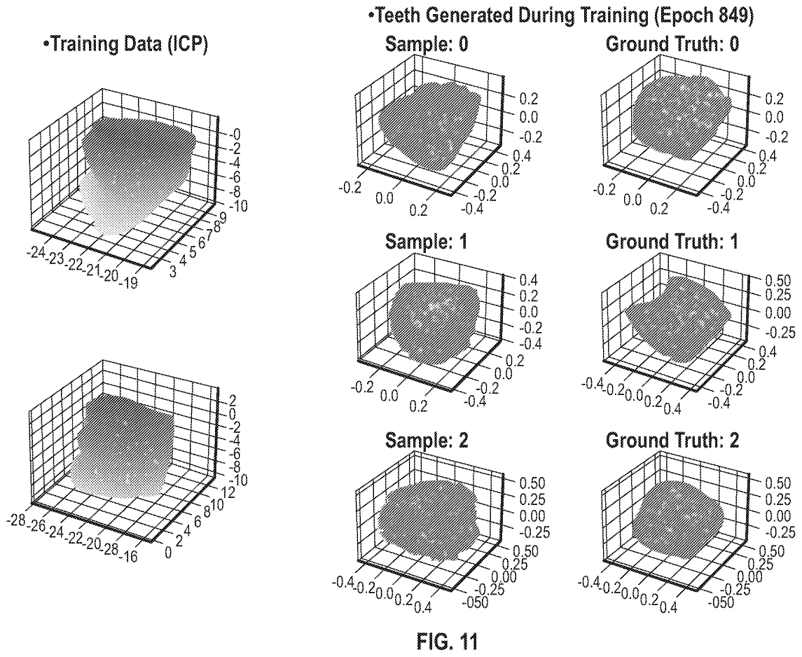

FIG. 11 shows Tooth reconstructions generated after training epoch 849 of a tooth reconstruction autoencoder. In FIG. 11, the left side (labelled as “Training Data (ICP)”) shows a tooth mesh (in the form of a 3D point cloud) after the completion of the pre-processing steps, where pre-processing used ICP to do the registration. The right side shows two things: the output of the tooth reconstruction VAE (in the left column) and the corresponding ground truth tooth 3D representation. In this instance as well, the 3D representation of each tooth is represented by a point cloud. This output was generated at epoch 849 of the reconstruction VAE training.

The above description deals primarily with the processing of mesh, point cloud and/or voxel data into latent space vectors, as a means for reducing the dimensionality of those data and strengthening the signal-to-noise ratio of those data, such that an ML classifier can make decisions based on those data. Applications include but are not limited to VAE Setups, MLP Setups, MAE Mesh In-Filling, VAE Mesh Element Labelling, VAE for Tooth Mesh Classification, and some examples of Setups Classification. A reconstruction autoencoder trained based on the above material is also relevant to validation operations, such as segmentation validation, coordinate system validation, mesh cleanup validation, restoration design validation, fixture model validation, clear tray aligner (CTA) trimline validation, setups validation, oral care appliance component validation (either or both of placement and generation), and hardware (bracket, attachment, etc.) placement validation, to name some examples.

Other types of data:

Autoencoders of this disclosure (such as a VAE or capsule autoencoder) may process other types of oral care data, such as text data, categorical data, spatiotemporal data, real-time data and/or vectors of real numbers, such as may be found among the procedure parameters. Data may be qualitative or quantitative. Data may be nominal or ordinal. Data may be discrete or continuous. Data may be structured, unstructured or semi-structured. The autoencoders of this disclosure may also encode such data into latent space vectors (or latent capsules) for later reconstruction. Those latent vectors/latent capsules may be used for prediction and/or classification. The reconstructions may be used for model verification, and for validation applications, for example, through the calculation of reconstruction error and/or the labeling of data elements.

A latent vector A which may be generated by the encoder E1 in a fully trained mesh reconstruction autoencoder (e.g., for tooth meshes), may be a reduced-dimensionality representation of the input mesh (e.g., a tooth mesh). In some implementations, the latent vector A may be a vector of 128 real numbers (or some other size, such as 256 or 512). The decoder D1 of the fully trained mesh reconstruction autoencoder may be capable to take the latent vector A as input and reconstruct a close facsimile of the input tooth mesh, with low reconstruction error. In some implementations, modifications may be made to the latent vector A, so as to effect changes in the shape of the reconstructed mesh that is generated from the decoder D2. Such modifications may be made after first mapping-out the latent space, to gain insight into the effects of making particular change. There are a variety of loss functions which may be used in the training of E1 and D1, which may involve terms related to reconstruction loss and/or KL-Divergence between distributions (e.g., in some instances to minimize the distance between the latent space distribution and a multidimensional Gaussian distribution). One purpose of the reconstruction loss term is to compare the predicted reconstructed tooth 3D representation to the corresponding ground truth reconstructed tooth 3D representation. One purpose of the KL-divergence term is to make the latent space more Gaussian, and therefore improve the quality of reconstructed meshes (i.e., especially in the case where the latent space vector may be modified, to change the shape of the outputted mesh, for example to segment a 3D mesh, or to perform tooth design generation for use in generating a dental reconstruction appliance).

In some implementations, modifications may be made to the latent vector A so as to change the characteristics of the reconstructed mesh (such as with the generation of a dental restoration tooth design mesh). If the loss L is computed using only reconstruction loss, and changes are made to the latent vector A, then in some use case scenarios, the reconstructed mesh may reflect the expected form of output (e.g., be a recognizable tooth). In other use case scenarios however, the output of the reconstructed mesh may not conform to the expected form of output (e.g., not be a recognizable tooth).

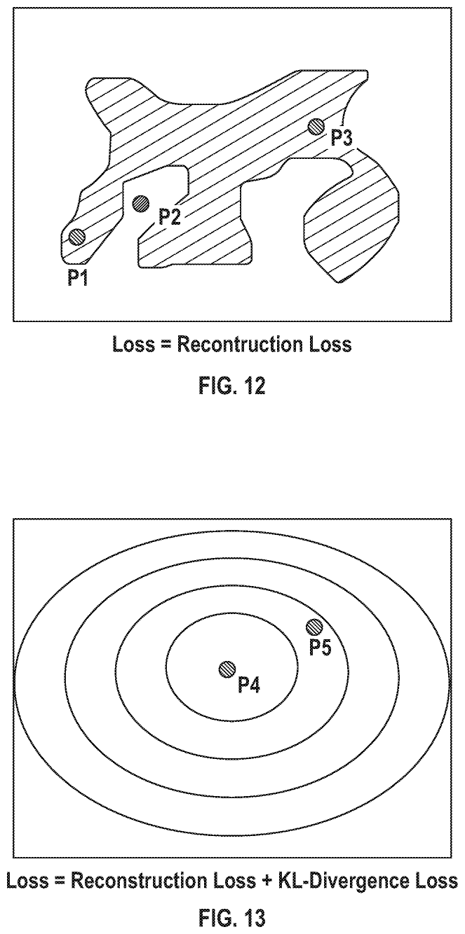

FIG. 12 illustrates a latent space where loss incorporates reconstruction loss but does not incorporate KL-Divergence loss. In FIG. 12, point P1 corresponds to the original form of a latent space vector A. Point P2 corresponds to a different location in the latent space, which may be sampled as a result of making modifications to the latent vector A, but where the mesh which is reconstructed from P2 may not give good output (e.g., does not look like a recognizable or otherwise suitable tooth). Point P3 corresponds to still a different location in the latent space, which may be sampled as a result of making a different set of modifications to the latent vector A, but where the mesh which is reconstructed from P3 may give good output (e.g., has the appearance of a tooth design which is suitable for use in generating a dental restoration appliance). In the case where loss involves only reconstruction loss, the subset of the latent space which can be sampled to produce a latent space vector P3 which yielding a valid reconstructed mesh may be irregular or hard to predict.

FIG. 13 illustrates an example latent space in which the loss includes both reconstruction loss and KL-divergence loss. If the loss is improved by incorporating a KL-divergence term, the quality of the latent space may improve significantly. The latent space may become more Gaussian under this new scenario (as shown in FIG. 13), a latent supervector A corresponds to point P4 near the center of a multidimensional Gaussian curve. Changes may be made to the latent supervector A, yielding point P5 nearby P4, where the resulting reconstructed mesh is highly likely to reflect desired attributes (e.g., is highly likely to be a valid tooth). The introduction of the KL-divergence term to loss may make the process of modifying the latent space vector A and getting a valid reconstructed mesh more reliable. In some implementations, as with a capsule autoencoder, the latent vector may be replaced with a latent capsule, which may undergo modification and subsequently be reconstructed. This autoencoder framework may, in some implementations, be adapted to the segmentation of tooth meshes. Additionally, this autoencoder framework may, in some implementations, be adapted to the task of tooth coordinate system prediction. In some implementations, a mesh reconstruction autoencoder for coordinate system prediction may compress the tooth data into latent vector form, and then provide the latent vector to a second ML module which has have been trained for coordinate system prediction (e.g., for coordinate system prediction on a mesh, with the goal of defining a local coordinate system for that mesh, such as a tooth mesh).

For a given domain (e.g., tooth restoration design generation, MAE tooth in-filling, or setups design, etc.), the latent space can be mapped-out, so that changes to the latent space vector A may lead to reasonably well reconstructed meshes. The latent space may be systematically mapped by generating latent vectors with carefully chosen variations in value (e.g., by experimenting with different combinations of 128 values in an example latent vector). In some instances, a grid search of values may be performed, with the advantage of efficiently exploring the latent space. With the latent space mapped-out, the shape of a mesh may be modified by nudging the values in one or more elements of the latent vector values towards the portion of the mapped out latent space which has been found to correspond to the desired tooth characteristics. The use of KL-divergence in the loss calculation increases the likelihood that the modified latent vector gets reconstructed into a valid example of the inputted 3D oral care representation (e.g., 3D mesh of a tooth).

In the case of restoration design generation, the mesh may correspond to at least some portion of a tooth. Changes may be made to a latent vector A, such that the resulting reconstructed tooth mesh may have characteristics which meet the specification set by the restoration design parameters. A neural network for tooth restoration design generation is described in US Provisional Application No. U.S. 63/366,514, the entire disclosure of which is incorporated herein by reference.

A tooth setup may be designed at least in part, by modifying a latent vector that corresponds to one or more teeth (e.g., each described as 3D point clouds, voxels or meshes) of an arch or arches which are to be placed in a setup configuration. This mesh may be encoded into a latent vector A which then undergoes modification to adjust the poses of the resulting tooth poses. The modified latent vector A′ may then be reconstructed into the mesh or meshes which describe the setup. Such a technique may be used to design a final setup configuration or an intermediate stage configuration, or the like.

The modifications to a latent vector may, in some implementations, be carried out via an ML model, such as one of the neural network models or other ML models disclosed elsewhere in this disclosure. In some implementations, a neural network may be trained to operate within the latent space of such vectors A of setups meshes. The mapping of the latent space of A may have been previously generated by making controlled adjustments to trial latent vectors and observing the resulting changes to a setups configuration (i.e., after the modified A has been reconstructed back into a full mesh or meshes of the dental arch). The mapping of the latent space may, in some instances, follow methodical search patterns, such as in a grid search.

In some implementations, a tooth reconstruction VAE may take a single input of tooth name/type/designation R, which may command the VAE to output a tooth mesh of the designated type. This can be accomplished by generating a latent vector A′ for use in reconstructing a suitable tooth mesh. In some implementations, this latent vector A′ may be sampled or generated “on the fly”, out of a prior mapping of the latent vector space. Such a mapping may have been performed to understand which portions of the latent vector space correspond to different shapes, structures and/or geometries of tooth. For example, out of the 128 real values in an example latent vector A′ (other sizes are possible), certain elements, and perhaps certain ranges of values for those vector elements may have been determined to correspond to a certain type/name/designation of tooth and/or a tooth with a certain shape or other intended characteristics. This model for tooth mesh generation may also apply to the generation of oral care hardware, appliances and appliance components (such as to be used for orthodontic treatment). This model may also be trained for the generation of other types of anatomy. This model may also be trained for the generation of other types on non-oral care meshes as well.

The mesh comparison module may compare two or more meshes, for example for the computation of a loss function or for the computation of a reconstruction error. Some implementations may involve a comparison of the volume and/or area of the two meshes. Some implementations may involve the computation of a minimum distance between corresponding vertices/faces/edges/voxels of two meshes. For a point in one mesh (vertex point, mid-point on edge, or triangle center, for example) compute the minimum distance between that point and the corresponding point in the other mesh. In the case that the other mesh has a different number of elements or there is otherwise no clear mapping between corresponding points for the two meshes, different approaches can be considered. For example, the open-source software packages CloudCompare and MeshLab each have mesh comparison tools which may play a role in the mesh comparison module for the present disclosure. In some implementations, a Hausdorff Distance may be computed to quantify the difference in shape between two meshes. The open-source software tool Metro, developed by the Visual Computing Lab, can also play a role in quantifying the difference between two meshes. The following paper describes the approach taken by Metro, which may be adapted by the neural networks applications of the present disclosure for use in mesh comparison and difference quantification: “Metro: measuring error on simplified surfaces” by P. Cignoni, C. Rocchini and R. Scopigno, Computer Graphics Forum, Blackwell Publishers, vol. 17(2), June 1998, pp 167-174.

Some techniques of this disclosure may incorporate the operation of, for one or more points on the first mesh, projecting a ray normal to the mesh surface and calculating the distance before that ray is incident upon the second mesh. The lengths of the resulting line segments may be used to quantify the distance between the meshes. According to some techniques of this disclosure, the distance may be assigned a color based on the magnitude of that distance and that color may be applied to the first mesh, by way of visualization.

Some techniques of this disclosure may incorporate the operation of, for one or more points on the first mesh, shooting a ray normal to the mesh surface and calculating the distance before that ray is incident upon the second mesh. The lengths of the resulting line segments may be used to quantify the distance between the meshes. According to some techniques of this disclosure, the distance may be assigned a color based on the magnitude of that distance and that color may be applied to the first mesh, by way of visualization.

Techniques of this disclosure may, in some implementations, classify 3D oral care representations using latent encodings of those 3D oral care representations. A first neural network, such as an encoder, may be trained to encode an instant (e.g., a representation that is being processed at deployment) 3D oral care representation (e.g., such as may be described by a 3D mesh, 3D point cloud, voxelized representation, or others described herein—such as matrices, vectors or mesh element labels) into a latent form (e.g., a latent representation such as a latent vector or a latent capsule). In some implementations, such an encoder may be trained as a part of a reconstruction autoencoder, where the encoder is trained end-to-end with a decoder and the decoder may reconstruct the latent from into a facsimile of the instant 3D oral care representation. The latent from may be provided to a first neural network, which may be trained to classify the latent form, as a stand-in for the classification of the instant 3D oral care representation.

In some implementations, such as with contrastive learning, the encoder may be trained end-to-end with the second neural network (e.g., the classification neural network). Contrastive learning may, in some implementations, train the encoder to generate latent forms which are geodesically nearby each other in the latent space for instant 3D oral care representations which are of the same or similar type or classification. For example, tooth meshes which describe an upper right cuspid are of the same type or classification. Furthermore, setups which describe malocclusions are of the same type or classification. Contrastive learning may, in some implementations, train the encoder to generate latent forms which are geodetically far apart in the latent space for instant 3D oral care representations which are of different types or classifications. For example, a tooth mesh which describe an upper right cuspid is of a different type or classification from a tooth mesh that describes a lower left 1^{st} molar. Furthermore, an intermediate setup (e.g., from stage 2) is of a different type or classification from a final setup. This contrastive behavior on the part of the first neural network (e.g., with generates the representation) may assist the second neural network (in deployment) in predicting the classification or type of an instant 3D oral care representation. In some implementations, the second neural network may comprise a Siamese network, which may take two inputs at training time. The Siamese network may take two inputs of the same classification or type and render a determination at the output that the two inputs are of the same classification or type. The Siamese network may take two inputs which are of classifications or types and render a determination at the output that the two inputs are of different classifications or types. In some implementations, this predicted determination may be compared to a ground truth determination (or label) which is associated with the pair of inputs. One or more loss values may be computed based on the comparing. Circle loss or triplet loss (among others) may be computed. The one or more loss values may be used to train, at least in part, the first and second neural networks (e.g., in an end-to-end fashion). In this manner, contrastive learning techniques may be used to train an assemblage of one or more neural networks to classify a 3D oral care representation (e.g., examples of which are disclosed herein).

3D oral care representations may be classified according to techniques disclosed herein. In accordance with these techniques, a first machine learning module may be trained to generate a representation of a first 3D oral care representation. This generated representation is referred to as a second 3D representation. A second machine learning module may be trained to classify the second representation. An advantage of this two-model-based method of this disclosure is to encode those representations into forms which classification machine learning models may more easily classify (e.g., to reduce the dimensionality of the 3D oral care representations and/or strengthen the signal present with the data that enables classification to take place). In this way, the two-model architecture of this disclosure provides a technical improvement of footprint reduction and computing resource consumption reduction. This reduction in dimensionality may mitigate high-dimensionality-related adverse effects of training of some machine learning classifiers. The reduction in dimensionality may reduce the feature space that a machine learning classifier is required to learn, which may lead to improved classification accuracy, thereby providing the technical improvement of data precision as well.

In some implementations, an autoencoder may be trained to produce the representation of the 3D oral care representation. In some instances, optional mesh element feature vectors may be computed for the mesh elements of the 3D oral care representation. These mesh element features may aid the autoencoder in assimilating and encoding the shape and/or structure of the 3D oral care representation.

Such autoencoders may be trained to reconstruct the 3D oral care representations using datasets comprising the relevant 3D oral care representations. For example, an autoencoder to reconstruct teeth may be trained on a dataset comprising tooth meshes.

In some implementations, machine learning models other than autoencoders may be used to produce the second representation. These models include 3D encoders, U-Nets, 3D pyramid encoder-decoders, or the like. These models may also benefit from being trained to receive mesh element features as input, thereby providing the data precision-based technical advantage of improving the accuracy of the generated second representations.

In some implementations, the first machine learning module may receive optional oral care metrics at the input, such as orthodontic metrics or restoration design metrics. These metrics may also help the autoencoder to understand the shape and/or structure of the received meshes, and ultimately lead to an improved second representation and more accurate classification results, thereby providing the technical improvement of enhanced data precision as well.

Aspects of this disclosure are directed to a setups classifier, or “setups classification tool.” In scenarios in which a ground truth reference is available, such as during model training, systems of this disclosure may use the various advantageous loss functions described herein to compare predicted data to the ground truth reference. In the absence of a ground truth reference, such as after model deployment in a production environment, the task of assessing the quality of a model increases in difficulty and complexity. The setups classification neural network of this disclosure addresses the challenges associated with model quality evaluation in scenarios in which the ground truth is not available.

The setups classification neural network of this disclosure can be trained to classify a configuration of a set of tooth meshes. There are multiple classes of tooth configurations which are useful to the treatment planning process, for example, mal, intermediate, and setup. The mal configuration reflects the starting configuration of the teeth. An intermediate stage configuration reflects the state of the teeth during treatment, as the teeth are being moved towards the final setup state. The setup configuration reflects the intended or target state of the teeth at the end of treatment (a final setup). There are typically multiple intermediate states. Some implementations of classification neural networks may be configured to distinguish between two or more of the intermediate stages.

Training a neural network to classify a setup, such as S1, S3, or S4 provides one or more advantages. Setup classification is useful for CTA fabrication and also for indirect bonding tray fabrication. Setup classification may also be applied to the fabrication of other oral care appliances. Such a classifier may be used by an automated staging or final setups prediction system, to assess the progress (i.e., movement of the teeth towards the goal poses) and performance (i.e., accuracy) of those predictions. Such a classifier may be used to train a new clinician to correctly recognize the state of an arch. Because such a classifier may be trained to be sensitive to subtleties in the dataset, the classifier may improve data precision and output accuracy in determining when the teeth have achieved acceptable final positions.

The classifier tools of this disclosure may indicate when changes to the configuration of teeth are complete (i.e., reflect the setup configuration). In some examples, the classifier tool may output an indication of how much work remains, a quantification of the extent of further changes that may be performed to the tooth configuration before the tooth configuration reflects a setup configuration.

In some examples, the neural network may directly classify a tooth mesh or set of tooth meshes, in terms of mal, intermediate, and setup. In other examples, a neural network, such as a variational autoencoder, may operate on the tooth mesh or tooth meshes to produce output (e.g., a latent space vector or vectors) which can then be outputted to a machine learning (ML) classification module, to effectuate the class determination (e.g., mal, intermediate or setup). A classification may also include an indication of whether the setup is appropriate for the fabrication of an oral care appliance, such as a CTA for orthodontic treatment.

In some implementations, the setups classifier tools of this disclosure (such as an encoder structure) could be used for the classification of an arch of tooth meshes, for example S1, S3 or S4, to determine whether the input arch reflects a mal configuration, an intermediate configuration, or a setup configuration. Some implementations of an encoder may include a dense layer. In some implementations, the encoder structure consumes representations of all teeth of the arch(es) at once and outputs the classification of the arch(es), for example, if all of the teeth are in a contiguous mesh, such as when gums are present. In some implementations, a transformer structure may be used in place of or in addition to the encoder structure and handle the generation of transforms for multiple teeth at once. Some implementations of a transformer may include a combination of one-to-many conv/dense/sparse layers, possibly forming structures such as ResNet.

The use of a transformer as an encoder or encoder/decoder pair may leverage the transformer block's inherent ability to deal with sequence-like data but process the sequence all at once, in contrast to architectures such as LSTMs or RNN which process the sequence from start to finish. Although arches are not sequential like language or speech data, transformers are still applicable to dental arch classification. For arches, the self-attention mechanism of transformers enable the model to learn a measure of relevance from one tooth to another tooth, from and to any mesh element (e.g., vertex, edge or face) in the arch.

Some of the setups classifiers of this disclosure are directed to a variational autoencoder (VAE) Setup Classifier. The VAE-based classifier of this disclosure executes a VAE to classify an arch of tooth meshes, such as S1, S3, or S4. The VAE incorporates an encoder structure which first transforms the 3D mesh of the tooth (e.g., a 3D mesh) into a latent space vector, thereby reducing the dimensionality of the representation of the tooth mesh. In addition to inputting the 3D mesh of the tooth, the VAE may also take as input spatial or structural information about the tooth, such as a transform that affects the pose (position and orientation) of the tooth. Structural information may include information about the physical dimensions of the tooth, such as height, width, diameter, circumference, volume, or mesh element count or mesh element distribution.

In the typical functioning of the VAE, this latent space vector can be provided to the decoder structure of the VAE, to be transformed back into a 3D mesh, possibly with reduced noise and/or modified attributes. In this instance, the latent space vector is outputted from the VAE to an ML classifier module, where the latent space vector (and the associated mesh) may be classified, for example, as mal, intermediate, or setup. This method may be executed on a single tooth mesh, on a portion of tooth meshes in S1, S3, or S4, or on the entire set of tooth meshes in S1, S3, or S4. The end result is a classification of that arch as mal, intermediate, or setup. In some instances, there may be several intermediate classes, corresponding to different stages of treatment. The term mesh should be understood in a non-limiting sense to be inclusive of 3D mesh, 3D point cloud and 3D voxelized representation.

Some implementations of the VAE-based classifier of this disclosure use a sparse mesh processing model to classify an arch of tooth meshes, such as that implemented by the open source MinkowskiEngine toolkit. Such an implementation would convert the tooth meshes into a volumetric form, such as using voxels, for sparse processing. The advantage of this type of sparse processing is that all of the disconnected tooth meshes of the arch can be processed together, rather than being fed individually into a neural network such as the open-source toolkit MeshCNN. MeshCNN can, nonetheless, be used for setups classification, particularly if the teeth of the arch are merged into a single mesh, such as with the addition of gum tissue to the arch.

In some implementations, the latent vector A for each of the several teeth of an arch may be concatenated onto a vector B, which may then be used as the input to a setups classification neural network of this disclosure. Other ML models may also be used to classify such a latent space vector B, such as the neural networks or other ML models listed elsewhere in this disclosure. In some examples, an SVM or a logistic regression model may be used to classify a latent vector B for the purpose of classifying a setup. Additional classification machine learning models which may be trained include a neural network, a regression model, a decision tree, a random forest model, a boosting model, a Gaussian process, a k-nearest neighbors (KNN) model, a Naïve Bayes model, or a gradient boosting algorithm. Other classification machine learning models may be trained for use with systems of this disclosure, as well. These classification models may be used when classifying a representation of a tooth (e.g., a representation created by an autoencoder, a U-Net or other neural network). In some instances, mesh element features may be provided to a neural network which generates a representation of a 3D oral care representation (e.g., a tooth or setup), to improve the quality of the generated representation, thereby providing a data precision-related technical improvement.

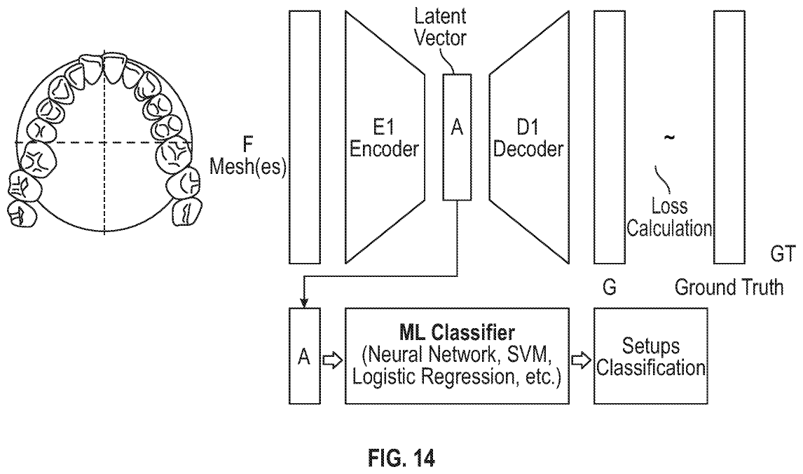

In some implementations, the training of the encoder E1 of FIG. 14 may benefit from receiving mesh element feature vectors at the input (e.g., a mesh element feature vector may be computed for each mesh element present in the input meshes—such as tooth meshes). These mesh element features may help the autoecoder to understand the shape and/or structure of the received meshes and ultimately improve the accuracy of the latent vector A (e.g., may enable A to be reconstructed into a more accurate facsimile of the input meshes F).

FIG. 14 illustrates an example of a classification technique of this disclosure for setups. The upper portion of FIG. 14 shows the process of training a mesh reconstruction VAE to produce a latent vector A for an input setups mesh or meshes. In deployment, the setups mesh (or meshes) is provided to E1, encoded into latent vector A, and then that A may be provided to one or more ML classifiers (such as one of the classifiers mentioned elsewhere in this disclosure). In some implementations, more than one ML classifier may be executed on A, and a final classification may be produced through a voting mechanism. The deployed system may generate a classification for the setup (e.g., mal, staging, final). The decoder D1 is involved in the training of the reconstruction autoencoder shown in the top portion of FIG. 14. The latent vector A may be reconstructed into a reconstructed setup G, which may be compared to a ground truth setup GT as a part of loss calculation. The computed loss may be used to train, at least in part either or both of the encoder E1 and the decoder D1.

Capsule Autoencoder classification can be applied to setups classification. The tooth meshes (or point clouds) of the setup may be provided to the capsule autoencoder, resulting in one or more latent capsules T. These latent capsules T may be provided to one or more ML models, such as a neural network or an SVM, for the purpose of classifying the setup. In some implementations, an MLP which has been trained using cross entropy loss may be used to classify the setup. The same setups classification categories which pertain to the VAE classification implementation also pertain to the cross entropy-trained MLP-based implementation.

The setups classification techniques of the present disclosure may, in some implementations, be used to classify dental restoration arches for use in dental restoration (e.g., to label an arch as pre-restoration, post-restoration, etc.).

Some implementations of the classifier tools of this disclosure may use a Frechet Inception Distance (FID) score to classify setups. The FID score may, in some implementations, be used to distinguish between a group of predicted final setups and a group of (clinician-approved) ground truth setups. To achieve this, a classifier may, in some implementations, be trained to distinguish between a group of predicted final setups and a group of (technician approved) ground truth setups, and then that classifier may be used as a stand-in for a classifier to distinguish between a maloccluded setup and a technician approved final setup. Near the output of the classifier (e.g., the output of the final convolutional layer) activations are extracted from the convolution neurons. These outputs comprise a feature vector defining the setup (e.g., either final setup or maloccluded setup). The neural network model's final (dense) layers use this feature vector to classify the setup as either a final setup or a maloccluded setup. During training, the convolution weights are learned such that this feature vector is maximally different between final setup and maloccluded setup (thereby making those two types of setups easier to classify). The FID score quantifies the difference between a group of feature vectors which correspond to final setups and a group of feature vectors corresponding to setups which receive the neural network model assigns the label “final setup.”

Some implementations of the techniques of this disclosure may use a latent vector A for a tooth to classify the tooth according to different categories, such as state of health (e.g., healthy, not healthy, and/or type of disorder or deformity), or type (e.g., such as defined by one of the dental notation systems listed elsewhere in this disclosure). In some implementations, a portion of a tooth mesh may be classified according to state of health. Such a portion of a tooth mesh may be identified or isolated according to FIGS. 19, 20 or 21 of US Provisional Application No. U.S. 63/370,160, or according to techniques described elsewhere in this disclosure. Both of these methods use neural networks to identify mesh elements (such as in a tooth mesh) which may benefit from further processing and/or exhibit anomalous qualities. Classification can label anomalies in the tooth mesh or the fragment of tooth mesh, such as extraneous material, divots, abfractions, lingual bars, undercuts, decay/caries, and other anomalies. In the case that a process has identified a portion of a mesh (such as a tooth mesh) as anomalous, a latent vector A can be computed for that flagged or labeled portion of the tooth mesh, and the resulting A can be classified using one of the classification neural networks of this disclosure (such as an MLP) which has been trained to classify latent vectors A (or latent capsules T). In some instances, a U-Net may be used to perform this classification. In some instances, an encoder may perform the classification. In some instances, the open source MeshCNN may be adapted to perform such a classification. Other ML models may also be used to classify such a latent space vector A, such as the neural networks or other ML models listed elsewhere in this disclosure (e.g., am SVM). In some instances, an encoder structure may be used to classify such a latent vector A.

In some instances, the tooth classifier may classify a portion of a tooth mesh to identify the anatomical features represented in that mesh fragment (e.g., such as a cusp tip or incisal edge, or to distinguish between a crown and a root). In some implementations a classifier model of this disclosure may be trained on examples of latent vector A where oral care hardware is involved. The classifier model can receive a tooth mesh, encode the tooth mesh to latent vector A and input A to a suitable ML model for classification as to whether the tooth has attached hardware. If the tooth mesh lacks hardware, the classifier is trained to output “NoHardware” as the result. If the tooth mesh has shape and/or structure consistent with attached hardware (such as a lingual bracket, labial bracket or orthodontic attachment meant to interface with a clear tray aligned) then the classifier is trained to output a result such as “HasHardware.” In some examples, the classifier may be trained to output an indication of which kind of hardware is attached.

In some implementations, a setup may be classified by first encoding the mesh or meshes of the arch as one or more latent vectors, and then applying one or more ML classifiers to the one or more latent vectors. In some instances, the entire arch may be a single mesh (e.g., pre-segmentation). The setup may be classified, for example, as mal, staging, or final setup. Other classes are possible, such as age and state of health.

Generally speaking, other kinds of anatomy can be labeled or classified by the classifier tools of this disclosure, as well. Any object that can be described by a 3D mesh can be classified by first computing a latent vector for the mesh and then applying an ML model to the classification of that latent vector.

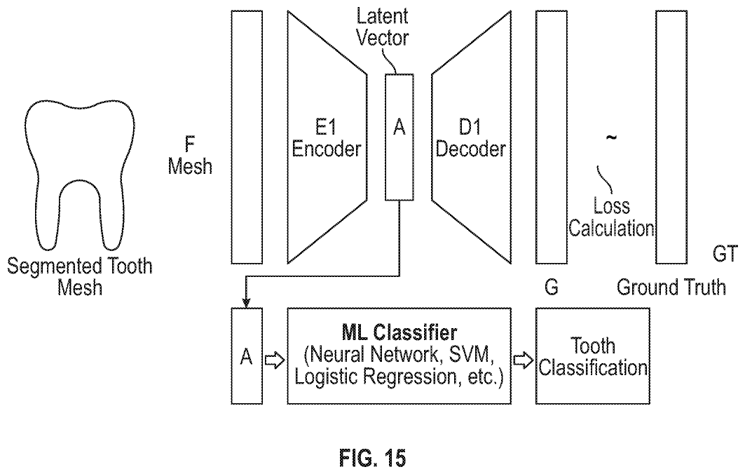

FIG. 15 illustrates an example of a classification implementation of this disclosure for tooth meshes (or other oral care meshes) using an autoencoder. In some implementations, the training of the encoder E1 in FIG. 15 may enhance output precision by receiving mesh element feature vectors at the input (e.g., a mesh element feature vector may be computed for each mesh element present in the input meshes—such as tooth meshes). These mesh element features may help the encoder E1 to encode the shape and/or structure of the received 3D oral care representations F (e.g., tooth meshes) and ultimately improve the accuracy of the latent vector A (e.g., may enable A to be reconstructed into a more accurate facsimile of the input meshes F).

The upper portion of FIG. 15 shows the process of training a mesh reconstruction VAE to produce a latent vector A for an input tooth mesh (which in some instances may have undergone segmentation). The latent vector A may be reconstructed by decoder D1 into a reconstructed tooth G, which may be compared to a ground truth tooth GT as a part of loss calculation. The computed loss may be used to train, at least in part either or both of the encoder E1 and the decoder D1. The encoder E1 of the reconstruction autoencoder is an example of a first ML module.

In deployment, the tooth mesh may be provided to E1, encoded into latent vector A and then that A may be provided to one or more ML classifiers (such as one of the classifiers mentioned elsewhere in this disclosure). The ML classifier is an example of a second ML module. In some implementations, more than one ML classifier may be executed on A, and a final classification may be produced through a voting mechanism. The deployed system may generate a classification for the 3D representation of the tooth (e.g., a classic aition for the tooth mesh). In some instances, a tooth name may be generated (e.g., UpperRightCentralIncisor, LowerLeftSecondMolar). In some instances, a state of health of the tooth may be generated (e.g. Healthy, NotHealthy). In some instances, a specific deformity or medical ailment may be identified by the ML classifier or classifiers.

According to some examples of this disclosure, capsule autoencoder classification can be applied to tooth classification. The tooth mesh (or point cloud) may be provided to the capsule autoencoder, resulting in a latent capsule T. This latent capsule T may be provided to one or more ML models, such as a neural network or an SVM, for the purpose of classifying the tooth. In some implementations, an MLP which has been trained by cross entropy loss may be used to classify the tooth mesh. The same tooth classification categories which pertain to the VAE classification implementation also pertain to this implementation.

Techniques of this disclosure may, in some implementations, use PointNet, PointNet++, or derivative neural networks (e.g., networks trained via transfer learning using either PointNet or PointNet++ as a basis for training) to extract local or global neural network features from a 3D point cloud or other 3D representation (e.g., a 3D point cloud describing aspects of the patient's dentition—such as teeth or gums). Techniques of this disclosure may, in some implementations, use U-Nets to extract local or global neural network features from a 3D point cloud or other 3D representation.

3D oral care representations are described herein as such because 3-dimensional representations are currently state of the art. Nevertheless, 3D oral care representations are intended to be used in a non-limiting fashion to encompass any representations of 3-dimensions or higher orders of dimensionality (e.g., 4D, 5D, etc.), and it should be appreciated that machine learning models can be trained using the techniques disclosed herein to operate on representations of higher orders of dimensionality.

In some instances, input data may comprise 3D mesh data, 3D point cloud data, 3D surface data, 3D polyline data, 3D voxel data, or data pertaining to a spline (e.g., control points). An encoder-decoder structure may comprise one or more encoders, or one or more decoders. In some implementations, the encoder may take as input mesh element feature vectors for one or more of the inputted mesh elements. By processing mesh element feature vectors, the encoder is trained in a manner to generate more accurate representations of the input data. For example, the mesh element feature vectors may provide the encoder with more information about the shape and/or structure of the mesh, and therefore the additional information provided allows the encoder to make better-informed decisions and/or generate more-accurate latent representations of the mesh. Examples of encoder-decoder structures include U-Nets, autoencoders or transformers (among others). A representation generation module may comprise one or more encoder-decoder structures (or portions of encoders-decoder structures—such as individual encoders or individual decoders). A representation generation module may generate an information-rich (optionally reduced-dimensionality) representation of the input data, which may be more easily consumed by other generative or discriminative machine learning models.

A U-Net may comprise an encoder, followed by a decoder. The architecture of a U-Net may resemble a U shape. The encoder may extract one or more global neural network features from the input 3D representation, zero or more intermediate-level neural network features, or one or more local neural network features (at the most local level as contrasted with the most global level). The output from each level of the encoder may be passed along to the input of corresponding levels of a decoder (e.g., by way of skip connections). Like the encoder, the decoder may operate on multiple levels of global-to-local neural network features. For instance, the decoder may output a representation of the input data which may contain global, intermediate or local information about the input data. The U-Net may, in some implementations, generate an information-rich (optionally reduced-dimensionality) representation of the input data, which may be more easily consumed by other generative or discriminative machine learning models.

An autoencoder may be configured to encode the input data into a latent form. An autoencoder may train an encoder to reformat the input data into a reduced-dimensionality latent form in between the encoder and the decoder, and then train a decoder to reconstruct the input data from that latent form of the data. A reconstruction error may be computed to quantify the extent to which the reconstructed form of the data differs from the input data. The latent form may, in some implementations, be used as an information-rich reduced-dimensionality representation of the input data which may be more easily consumed by other generative or discriminative machine learning models. In most scenarios, an autoencoder may be trained to input a 3D representation, encode that 3D representation into a latent form (e.g., a latent embedding), and then reconstruct a close facsimile of that input 3D representation as the output.

A transformer may be trained to use self-attention to generate, at least in part, representations of its input. A transformer may encode long-range dependencies (e.g., encode relationships between a large number of inputs). A transformer may comprise an encoder or a decoder. Such an encoder may, in some implementations, operate in a bi-directional fashion or may operate a self-attention mechanism. Such a decoder may, in some implementations, may operate a masked self-attention mechanism, may operate a cross-attention mechanism, or may operate in an auto-regressive manner. The self-attention operations of the transformers described herein may, in some implementations, relate different positions or aspects of an individual 3D oral care representation in order to compute a reduced-dimensionality representation of that 3D oral care representation. The cross-attention operations of the transformers described herein may, in some implementations, mix or combine aspects of two (or more) different 3D oral care representations. The auto-regressive operations of the transformers described herein may, in some implementations, consume previously generated aspects of 3D oral care representations (e.g., previously generated points, point clouds, transforms, etc.) as additional input when generating a new or modified 3D oral care representation. The transformer may, in some implementations, generate a latent form of the input data, which may be used as an information-rich reduced-dimensionality representation of the input data, which may be more easily consumed by other generative or discriminative machine learning models.

In some implementations, an encoder-decoder structure may first be trained as an autoencoder. In deployment, one or more modifications may be made to the latent form of the input data. This modified latent form may then proceed to be reconstructed by the decoder, yielding a reconstructed form of the input data which differs from the input data in one or more intended aspects. Oral care arguments, such as oral care parameters or oral care metrics may be provided to the encoder, the decoder, or may be used in the modification of the latent form, to influence the encoder-decoder structure in generating a reconstructed form that has desired characteristics (e.g., characteristics which may differ from that of the input data).

Techniques of this disclosure may, in some instances, be trained using federated learning. Federated learning may enable multiple remote clinicians to iteratively improve a machine learning model (e.g., validation of 3D oral care representations, mesh segmentation, mesh cleanup, other techniques which involve labeling mesh elements, coordinate system prediction, non-organic object placement on teeth, appliance component generation, tooth restoration design generation, techniques for placing 3D oral care representations, setups prediction, generation or modification of 3D oral care representations using autoencoders, generation or modification of 3D oral care representations using transformers, generation or modification of 3D oral care representations using diffusion models, 3D oral care representation classification, imputation of missing values), while protecting data privacy (e.g., the clinical data may not need to be sent “over the wire” to a third party). Data privacy is particularly important to clinical data, which is protected by applicable laws. A clinician may receive a copy of a machine learning model, use a local machine learning program to further train that ML model using locally available data from the local clinic, and then send the updated ML model back to the central hub or third party. The central hub or third party may integrate the updated ML models from multiple clinicians into a single updated ML model which benefits from the learnings of recently collected patient data at the various clinical sites. In this way, a new ML model may be trained which benefits from additional and updated patient data (possibly from multiple clinical sites), while those patient data are never actually sent to the 3rd party. Training on a local in-clinic device may, in some instances, be performed when the device is idle or otherwise be performed during off-hours (e.g., when patients are not being treated in the clinic). Devices in the clinical environment for the collection of data and/or the training of ML models for techniques described herein may include intra-oral scanners, CT scanners, X-ray machines, laptop computers, servers, desktop computers or handheld devices (such as smart phones with image collection capability). In addition to federated learning techniques, in some implementations, contrastive learning may be used to train, at least in part, the ML models described herein. Contrastive learning may, in some instances, augment samples in a training dataset to accentuate the differences in samples from different classes and/or increase the similarity of samples of the same class.

Machine learning models such as: U-Nets, encoders, autoencoders, pyramid encoder-decoders, transformers, or convolution and/or pooling layers, may be trained as a part of a method for hardware (or appliance component) placement. Representation learning may train a first module to determine an embedded representation of a 3D oral care representation (e.g., encoding a mesh or point cloud into a latent form using an autoencoder, or using a U-Net, encoder, transformer, block of convolution and/or pooling layers or the like). That representation may comprise a reduced dimensionality form and/or information-rich version of the inputted 3D oral care representation. In some implementations, the generation of a representation may be aided by the calculation of a mesh element feature vector for one or more mesh elements (e.g., each mesh element). In some implementations, a representation may be computed for a hardware element (or appliance component). Such representations are suitable to be provided to a second module, which may perform a generative task, such as transform prediction (e.g., a transform to place a 3D oral care representation relative to another 3D oral care representation, such as to place a hardware element or appliance component relative to one or more teeth) or 3D point cloud generation. In the instance where a U-Net (among other neural networks) is trained to generate the representations of tooth meshes, the mesh convolution and/or mesh pooling techniques described herein leverage invariance to rotations, translations, and/or scaling of that tooth mesh to generate predications that techniques that are not invariant to the rotations, translations, and/or scaling of that tooth mesh cannot generate.

Techniques described herein may be trained to classify 3D oral care representations (e.g., tooth crowns, orthodontic setups, or other examples of 3D oral care representations described herein). 3D representations may comprise point clouds, polylines, meshes, voxels and the like. 3D oral care representations may be classified according to the specification of the oral care arguments which may, in some implementations, be provided to the classification model. Oral care arguments may include oral care parameters as disclosed herein, or other real-valued, text-based or categorical inputs which specify aspects of the 3D oral care representations which are classified by the techniques described herein. In some instances, oral care arguments may include oral care metrics. Oral care arguments are specifically adapted to the implementations described herein. For example, the oral care arguments may specify the manner in which the 3D oral care representations of this disclosure may be classified. In short, implementations using the specific oral care arguments disclosed herein generate more accurate classifications than do implementations that do not use the specific oral care arguments. In some instances, a text encoder may encode a set of natural language instructions from the clinician (e.g., generate a text embedding). A text string may comprise tokens. An encoder for generating text embeddings may, in some implementations, apply either mean-pooling or max-pooling between the token vectors. In some instances, a transformer (e.g., BERT or Siamese BERT) may be trained to extract embeddings of text for use in digital oral care (e.g., by training the transformer on examples of clinical text, such as those given below). In some instances, such a model for generating text embeddings may be trained using transfer learning (e.g., initially trained on another corpus of text, and then receive further training on text related to digital oral care). Some text embeddings may encode text at the word level. Some text embeddings may encode text at the token level. A transformer for generating a text embedding may, in some implementations, be trained, at least in part, with a loss calculation which compares predicted outputs to ground truth outputs (e.g., softmax loss, multiple negatives ranking loss, MSE margin loss, cross-entropy loss or the like). In some instances, the non-text arguments, such as real values or categorical values, may be converted to text, and subsequently embedded using the techniques described herein.

In some implementations, the 3D oral care representation classification techniques of this disclosure may be combined with orthodontic setups prediction, dental restoration appliance generation, fixture model generation, restoration design generation, the generation of an indirect bonding tray for orthodontic treatment, or other oral care automation techniques described herein. For example, tooth classification may first be performed prior to automation techniques in digital oral care.

Orthodontic setups prediction benefits from knowledge of tooth mesh identities, because the setups prediction ML model is trained to place certain teeth into certain poses (e.g., certain poses relative to other teeth) in the predicted orthodontic setup. In order to accurately transform the upper cuspids into a setups pose, the setups prediction model needs to know which tooth meshes in the arch correspond to upper cuspids. For example, the setups prediction model may place an upper cuspid in a manner which causes the cusp tip to extend significantly beyond the incisal edge of the adjacent lateral incisor, whereas the setups prediction model may place a central incisor such that the incisal edge of the central incisor is largely in-line with the incisal edge of the lateral incisor. Representation learning may be used to train a first ML module (e.g., a 3D U-Net, a 3D encoder from an autoencoder, or the like) to generate representations of the identified teeth, which may be provided to a second ML module. The second ML module (e.g., a set of one or more fully connected layers, etc.) may be trained to generate tooth transforms for the teeth, to place those teeth into setups poses. Tooth identity information may be provided to the second ML module, along with the corresponding latent representation (e.g., a tooth number may be embedded with the latent vector for each tooth, before those latent vectors are provided to the second ML module). Automated setups prediction benefits from the knowledge of tooth identity, for example, as determined by the classification techniques described herein.

Oral care appliance generation benefits from knowledge of tooth identities, because appliance generation may involve the placement of certain appliance components in proximity to particular teeth. Dental restoration appliance generation involves the placement of components from a library of pre-defined component parts, such as pre-defined appliance features include vents, rear snap clamps, door hinges, door snaps, an incisal registration feature, center clips, custom labels, a manufacturing case frame, a diastema matrix handle, among others. For example, the rear snap clamp component may be placed in proximity to a tooth which one tooth beyond the outer-most teeth to be restored. For instance, when the outer-most teeth to be restored in an upper arch are the left and/or right upper cuspids, then the left and/or right rear snap clamps may be placed on the respective left and/or right upper 2^{nd} bicuspids. In this manner, appliance component placement benefits from the knowledge of tooth identity, for example, as determined by the classification techniques described herein.

Furthermore, oral care appliance generation may involve the generation of custom appliance components which may take shape (e.g., using generative ML techniques) according to the anatomy of the particular teeth in proximity to a given portion of the generated appliance component. For example, the mold parting surface may be generated to divide the facial from the lingual portions of the patient's teeth, passing along the middles of the incisal edges of anterior teeth, and passing through the outer cusp tips of the molars. Stated another way, mold parting surface generation benefits from the knowledge of tooth identity (e.g., as determined by the classification techniques described herein), because the parting surface is generated in a manner so as to bisect anterior teeth (e.g., incisors) differently than molars (e.g., 1^{st} or 2^{nd} molars). Examples of custom appliance components include a mold parting surface, a gingival trim surface, a shell, a facial ribbon, a lingual shelf (also referred to as a “stiffening rib”), a door, a window, an incisal ridge, a case frame sparing, or a diastema matrix wrapping, a spline, among others. A spline refers to a curve that passes through a plurality of points or vertices, such as a piecewise polynomial parametric curve. A mold parting surface refers to a 3D mesh that bisects two sides of one or more teeth (e.g., separates the facial side of one or more teeth from the lingual side of the one or more teeth). A gingival trim surface refers to a 3D mesh that trims an encompassing shell along the gingival margin. A shell refers to a body of nominal thickness. In some examples, an inner surface of the shell matches the surface of the dental arch and an outer surface of the shell is a nominal offset of the inner surface. The facial ribbon refers to a stiffening rib of nominal thickness that is offset facially from the shell. A window refers to an aperture that provides access to the tooth surface so that dental composite can be placed on the tooth. A door refers to a structure that covers the window. An incisal ridge provides reinforcement at the incisal edge of dental appliance and may be derived from the archform. The case frame sparing refers to connective material that couples parts of a dental appliance (e.g., the lingual portion of a dental appliance, the facial portion of a dental appliance, and subcomponents thereof) to the manufacturing case frame. In this way, the case frame sparing may tie the parts of a dental appliance to the case frame during manufacturing, protect the various parts from damage or loss, and/or reduce the risk of mixing-up parts. These appliance components and others are described in PCT patent applications WO2020240351A1 and WO2021240290A1, both of which are incorporated herein by reference in their entirety.

Restoration design generation may be performed to alter the shape of a pre-restoration tooth (e.g., using an encoder-decoder structure, such as a reconstruction autoencoder). A reconstruction autoencoder may be trained to reconstruct examples of a particular tooth (e.g., a lower left central incisor, or an upper right 1^{st} molar). Experiments have shown that a reconstruction autoencoder which is trained to reconstruct a particular type of tooth yields more accurate reconstructions (e.g., as measured by reconstruction error) than a reconstruction autoencoder which is trained to reconstruct multiple types of teeth (e.g., all teeth in an arch). Therefore, restoration design generation (which may be performed through the use of a reconstruction autoencoder) benefits from the knowledge of tooth identity, for example, as determined by the classification techniques described herein.

In some implementations, meta data may be associated with 3D representations described herein (e.g., 3D meshes of individual teeth, or 3D meshes of entire arches). Meta data may be associated with one or more mesh elements (e.g., vertices, etc.) of a 3D mesh. Meta data may include color information (e.g., derived from a color photograph that is applied to the 3D mesh as a texture), temperature information, surface impedance information, and the like. Such meta data may be associated with the mesh elements of a 3D representation before that 3D representation undergoes latent encoding (e.g., using a 3D encoder), with the benefit of improving the generated latent encoding.

### EXAMPLES

Example 1: A method of classifying a 3D oral care representation, the method comprising:
receiving, by processing circuitry of a computing device, a first 3D oral care representation; providing, by the processing circuitry, the first 3D oral care representation as input to a first trained machine learning (ML) model;
executing, by the processing circuitry, the first trained ML model to generate a second 3D oral care representation from the first 3D oral care representation provided as the input; and
providing, by the processing circuitry, the second 3D oral care representation to a second trained ML model; and
executing, by the processing circuitry, the second trained ML model to output a classification with respect to the second 3D oral care representation.
Example 2: The method of Example 2, further comprising providing, by the processing circuitry, as input to the first trained ML model, at least one mesh element feature for at least one mesh element associated with the first 3D oral care representation.
Example 3: The method of Example 1, wherein the first 3D oral care representation comprises a tooth representation.
Example 4: The method of Example 3, wherein the classification comprises a tooth classification.
Example 5: The method of Example 4, wherein the tooth classification is indicative of at least one of a tooth name or a tooth type.
Example 6: The method of Example 1, wherein the 3D oral care representation represents an orthodontic setup, and wherein the classification comprises a setup classification.
Example 7: The method of Example 6, wherein the setup classification comprises one of a maloccluded classification, an intermediate stage classification, or a final setup classification.
Example 8: The method of Example 1, wherein the mesh element represents at least one of a vertex, a face, or an edge.
Example 9: The method of Example 1, wherein the mesh element comprises a voxel.
Example 10: The method of Example 1, wherein the first 3D representation is at least one of a mesh, a point cloud, or a voxelized representation.
Example 11: The method of Example 1, wherein the first trained ML model is a trained autoencoder model.
Example 12: The method of Example 1, wherein the trained autoencoder model is a trained variational autoencoder (VAE) model.
Example 13: The method of Example 11, wherein the trained autoencoder model comprises at least one 3D encoder configured to encode the first 3D oral care representation to a latent space representation.
Example 14: The method of Example 13, wherein the trained autoencoder model comprises at least one 3D decoder configured to reconstruct the latent space representation to form a reconstructed 3D oral care representation.
Example 15: The method of Example 14, further comprising calculating a reconstruction loss that quantifies a difference between the first 3D oral care representation and the reconstructed oral care representation.
Example 16: The method of Example 15, wherein calculating the reconstruction loss comprises calculating at least one of a reconstitution loss or a KL-divergence loss term.
Example 17: The method of Example 1, wherein the second trained ML model is an ML classifier model, and wherein the ML classifier model comprises at least one of a neural network, a support vector machine (SVM), a regression model, a decision tree, a random forest model, a boosting model, a Gaussian process, a k-nearest neighbors (KNN) model, a logistic regression model, a Naïve Bayes model, or a gradient boosting algorithm.
Example 18: The method of Example 17, wherein the ML classifier model is configured to output at least one tooth designation conforming to at least one of a Universal Numbering System, a Palmer System, or an FDI World Dental Federation notation (ISO 3950).
Example 19. The method of either Example 17 or Example 18, wherein the ML classifier model is configured to output an indication of tooth health associated with the first 3D oral care representation.

1. A method of classifying a 3D representation, the method comprising:
receiving, by processing circuitry of a computing device, a first three-dimensional (3D) representation of oral care data;
wherein the first 3D representation comprises one or more mesh elements;
providing, by the processing circuitry, the first 3D representation, as input to a trained autoencoder network; and
computing one or more mesh element features for the one or more of the mesh elements;
providing the one or more mesh element features to the trained autoencoder network;
executing, by the processing circuitry, the trained autoencoder network to encode the first 3D representation of oral care data into one or more latent space representations, wherein the one or more latent space representations are configured for use by a machine learning model for classification of the first 3D representation of oral care data.

2. The method of claim 1, wherein the trained autoencoder model comprises at least one of a multi-dimensional encoder configured to encode the 3D representation of oral care data into a latent space representation or a multi-dimensional decoder configured to reconstruct the latent space representation into a reconstructed representation of oral care data that is a facsimile of the 3D representation of oral care data.

3. The method of claim 2, further comprising:
providing, by the processing circuitry, the 3D representation of oral care data and the reconstructed oral care representation as input data to a reconstruction error calculation module; and
executing, by the processing circuitry, the reconstruction error calculation module outputs a reconstruction error that quantifies a loss between the 3D representation of oral care data and the reconstructed representation of oral care data.

4. The method of claim 1, wherein the 3D representation of oral care data represents an orthodontic setup, and wherein the classification comprises a setup classification.

5. The method of claim 4, wherein the setup classification comprises one of a maloccluded classification, an intermediate stage classification, or a final setup classification.

6. The method of claim 1, wherein the 3D representation of oral care data represents a tooth.

7. The method of claim 6, wherein the classification comprises a tooth classification.

8. The method of claim 7, wherein the tooth classification is indicative of at least one of a tooth name or a tooth type.

9. The method of claim 1, wherein the tooth classification is indicative of the presence of attached hardware.

10. The method of claim 1, wherein the computing device is deployed at a clinical context, and wherein the method is performed in near real-time during an encounter with a patient.

11. The method of claim 1, wherein the 3D representation of oral care data is used for generating an oral care appliance.

12. The method of claim 11, wherein the oral care appliance is at least one of a clear tray aligner (CTA), a dental restoration appliance, or an indirect bonding tray.

13. The method of claim 1, wherein the first machine learning module is at least one of: a neural network, a support vector machine (SVM), a regression model, a Logistic regression model, a decision tree, a random forest model, a boosting model, a Gaussian process, a k-nearest neighbors (KNN) model, a Naïve Bayes model, or a gradient boosting algorithm.

14. A device for classifying a 3D representation, the device comprising:
interface hardware configured to receive a first three-dimensional (3D) representation of oral care data of a patient;
processing circuitry configured to execute a trained autoencoder model to:
encode the first 3D representation of oral care data into one or more latent space representations; where the latent space representation is used for classification of the first 3D representation of oral care data and
output a classification of the 3D representation of oral care data; and
a memory unit configured to store the classification.

15. The device of claim 14, wherein:
the trained autoencoder model comprises a multi-dimensional encoder and multi-dimensional decoder,
the 3D encoder is configured to encode the first 3D representation of oral care data into a latent space representation, and
the 3D decoder is configured to reconstruct the latent space representation into a reconstructed representation that is a facsimile of the first 3D representation of oral care data.

16. The device of claim 15, wherein the processing circuitry is further configured to:
provide the 3D representation of oral care data and the reconstructed representation of oral care data as input data to a reconstruction error calculation module; and
execute a reconstruction error calculation module to output a reconstruction error that quantifies a loss between the 3D representation of oral care data and the reconstructed representation of oral care data.

17. The device of claim 14, wherein the 3D representation of oral care data represents an orthodontic setup, and wherein the classification comprises a setup classification.

18. The device of claim 17, wherein the setup classification comprises one of a mal classification, an intermediate classification, or a final setup classification.

19. The device of claim 14, wherein the 3D representation of oral care data represents a tooth.

20. The device of claim 19, the classification comprises a tooth classification.
